(19) United States
(12) Patent Application Publication
(10) Pub. No.: US 2026/0133679 A1
(43) Pub. Date: May 14, 2026

(54) METHOD FOR DETERMINING PROCESSING PARAMETER, PROCESSING DEVICE, SYSTEM, AND MEDIUM

(71) Applicant: Makeblock Co., Ltd., Shenzhen (CN)

(72) Inventors: Liang WANG, Shenzhen (CN); Yanchen GUO, Shenzhen (CN); Shiling WU, Shenzhen (CN); Yu WANG, Shenzhen (CN); Haihan ZENG, Shenzhen (CN)

(73) Assignee: Makeblock Co., Ltd., Shenzhen (CN)

(21) Appl. No.: 19/444,575

(22) Filed: Jan. 9, 2026

Related U.S. Application Data
(63) Continuation of application No. PCT/CN2025/091858, filed on Apr. 28, 2025.

(30) Foreign Application Priority Data
Feb. 28, 2024 (CN) 202410221268.1
Aug. 20, 2024 (CN) 202411146500.6
Dec. 30, 2024 (CN) 202411971530.0
Apr. 27, 2025 (CN) 202510540893.7

(51) Int. Cl. G06F 3/0484; G05B 19/4093; G06V 10/54; G06V 10/56; G06V 10/75; G06V 10/764; G06V 30/19

(52) U.S. Cl. CPC G06F 3/0484; G05B 19/40937; G06V 10/751; G06V 10/764; G05B 2219/45041; G06V 10/54; G06V 10/56; G06V 30/19093; G06V 30/19173; G06V 2201/06

(57) ABSTRACT

A method for determining a processing parameter, a processing device, a system, and a medium. The method for determining the processing parameter includes the following. Processing factor information of a workpiece to be processed is configured. One or more processing preview diagrams are displayed according to the processing factor information, where there is a mapping relationship between the one or more processing preview diagrams and processing parameters. A processing parameter corresponding to a selection instruction for the one or more processing preview diagrams is determined to be a target processing parameter in response to the selection instruction, where the target processing parameter is used for controlling a processing device to process the workpiece to be processed.

### CROSS-REFERENCE TO RELATED APPLICATION(S)

This application is a continuation of International Application PCT/CN2025/091858, filed on Apr. 28, 2025, which claims priority to Chinese Patent Application No. 202411971530.0 filed Dec. 30, 2024, Chinese Patent Application No. 202410221268.1 filed Feb. 28, 2024, Chinese Patent Application No. 202411146500.6 filed Aug. 20, 2024, and Chinese Patent Application No. 202510540893.7 filed Apr. 27, 2025 the entire disclosures of which are hereby incorporated by reference.

### TECHNICAL FIELD

This disclosure relates to the technical field of processing device control, in particular to a method for determining a processing parameter, a processing device, a system, and a medium.

### BACKGROUND

In the related art, when a user applies a laser processing device, the user needs to determine a processing parameter for a specific type of material according to previous experience or by consulting an operating manual, and then manually set the processing parameter on the processing device.

### SUMMARY

In a first aspect, a method for determining a processing parameter is provided in the present disclosure. The method includes the following. Processing factor information of a workpiece to be processed is configured. One or more processing preview diagrams are displayed according to the processing factor information, where there is a mapping relationship between the one or more processing preview diagrams and processing parameters. A processing parameter corresponding to a selection instruction for the one or more processing preview diagrams is determined to be a target processing parameter in response to the selection instruction, where the target processing parameter is used for controlling a processing device to process the workpiece to be processed.

In a second aspect, a computer system is further provided in the present disclosure. The computer system includes at least one processor and at least one non-transitory computer-readable medium. The at least one non-transitory computer-readable medium is configured to store program instructions which, when executed by the at least one processor, cause the computer system to perform the method for determining a processing parameter in the first aspect.

In a third aspect, a non-transitory computer-readable storage medium is further provided in the present disclosure. The non-transitory computer-readable storage medium is configured to store a computer program for implementing a method for determining a processing parameter, and the computer program which, when executed by a processor, causes the processor to perform the method for determining a processing parameter in the first aspect.

### BRIEF DESCRIPTION OF THE DRAWINGS

FIG. 1 is a flowchart illustrating a method for determining a processing parameter according to embodiments of the present disclosure.

FIG. 2 is a schematic diagram of obtaining a processing area image in a method for determining a processing parameter according to embodiments of the present disclosure.

FIG. 3 is a schematic diagram of obtaining a material type by identifying label information in a method for determining a processing parameter according to embodiments of the present disclosure.

FIG. 4 is a schematic diagram of displaying candidate material types in a method for determining a processing parameter according to embodiments of the present disclosure.

FIG. 5 is a schematic diagram of a material list control in a method for determining a processing parameter according to embodiments of the present disclosure.

FIG. 6 is a schematic diagram of intelligent identification in a method for determining a processing parameter according to embodiments of the present disclosure.

FIG. 7 is a schematic diagram of a material list control displaying candidate material types in a method for determining a processing parameter according to embodiments of the present disclosure.

FIG. 8 is a schematic diagram of displaying a processing parameter array and an array element after a material type is identified in a method for determining a processing parameter according to embodiments of the present disclosure.

FIG. 9 is a simplified flowchart illustrating a method for determining a processing parameter according to the present disclosure.

FIG. 10 is a schematic diagram of a processing device in embodiments of the present disclosure.

FIG. 11 is a schematic diagram of a processing system according to embodiments of the present disclosure.

FIG. 12 is a schematic structural diagram of hardware of a terminal device according to embodiments of the present disclosure.

FIG. 13 is a flowchart illustrating a method for determining a processing parameter according to the present disclosure.

FIG. 14 is another flowchart illustrating a method for determining a processing parameter according to the present disclosure.

FIG. 15 is an exemplary diagram of a processing parameter array involved in embodiments of the present disclosure.

FIG. 16 is another exemplary diagram of a processing parameter array involved in embodiments of the present disclosure.

FIG. 17 is a schematic diagram of an interface for a hovering operation scenario involved in embodiments of the present disclosure.

FIG. 18 is a schematic diagram of an interaction interface involved in embodiments of the present disclosure.

FIG. 19 is yet another flowchart illustrating a method for determining a processing parameter according to the present disclosure.

FIG. 20 is another schematic diagram of an interaction interface involved in embodiments of the present disclosure.

FIG. 21 is yet another schematic diagram of an interaction interface involved in embodiments of the present disclosure.

FIG. 22 is a schematic diagram of an exemplary embodiment environment according to the present disclosure.

FIG. 23 is a flowchart illustrating a method for data processing based on a processing device in an exemplary embodiment of the present disclosure.

FIG. 24 is a schematic diagram of a captured image in an exemplary embodiment of the present disclosure.

FIG. 25 is a flowchart illustrating a method for data processing based on a processing device in another exemplary embodiment of the present disclosure.

FIG. 26A is a schematic diagram of a processing interface in an exemplary embodiment of the present disclosure.

FIG. 26B and FIG. 26C are schematic diagrams each illustrating a capturing interface in an exemplary embodiment of the present disclosure.

FIG. 26D is a schematic diagram illustrating a recognition processing interface in an exemplary embodiment of the present disclosure.

FIG. 26E is a schematic diagram of an array element selection interface in an exemplary embodiment of the present disclosure.

FIG. 27A is a schematic diagram illustrating a first sample image in an exemplary embodiment of the present disclosure.

FIG. 27B is a schematic diagram illustrating a second sample image in an exemplary embodiment of the present disclosure.

FIG. 28 is a block diagram illustrating an apparatus for data processing based on a processing device in an exemplary embodiment of the present disclosure.

FIG. 29 is a schematic structural diagram of a computer system appropriate for implementing an electronic device of the present disclosure.

FIG. 30 is yet another schematic diagram of an interaction interface in an exemplary embodiment of the present disclosure.

### DETAILED DESCRIPTION

Currently, when the user applies a laser processing device, the user needs to determine a processing parameter for a specific type of material according to previous experience or by consulting an operating manual, and then manually set the processing parameter on the processing device. With such a method, a matching degree between the processing parameter and the material may be low, leading to a poor processed result.

In an example, the present disclosure provides the following solution. A processing area image corresponding to a processing device platform is obtained, where the processing area image contains a workpiece to be processed. At least a portion of the processing area image is identified, and a processing parameter for the workpiece to be processed is determined.

In the present disclosure, the processing area image corresponding to the processing device platform is identified, and then the processing parameter for the workpiece to be processed is obtained by analyzing the processing area image, thereby achieving the technical effect of accurately providing the processing parameter after the user places the workpiece.

Specifically, the at least a portion of the processing area image is identified and the processing parameter for the workpiece to be processed is determined as follows. The processing area image is identified, and a material type of the workpiece to be processed is determined. The processing parameter for the workpiece to be processed is obtained through matching based on the material type.

It can be noted that, an execution entity in the embodiment may be a processing system, may be a computing service device with functions of data processing, network communication, and program execution, such as a tablet computer, a personal computer, or a mobile phone, may be a processing device capable of implementing the above functions, or may be a terminal device connected to the processing device, which is not specifically limited in embodiments of the present disclosure. The embodiment and the following embodiments are elaborated below with an example that the execution entity is a processing system.

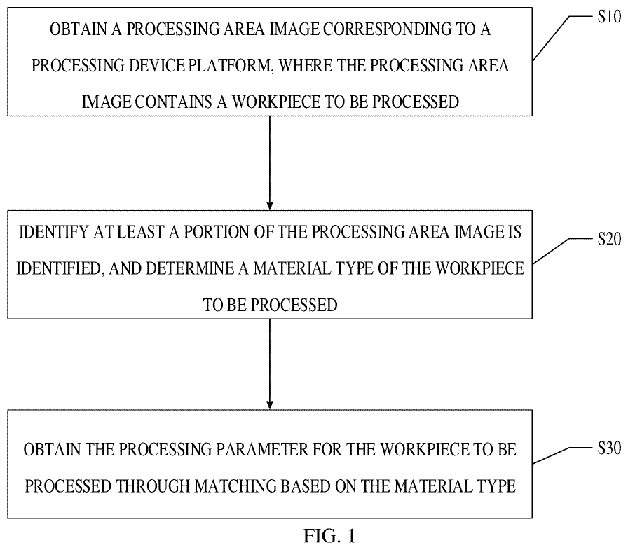

Based on this, a method for determining a processing parameter is provided in an embodiment of the present disclosure. Reference may be made to FIG. 1, and the method for determining the processing parameter includes operations at S10 to S30.

At S10, a processing area image corresponding to a processing device platform is obtained, where the processing area image contains a workpiece to be processed.

In this embodiment, the processing device platform is a platform used for placing the workpiece to be processed in the processing device. A processing module of the processing device, such as a cutting head or a laser head, processes the workpiece to be processed on the processing device platform. The processing area image is an image captured from the processing device platform. The workpiece to be processed refers to a workpiece that is placed on the processing device platform and needs to be processed, including but not limited to, acrylic, leather, wood, and alloy materials.

In an optional embodiment, the processing device is provided with a sensor for capturing a processing area image. When the processing device detects that a workpiece to be processed is placed on the processing device platform or when the processing device receives an image capture instruction sent by a terminal device, the processing device invokes the sensor to capture a processing area image corresponding to the processing device platform, where the processing area image contains the whole workpiece to be processed, and then the processing area image is sent to the terminal device.

At S20, at least a portion of the processing area image is identified, and a material type of the workpiece to be processed is determined.

In this embodiment, the material type refers to a material property of the workpiece to be processed. The material type includes, but is not limited to, acrylic, aluminum alloy, wood, and leather. The material type may also be a refinement of the foregoing materials. For example, wood may be further categorized into poplar, elm, oak, walnut, boxwood, padauk, rosewood, mahogany, etc. Leather may be further categorized into pigskin, cowhide, sheepskin, etc.

In an optional embodiment, the workpiece to be processed is provided with label information. The terminal device identifies the processing area image, determines the label information in the processing area image, wherein the label information is mapped to the material type of the workpiece to be processed, and obtains the material type of the workpiece to be processed by parsing the label information. Alternatively, the label information is directly mapped to a processing parameter for the workpiece to be processed, and the processing parameter for the workpiece to be processed is obtained by parsing the label information.

In another optional embodiment, feature recognition is performed on the processing area image to extract feature information of the workpiece to be processed, retrieval is performed in a feature database based on the feature information, and a material with a matching degree exceeding a threshold in the feature database is taken as an identified material type.

At S30, the processing parameter for the workpiece to be processed is obtained through matching based on the material type.

In this embodiment, the processing parameter is a combination of at least one processing parameter, including but not limited to a laser power, a pulse frequency, a pulse width, a scan speed, a spot size, a defocus amount, and the number of processing times.

In an optional embodiment, a processing parameter associated with the material type is obtained based on the material type.

In an optional embodiment, at least two sets of processing parameters associated with the material type are obtained, and a selected processing parameter is taken as the processing parameter for the workpiece to be processed according to a selection instruction by a user for any one of the at least two sets of processing parameters.

In an optional embodiment, multiple reference processing parameters associated with the material type are obtained, and a processing quality parameter corresponding to each reference processing parameter is determined, wherein the processing quality parameter refers to the processing quality of a processed result obtained by applying the reference processing parameter to process a processing element on the workpiece to be processed. Then, one of the multiple reference processing parameters is taken as the processing parameter for the workpiece to be processed based on the processing quality parameter.

Exemplarily, when the user places a workpiece to be processed, such as a thin walnut board, on the processing device platform, the processing device automatically detects the placement of the workpiece and immediately triggers the sensor to capture a processing area image. The sensor quickly takes a clear image that contains the whole thin walnut board, and sends image data to the terminal device via a preset data transmission method. The terminal device is equipped with a specialized image identification software. Upon receiving the processing area image, the software first attempts to determine a material type by scanning a small QR code label pre-attached to the thin walnut board. Using its built-in QR code decoding function, the software parses the label to quickly and accurately obtain material type information: “walnut”. If the label is damaged or missing, or if there is no label information on the workpiece to be processed, the material type cannot be determined according to the label information, and the software will automatically switch to an image feature-based recognition mode. The software performs detailed feature analysis on the processing area image, extracts distinctive feature information such as texture, color, and luster of the walnut, and then performs retrieval and matching in a comprehensive built-in feature database. Through complex algorithmic calculations, a material type whose matching degree with the extracted feature exceeds a configured threshold (e.g., 90%) is determined as “walnut”.

The terminal device immediately accesses a locally stored processing parameter database according to the identified material type “walnut”. The database stores multiple sets of processing parameters for various material types, and each set of processing parameters includes a specific value(s) of at least one of the following parameters: a laser power, a pulse frequency, a pulse width, a scan speed, a spot size, and a defocus amount. For example, one set of processing parameters may include a laser power and a scan speed, or may include a laser power, a scan speed, and a pulse frequency, and the combinations of processing parameters are not exhaustively listed. In the database, walnut is associated with three recommended sets of processing parameters, which are appropriate for different processing needs such as fine engraving, rapid cutting, and surface etching.

After viewing brief descriptions of the three parameter sets on the terminal device, the user selects a set of processing parameters configured for fine engraving according to the purpose of a current processing, such as creating a finely engraved walnut pendant. The set of processing parameters (a laser power is 80 W, and a scan speed is 400 mm/s) is then sent back to the laser processing device via the preset data transmission method. The processing device automatically completes parameter configuration and prepares to begin processing.

If the user is unsure which set of parameters to choose, the terminal device may automatically obtain processing quality parameters corresponding to the three sets of reference processing parameters. The processing quality parameter is previously obtained by measuring and evaluating walnut samples processed with different processing parameters. For example, the processing quality parameter is determined according to the flatness of the engraved edge, the roughness of the cut surface, and the uniformity of the etching depth. Then, the device automatically determines and applies the most appropriate set of processing parameters to the laser processing device according to a preset quality priority rule, such as prioritizing a set of parameters with the best edge flatness.

In the present disclosure, recognition processing is automatically performed based on the processing area image to obtain the material type, a corresponding processing parameter is automatically obtained based on the material type, and thus a processing parameter that matches the material type can be accurately obtained without manual operation by the user. As such, the problem of poor processing effect caused by a low matching degree between the processing parameter and the material can be addressed, and the efficiency of obtaining the processing parameter can be improved since manual operation by the user is not required in the process of obtaining the processing parameter. Therefore, the processing efficiency can be improved, and the technical effect of automatically recommending the processing parameter based on the material can be achieved.

Based on any embodiment, in a possible embodiment of the present disclosure, the operations at S20 include the following. The label information in the processing area image is identified, and the material type of the workpiece to be processed is determined.

In an optional embodiment, the workpiece to be processed is placed in an image capturing area of the processing device. When the processing system starts image capturing, a processing area image is obtained. The processing system employs an image recognition algorithm to rapidly scan and analyze the image, specifically performing precise localization and recognition of a preset label information area.

The labeling information is in a specific coding format that directly presents material type information in plaintext. For example, when a label is detected, the system clearly reads a word “oak” directly printed on the label by using an optical character recognition (OCR) technology, and thus quickly and accurately determines that the material type of the workpiece to be processed is oak. In the entire process, no complex conversion or secondary parsing is required, the key material type information is directly obtained from the label, thereby greatly improving the recognition efficiency and accuracy, and providing a reliable basis for subsequent matching of a processing parameter.

In another optional embodiment, after obtaining the processing area image, the system searches for and locates label information in the processing area image by using an intelligent image recognition technology. The label information stores a unique identifier code, such as “ABC123”, which is encrypted or generated according to specific rules. After extracting the identifier code, the system immediately compares and queries the identifier code against a pre-stored identifier-material type mapping table in a local database. In the mapping table, each identifier is in one-to-one correspondence with a specific material type. When the system queries that “ABC123” corresponds to a material type “rosewood”, the system successfully determines the material type of the workpiece to be processed. With such a method, an indirect association between an identifier and a material type is established, which not only ensures the security and accuracy of information but also enables flexible management and updates of material type information, thereby adapting to varying production needs and changes in material type.

In this embodiment, the material type of the workpiece to be processed can be quickly obtained by recognizing the label information on the workpiece to be processed, which can improve the efficiency and accuracy of obtaining the material type, and facilitate the quick matching of the processing parameter according to the material type, thereby improving the processing efficiency.

Based on any embodiment mentioned above, in a possible embodiment of the present disclosure, the operations at S20 include operations at S21 to S22.

At S21, material feature information of the workpiece to be processed is determined based on the processing area image.

In this embodiment, the label information refers to the identifier (such as a QR code, a barcode, or a watermark) on the workpiece to be processed, and is used for directly or indirectly determining the material type. The material feature information refers to a visual or physical feature of the workpiece to be processed, including but not limited to, texture, color, gloss, shape, and edge features, or may be at least one of a spectral feature and a speckle feature.

The terminal device analyzes the processing area image to extract the material feature information of the workpiece to be processed. For example, image processing algorithms are used for extracting texture features (such as growth rings in wood or pores in leather) and color features (such as the transparency of acrylic or the reflectivity of metal) of the material.

At S22, the material type of the workpiece to be processed is determined based on a matching degree between the material feature information and various material features in a configured material feature database.

In this embodiment, the configured material feature database refers to a database that is pre-established and stores material feature information for various material types. The matching degree refers to a degree of similarity between the material feature information of the workpiece to be processed and the material feature information in the database, typically expressed as a percentage or score.

The terminal device calculates the matching degree by comparing the extracted material feature information with the various material features in the configured material feature database, and takes a material type with a matching degree exceeding a preset threshold as an identified result. The preset threshold may be configured as any value, such as 90%, 80%, 70%, 85%, 95%, etc., which is not limited in this embodiment.

For example, if the matching degree between the texture feature of the workpiece to be processed and the feature of “walnut” in the database reaches 95% and the preset threshold is 90%, the material type is determined to be “walnut”.

Exemplarily, when the user places a timber to be processed on the processing device platform of the laser processing device. Upon detecting the placement of the timber, the processing device automatically captures a processing area image and sends the image to the terminal device. The terminal device attempts to recognize label information in the image but detects no labels. Subsequently, the system switches to a feature-based recognition mode to determine the material type. The processing device invokes its built-in camera to capture a processing area image containing the timber to be processed and sends image data to the terminal device. The terminal device analyzes the processing area image and extracts material feature information of the timber. The material feature information includes: texture feature, which is distinct growth rings and fine wood fiber structure; color feature, which is light brown with a slight sheen; and shape feature, which is square, with smooth edges and no obvious burrs. The terminal device compares the extracted material feature information with the various material features in the configured material feature database: a matching degree with “poplar” is 75%; a matching degree with “walnut” is 95%; and a matching degree with “oak” is 85%. Since the matching degree with “walnut” is the highest and exceeds the preset threshold (90%), the terminal device determines the material type to be “walnut”. The terminal device retrieves a recommended processing parameter from the processing parameter database according to the material type “walnut”, and sends the processing parameter to a laser cutter to automatically complete parameter configuration.

Further, there may be multiple candidate material types exceeding the preset threshold. For example, if the preset threshold is 80%, both the matching degree with walnut and the matching degree with oak are higher than the preset threshold. In this case, a candidate box is displayed, and the material type is determined in response to a selection instruction for the candidate box.

In this embodiment, the problem of being unable to determine the material type when no label information is detected is addressed through feature extraction and database matching. This method is applicable to scenarios where a label is absent or damaged, thereby expanding the present disclosure scope of the system. Feature matching ensures the accuracy of material type recognition and avoids human error. Feature recognition of various materials is supported, and different processing needs can be satisfied.

Further, dynamic update is supported in the configured material feature database, such that the user can add material feature information for a new material type or optimize existing feature data, thereby improving the matching accuracy. The terminal device can simultaneously extract multiple material feature information and calculate an overall matching degree by using a weighted algorithm, thereby further improving the recognition accuracy. After the material type is determined, the terminal device can display the recognized result and the matching degree to the user, and the user can manually confirm or adjust the material type to ensure the reliability of the recognition.

This embodiment elaborates the method for determining the material type through feature extraction and database matching when no label information is detected. Combined with specific scenarios and operations, the method achieves automation and accuracy of material type recognition, thereby providing a reliable basis for matching the processing parameter.

Optionally, the material feature information of the workpiece to be processed is determined based on the processing area image as follows.

At S211, first feature information of the workpiece to be processed is determined based on the processing area image, where the first feature information includes a texture feature, a color feature, and a shape feature.

In this embodiment, the first feature information includes a texture feature, a color feature, and a shape feature.

As for texture feature extraction, first, the processing area image is converted into a gray-level image, and a gray-level co-occurrence matrix (GLCM) algorithm is used for quantifying the texture feature. The GLCM calculates a joint probability distribution of gray-level pixels at a given distance and direction in the image, to obtain several statistics reflecting texture features, such as contrast, correlation, energy, and entropy. For example, for a wood image with a distinct texture direction, the contrast may be relatively high when calculating the GLCM in a horizontal direction, while the correlation reflects the regularity of the texture. These statistics constitute part of the texture feature vector.

As for color feature extraction, an appropriate color space model, such as HSV (hue, saturation, value) or LAB color space, is used to perform quantitative analysis on pixel colors in the processing area image. Statistical color information is obtained by calculating a histogram distribution of each color channel. For example, for a piece of red acrylic material, in HSV color space, its hue values concentrate within a red region, and its saturation and brightness also concentrate within specific ranges. These color feature parameters are combined into a color feature vector.

As for shape feature extraction, edge detection algorithms, such as the Canny edge detector, are used to identify the contour edges of the workpiece to be processed in the image. Subsequently, shape descriptors, such as Hu moments, are calculated based on the edge information. Hu moments exhibit invariance to translation, rotation, and scaling, enabling effective description of shape features of an object. For a material with a regular shape, such as a circular metal sheet, Hu moments can accurately reflect its circular geometric features. For a material with an irregular shape, such as a piece of natural leather, Hu moments can capture its unique contour shape information.

At S212, alternatively, second feature information of the workpiece to be processed is determined based on the processing area image, where the second feature information includes a spectral feature and/or a speckle feature.

In this embodiment, the second feature information includes a spectral feature and/or a speckle feature.

A spectrometer is used, and a sensor of the spectrometer is aimed at the workpiece to be processed placed on the processing device platform, to collect reflection or transmission spectral data of the material within a specific wavelength range. Different materials exhibit unique absorption and reflection features for light of different wavelengths due to variations in chemical composition and physical structure of the materials. For example, metallic materials may have relatively high reflectivity in a visible light spectrum and specific absorption peaks in an infrared band, and some plastic materials exhibit a distinct absorption feature in an ultraviolet band. By analyzing parameters such as the position, intensity, and width of feature peaks in the spectral data, a spectral feature vector of the material can be determined for material type recognition.

When the surface of the workpiece to be processed is irradiated by a laser, a speckle phenomenon occurs due to the surface roughness and internal structural inhomogeneity of the material. Speckle patterns can be captured and analyzed by using a high-speed camera or a photodetector to obtain the speckle feature. For example, features such as grain size, contrast, and spatial distribution of the speckle are closely related to the microstructure of the material. For a material with smooth surfaces, the speckle grains are relatively small and uniformly distributed, whereas for a material with rough surfaces, the speckle exhibits relatively large grains and irregular distribution. The speckle feature information can serve as supplementary features, enhancing the accuracy of material recognition when combined with other features.

The first feature information or the second feature information obtained via the foregoing method can comprehensively and accurately describe the feature of the workpiece to be processed, providing rich data support for subsequent matching based on the feature information and the configured material feature database, and determining the material type. As such, the laser processing device can intelligently recognize different materials and automatically match the processing parameters, thereby improving the processing effect and quality.

Based on any embodiment, in a possible embodiment of the present disclosure, the operations at S30 include operations at S31 to S33.

At S31, multiple reference processing parameters are obtained.

In this embodiment, the reference processing parameters refer to multiple sets of feasible array elements obtained in advance for different material types through extensive experimentation and empirical accumulation. Each set of array elements includes at least one or two of the following key parameters during laser processing process, such as a laser power (which determines the output intensity of laser energy, measured in watts), a pulse frequency (the number of laser pulses emitted per unit time, in Hertz), a pulse width (a duration of a single laser pulse, in nanoseconds, picoseconds, or femtoseconds), a scan speed (the speed at which a laser beam moves across the material surface, in mm/s or m/s), a spot size (the diameter of the spot after the laser beam is focused on the material surface, in micrometers), and a defocus amount (a distance between the focus of the laser beam and the surface of the workpiece to be processed).

After the material type of the workpiece to be processed is determined, a control software of the processing system automatically queries and extracts all reference processing parameters associated with the material type from the local database. For example, for an aluminum alloy material, the database may store five different sets of reference processing parameters, which are combinations of parameters configured to achieve different processing effects (such as rapid cutting, fine engraving, surface polishing, line cutting, line engraving, fill engraving, and bitmap engraving).

In another optional embodiment, each material type is associated with a set of processing parameter arrays, the set of processing parameter arrays includes multiple processing preview diagrams, and each processing preview diagram corresponds to a processing preview effect with a different reference processing parameter. As such, multiple reference processing parameters are determined according to the processing parameter array.

At S32, a processing quality parameter corresponding to each reference processing parameter is determined based on the material type.

In this embodiment, the processing quality parameter is an indicator used for quantitatively evaluating the quality of a processed result obtained after processing the workpiece using a specific reference processing parameter. The indicator may include processing precision (such as dimensional deviation, shape precision, etc., calculated by measuring a difference between an actual size and a design size of a processed product), surface roughness (reflecting the microscopic unevenness of the processed surface, measured using a roughness tester, in micrometers), heat-affected zone (HAZ) size (an area where the workpiece changes microstructure and properties due to heat during laser processing, determined via a method such as metallographic analysis, etc.,), material removal rate (the volume or the weight of material removed per unit time, used for measuring processing effect and material consumption), presence of burn-through, etc. Different processing quality parameters have different weights of importance for different processing requirements.

In an optional embodiment, the processing quality parameter is a non-negative number. A processing preview diagram corresponding to each reference processing parameter is determined. Based on the processing preview diagram, processing device information, a processing method, and a processing element, a processing prediction pattern corresponding to each reference processing parameter is determined via an image-to-image generation method. Defect identification is then performed on the processing prediction pattern to determine whether there is a defect in each processing prediction pattern. For each defect identified, a value of the processing quality parameter is incremented by 1. If no defects are found in the processing prediction pattern, the processing quality parameter is recorded as 0.

In an optional embodiment, for each extracted reference processing parameter, the processing system obtains a corresponding processing quality parameter by actually processing a sample workpiece according to a preset experimental plan and measurement method. For example, after an aluminum alloy sample is cut by using the first set of reference processing parameters, the roughness and dimensional precision of a cut surface are measured by using a high-precision measuring instrument, the HAZ size is determined through metallographic analysis, and the material removal rate is calculated. These measurement results are recorded as the processing quality parameters for the first set of reference processing parameters. This process is repeated for all reference processing parameters, to obtain the processing quality parameters corresponding to each set of reference processing parameters.

At S33, the processing parameter is selected from the multiple reference processing parameters according to the processing quality parameter.

In this embodiment, a set of parameters most appropriate for the current processing task is selected from the multiple reference processing parameters according to specific selection rules and user requirements. The selection rules can be based on the user's priority requirements for different aspects of processing quality. For example, if the user prioritizes processing precision, the processing precision, one of the processing quality parameters, is given a higher weight; and if the user pursues high-efficiency processing, a weight for the material removal rate will be increased accordingly. A comprehensive evaluation score for each reference processing parameter is obtained by performing weighted calculation on each processing quality parameter, and a set of parameters with the highest score is taken as the final processing parameter.

The user's primary requirement for processing the aluminum alloy material is to improve the processing effect as much as possible while maintaining a certain level of processing precision. Based on this requirement, the processing system assigns weights of 0.4, 0.2, 0.2, and 0.2 to processing precision, surface roughness, HAZ size, and material removal rate, respectively. For each reference processing parameter, the processing quality parameter is calculated as follows: processing quality parameter=0.2 * processing precision score+0.2 * surface roughness score+0.2 * HAZ score+0.2 * material removal rate score. The data referenced for the processing quality parameter in the present disclosure is not limited, for example, the data may also be presence of burn-through. Each score can be normalized based on the closeness between an actual measured value and an ideal value. For example, the processing precision score can be obtained by calculating a deviation ratio between an actual processing precision and a preset ideal precision and then performing inverse normalization (a smaller deviation leads to a higher score). A reference processing parameter with the highest score by calculating and comparing comprehensive scores of all reference processing parameters is selected as the final processing parameter used for processing the aluminum alloy material.

For example, when the user places an aluminum alloy sheet on the platform of the laser processing device, the processing system determines the material type as aluminum alloy through image recognition and feature analysis. Next, the system retrieves five sets of reference processing parameters for aluminum alloy from the database, labeled as reference processing parameter A, reference processing parameter B, reference processing parameter C, reference processing parameter D, and reference processing parameter E, respectively. Then, the system performs actual processing test on each set of reference processing parameters. A sample piece of the same aluminum alloy material is cut by using reference processing parameter A, and the measured processing precision is ±0.1 mm (the maximum score is assumed to be ±0.05 mm, and the score is calculated as 0.6 according to the deviation ratio), surface roughness is Ra 3.2 μm (the maximum score is assumed to be Ra 1.6 μm, and the score is 0.5), HAZ size is 0.5 mm (the maximum score is assumed to be 0.3 mm, and the score is 0.4), and material removal rate is 5 mm³/s (the maximum score is assumed to be 8 mm³/s, and the score is 0.625). A processing quality parameter corresponding to reference processing parameter A is calculated to be 0.545 according to the assigned weight. Similarly, tests and comprehensive score calculations are performed for reference processing parameter B, reference processing parameter C, reference processing parameter D, and reference processing parameter E, and thus a comprehensive score of reference processing parameter B is 0.61, a comprehensive score of reference processing parameter C is 0.58, a comprehensive score of reference processing parameter D is 0.49, and a comprehensive score of reference processing parameter E is 0.56. After the comprehensive scores of all sets of parameters are compared, it can be seen that reference processing parameter B has the highest score. Therefore, the processing system ultimately selects reference processing parameter B (e.g., the laser power is 1000 W, the pulse frequency is 50 kHz, the pulse width is 10 ns, the scan speed is 800 mm/s, the spot size is 0.3 mm, the defocus amount is −1 mm) as the processing parameter for cutting the aluminum alloy sheet, and automatically applies these parameters to the laser processing device to perform precise and efficient cutting of the aluminum alloy sheet.

In another optional embodiment, after the processing quality parameter corresponding to each reference processing parameter is determined, a reference processing parameter corresponding to a processing quality parameter with the smallest value is taken as the selected processing parameter.

Optionally, the processing parameter is implemented as a set of processing parameters including processing parameters of at least one dimension, and the processing parameter is selected from the multiple reference processing parameters according to the processing quality parameter as follows.

At S34, based on the processing quality parameter, two sets of reference processing parameters to be interpolated are determined, and a processing parameter to be interpolated is determined.

In this embodiment, the two sets of reference processing parameters to be interpolated are selected from the existing sets of reference processing parameters. The two sets have different processing quality performances and are referential and complementary to each other. For example, one set of processed products may excel in certain quality indexes but be weaker in others, while the opposite is true for the other set. The two sets are used to explore a better combination of parameters. The processing parameter to be interpolated is a parameter that is selected from each of the two sets of parameters, has a significant impact on the processing quality, and is adjustable, such as P (laser power) and v (scan speed) in laser processing. By varying a value of the processing parameter to be interpolated, a new set of candidate parameters is generated to identify appropriate parameter configurations.

First, comprehensive analysis and ranking are performed on the processing quality parameters corresponding to all reference processing parameters, for example, divided into three layers: high, medium, and low, based on a combined assessment of processing precision and surface roughness. Next, two sets of parameters are selected from different layers, for example, selecting parameter set A, which exhibits high precision but low material removal rate, and parameter set B, which exhibits low precision but high material removal rate. It is determined, through data analysis, that P significantly contributes to a difference in processing quality between the two sets, and thus P is determined as the processing parameter to be interpolated.

At S35, other processing parameters except the processing parameters to be interpolated in the two sets of processing parameters remain unchanged, and interpolation processing is performed on the processing parameter to be interpolated to obtain multiple candidate reference processing parameters.

In this embodiment, interpolation processing means that, according to respective values of the parameter to be interpolated (e.g., P) in the two sets of reference processing parameters, a new set of parameters is constructed by interpolating, by using a mathematical algorithm, an intermediate value between the respective values. In this process, other parameters except P (e.g., pulse frequency f, pulse width t, spot size d, defocus amount l, etc.) remain their corresponding values of the original two sets of parameters, and only the value of P is changed to generate multiple candidate reference processing parameters, which fills a gap between the original two sets of parameters and increases the choice.

A value of P in parameter set A is set to P1, a value of P in parameter set B is set to P2, and a difference is calculated as: ΔP=P2−P1. According to the desired number of interpolations n (e.g., n=5), an interpolation step size is calculated as step=ΔP/(n+1). n candidate reference processing parameters are constructed sequentially. Pi of the i-th candidate set is calculated as: Pi=P1+(i+1)*step (i=0,1,2,. . . , n−1), with other parameters identical to the corresponding parameters in parameter set A and parameter set B. As such, n candidate sets with different P values are generated.

At S36, the processing parameter is selected from the multiple candidate reference processing parameters.

In this embodiment, the selection rule is to select, according to the preset rule and expectations for processing quality, the most appropriate set of parameters for the current processing task from the multiple candidate reference processing parameters generated through interpolation as the final processing parameter. The rule comprehensively considers various aspects of processing quality, assigns appropriate weights to the processing quality parameters (such as processing precision, surface roughness, HAZ size, and material removal rate) to measure the merits of the candidate sets, thereby meeting the user's specific needs for processed results and the practical demands of production.

For each candidate reference processing parameter, its corresponding processing quality parameter is obtained by processing samples using the method mentioned above. Finally, processing quality parameters corresponding to all candidate sets are compared, and a candidate set with the highest score is selected as the final processing parameter for application in the actual laser processing operation. As such, the processing process can be optimized and controlled, the processing quality and efficiency can be improved, and the diverse needs of different materials and processing scenarios can be satisfied.

In this embodiment, the multiple reference processing parameters are determined as the selection criteria according to the material type. A processing quality parameter corresponding to a result of a processing element processed by the processing device on the workpiece to be processed is determined for each reference processing parameter. Then, according to the processing quality parameter corresponding to each reference processing parameter, one reference processing parameter is optimally selected as the processing parameter for the workpiece to be processed, thereby improving the accuracy of the processing parameter and improving the processing effect.

Further, among the reference processing parameters, interpolation is performed between the two sets of reference processing parameters based on the defects corresponding to their processing quality parameters, to obtain a richer set of candidate reference processing parameters, which further improves the matching degree between the processing parameter and the workpiece to be processed and enhances the processing effect.

Based on any embodiment mentioned above, in a possible embodiment of the present disclosure, the processing parameter for the workpiece to be processed is determined as follows. A corresponding processing parameter array is determined according to processing factor information of a processing element, and multiple reference processing parameters are determined based on the processing parameter array, where the processing parameter array includes multiple processing preview diagrams, each of which is obtained through processing based on different array elements, and an array element indicates all the reference processing parameters.

It may be understood that, the processing factor information may be any one of a material type, a processing type, and a processing device type. Each type of processing factor information corresponds to a different processing parameter. The array element includes a processing parameter(s) corresponding to at least one type of processing factor information or processing parameters corresponding to at least two different types of processing factor information.

Specifically, the multiple reference processing parameters are obtained as follows.

At S311, a corresponding processing parameter array is determined according to the material type, and the multiple reference processing parameters are determined based on the processing parameter array.

At S312, the processing parameter array includes multiple processing preview diagrams, and each processing preview diagram corresponds to a processing preview effect of a different reference processing parameter.

In this embodiment, the processing parameter array is a structured representation that integrates processing effects corresponding to different reference processing parameters. The processing parameter array is in the form of an array, whose rows and columns can represent processing preview diagrams corresponding to different types of processing parameters (such as any two of a laser power, a pulse frequency, and a scan speed). The processing preview diagrams intuitively illustrate possible effects of processing a material using specific reference processing parameters, thereby providing a visual reference for selecting an appropriate parameter set.

The processing preview diagram is an image of a processing effect obtained after a material is processed by using a set of reference processing parameters. For example, when a metal material is cut, a processing preview diagram can clearly illustrate visual features such as the flatness of the cut surface, the smoothness of the edges, the presence or absence of an HAZ, etc., thereby helping to determine whether the parameter set meets the desired processing requirements.

First, the processing system retrieves a corresponding processing parameter array corresponding to the identified material type of the workpiece to be processed in the local database. The database pre-stores processing parameter arrays for various common material types, respectively. The database is built through extensive experimentation and data accumulation. For example, for an aluminum alloy material, the system will retrieve a processing parameter array specifically for aluminum alloy. Next, the system analyzes various processing preview diagrams in the processing parameter array. Each processing preview diagram is associated with a specific set of reference processing parameters that records processing parameters (such as the laser power in watts, the pulse frequency in hertz, etc.) configured during the current processing experiment. By analyzing the multiple processing preview diagrams and their associated parameter sets, several different reference processing parameters can be extracted. For example, five different sets of reference processing parameters can be obtained from a series of preview diagrams illustrating cutting effects with different combinations of cutting speed and laser power. Each set of parameters corresponds to a different processing effect and quality performance, thereby providing basic data for subsequent selection of the most appropriate parameter set for the current processing task.

For example, when the user places an acrylic sheet on the platform of the laser processing device, the processing system determines the material type as acrylic through image recognition or other methods. Subsequently, the system retrieves a processing parameter array corresponding to the acrylic material from the local database. The processing parameter array includes multiple processing preview diagrams, each of which illustrates an effect of engraving the acrylic material with a different reference processing parameter. For example, some processing preview diagrams illustrate fine engraved lines and smooth edges, but a relatively slow engraving speed, and their corresponding reference processing parameters might be a relatively low laser power (e.g., 30 W), a relatively high pulse frequency (e.g., 80 kHz), and a moderate scan speed (e.g., 300 mm/s), to ensure engraving precision. Some processing preview diagrams illustrate a faster engraving speed but slightly rougher line edges, and their associated reference processing parameters might be a relatively high laser power (e.g., 60 W), a moderate pulse frequency (e.g., 50 kHz), and a relatively fast scan speed (e.g., 600 mm/s), to ensure processing efficiency. The system analyzes these processing preview diagrams and their corresponding reference processing parameter, to extract five different sets of reference processing parameters, labeled as reference processing parameter A, reference processing parameter B, reference processing parameter C, reference processing parameter D, and reference processing parameter E, respectively. These reference processing parameters cover different trade-offs between processing precision and efficiency. Subsequently, the processing quality parameter corresponding to each reference processing parameter can be further determined based on the five sets of reference processing parameters. Then, a final processing parameter most appropriate for the current task of engraving the acrylic sheet can be selected according to corresponding selection rules (such as according to the user's priority on processing precision or efficiency). Finally, the final processing parameter is applied to the laser processing device to achieve high-quality and high-efficiency engraving, thereby meeting the requirements of craft production.

Optionally, the operations at S32 include the following.

At S321, a processing preview diagram corresponding to each reference processing parameter is determined in the processing parameter array.

In this embodiment, after the multiple reference processing parameters are obtained, the processing preview diagram corresponding to each reference processing parameter is accurately retrieved and determined in the processing parameter array based on an association relationship between the reference processing parameter and the array. For example, if there is reference processing parameter A, a corresponding preview diagram illustrating the effect of processing the material by using parameter set A is found in the processing parameter array according to a preset indexing rule (which may be a correspondence established based on parameter set number, parameter feature, etc.). The preview diagram clearly illustrates the surface state, shape, and other conditions of the material after processing.

At S322, a processing prediction pattern corresponding to each reference processing parameter is determined based on a processing preview diagram, processing device information, a processing method, and a processing element.

In this embodiment, the processing device information includes various parameters and performance features of the laser processing device, such as the maximum laser power range, the minimum spot size precision, and the precision and speed range of a scan system. The information reflects the processing capability limits and precision levels that the device can achieve, and will affect the actual processing effect. The processing method refers to a specific operation type used for processing the workpiece, such as cutting, engraving, drilling, surface etching, etc. Different processing methods result in significant differences in material removal and deformation, thus affecting the final processing quality and effect. The processing prediction pattern is a prediction of a final pattern that will appear in the current actual processing scenario after processing with the corresponding reference processing parameter, taking into account factors such as the preliminary processing effect illustrated in the processing preview diagram, the actual capability of the processing device, the specific processing method used, the processing element to be implemented, etc. The processing prediction pattern is more closely related to the actual processing situation than the processing preview diagram and is an important intermediate data for further analysis of processing quality.

For each reference processing parameter, basic processing features illustrated in its corresponding processing preview diagram are first extracted, such as the texture of the material surface and the smoothness of the cut edges. Next, whether the device can achieve the effect illustrated in the preview diagram in actual processing is considered in combination with the information of the laser processing device currently used. If the device's precision does not reach the level implied by the preview diagram, the effect needs to be adjusted accordingly. For example, if the minimum spot size precision of the device is larger than that of a device on which the preview diagram is based, some fine textures may not be perfectly represented in the prediction pattern and need to be appropriately blurred. Then, the processing method to be used is considered. If the processing method is engraving, the matching of the complexity and depth requirements of lines in the engraved pattern (processing element) with the engraving effect in the processing preview diagram is analyzed, and the smoothness and depth of the lines in the prediction pattern are reasonably estimated. Similarly, if the processing method is cutting, the appearance, flatness, and other features of the cuts in the prediction pattern are adjusted according to requirements such as cut width, the device capabilities, and the preview diagram. Through the above comprehensive analysis and adjustments, the processing prediction pattern corresponding to each reference processing parameter is ultimately determined.

At S323, the processing quality parameter corresponding to each reference processing parameter is obtained based on a defect determination result of the processing prediction pattern corresponding to each reference processing parameter.

In this embodiment, the defect determination result of the processing prediction pattern refers to the quantitative or qualitative description obtained after analyzing and evaluating the processing prediction pattern, which identifies an area that does not meet the ideal processing quality requirements. For example, issues such as surface roughness exceeding a standard value, a deviation between the processed shape and design requirements, and an excessive HAZ in the pattern are identified through professional image analysis algorithms, dimensional measurement methods, etc., to determine the specific details of these defects, thereby reflecting the processing quality problems that may be caused by the reference processing parameters.

For the processing prediction pattern corresponding to each reference processing parameter, image analysis software and related measurement tools are used to analyze its defects. For example, a value of the surface roughness is statistically analyzed by calculating a height difference at different positions on the processed surface in the pattern, the processing precision is determined by comparing a deviation between a shape in the processing prediction pattern and a shape required by the design by using dimensional measurement algorithms, the HAZ size is obtained by identifying and calculating an area of the HAZ in the pattern, etc. These analytical and measured results are organized and recorded according to corresponding processing quality parameter categories. For example, the specific value of the surface roughness is recorded as a value of the processing quality parameter corresponding to the reference processing parameter; the deviation of the processing precision is converted into a corresponding processing precision score, which can be determined according to a configured correspondence between the deviation range and the score, etc. In this way, a complete set of processing quality parameters corresponding to each reference processing parameter is obtained based on the defect determination result of the processing prediction pattern, providing data support for subsequent selection of the optimal processing parameter.

For example, firstly, after recognizing the material type as walnut, the processing system retrieves a processing parameter array corresponding to walnut from the database, and obtains five sets of reference processing parameters based on the array, labeled as parameter set 1, parameter set 2, parameter set 3, parameter set 4, and parameter set 5. Then, the system finds a processing preview diagram corresponding to parameter set 1 in the processing parameter array. The diagram illustrates the approximate effect of engraving the walnut material by using parameter set 1, such as relatively clear grain lines, but some line edges being slightly rough, and the engraving depth being relatively shallow. Next, the processing preview diagram is adjusted according to the information of the currently used laser processing device (laser power adjustment precision, scan speed range, etc.), the current processing method (fine engraving), and processing elements to be implemented (complex patterns required in the design pattern, with precise requirements for line thickness and depth), to generate a processing prediction pattern corresponding to parameter set 1. In this process, considering the limited precision of the laser power adjustment of the device, the control of the engraving depth may not be as ideal as in the preview diagram. Therefore, the engraving depth is appropriately adjusted in the prediction pattern. Meanwhile, a more realistic estimation of the line smoothness and edge smoothness is made according to the requirements for line precision in the complex patterns of the design pattern and the device's scan speed range. Ultimately, the processing prediction pattern corresponding to parameter set 1 is obtained. Subsequently, a defect determination result of the processing prediction pattern corresponding to parameter set 1 is analyzed. The height difference at different positions on the surface of the pattern is measured by using the image analysis software, and the surface roughness is calculated as Ra2.5 μm (which is the corresponding processing quality parameter—the value of the surface roughness). A deviation of 0.1 mm is found in some lines by comparing the deviation between the shape of patterns in the processing prediction pattern and the shape required by the design. According to the configured processing precision scoring rules (full score for a deviation within 0.05 mm, and a certain percentage deduction for every additional 0.01 mm), the processing precision score is determined as a certain value. Then, other processing quality parameters, such as the HAZ size, are obtained by identifying and calculating the area of the HAZ in the pattern. With the same method, corresponding processing prediction patterns and processing quality parameters are determined for parameter set 2, parameter set 3, parameter set 4, and parameter set 5, respectively. Finally, based on the processing quality parameters, a comprehensive evaluation score for each parameter set is calculated according to preset weights. For example, if the user prioritizes the processing precision and the surface roughness, the two parameters are given higher weights, and then a parameter set with the highest score is selected as the final processing parameter for engraving the walnut board.

Based on any embodiment, in a possible embodiment of the present disclosure, before the processing area image is identified and the material type of the workpiece to be processed is determined, the method includes the following operations.

At A10, an obtained processing area image is displayed in the interaction interface in response to a selection instruction of an acquisition control for the processing area image in the interaction interface.

At A20, if a processing element is displayed in the interaction interface, the processing element and the processing area image are merged with each other and then displayed in the interaction interface, where the processing element is placed above a layer of the processing area image.

In this embodiment, the interaction interface serves as a visual platform for an operator to engage in human-machine interaction with the laser processing system. It integrates various controls, display areas, and feedback mechanisms, presents system status graphically and intuitively, receives instructions from the operator, and enables convenient control over the entire laser processing process. Like an intelligent control hub, it simplifies the complex operations of the processing system into an interface interaction that is easy to understand and operate. The acquisition control for the processing area image is a dedicated button in an operation instruction area of the interaction interface. Serving as a key component for triggering the capture and display of the processing area image, the acquisition control is to send an image capture instruction to the processing equipment and initiate the entire image visualization process. By clicking on this control, similar to pressing a camera shutter, the operator initiates a “snapshot” of the processing site and imports the captured image into the interaction interface. An image display area is a core area of the interaction interface, and is dedicated to presenting the processing area image and subsequent possible images, such as a processed recognition image, a processing monitoring image, etc. The image display area serves as a “window” for the operator to observe the actual state of the processing material. Through high-resolution and appropriately scaled image display, the operator can make accurate processing decisions, such as determining whether the workpiece is placed correctly, whether the label information is clearly visible, etc.

In this embodiment, the overall interaction interface is divided into multiple functional areas, including the image display area, the operation instruction area, a parameter configuring area, and a status feedback area. The image display area occupies a relatively large central position on the interface and is used to present the processing area image and related image information in real time during subsequent processing, such that it can be ensured that the operator can clearly and intuitively observe the material status. A prominent “capture image” button is configured in the operation instruction area. The button may have a concise and clear icon, such as a small camera icon, to further emphasize its functional cue. The button is aimed to trigger the processing device to capture an image and send the captured processing area image to the interaction interface for display.

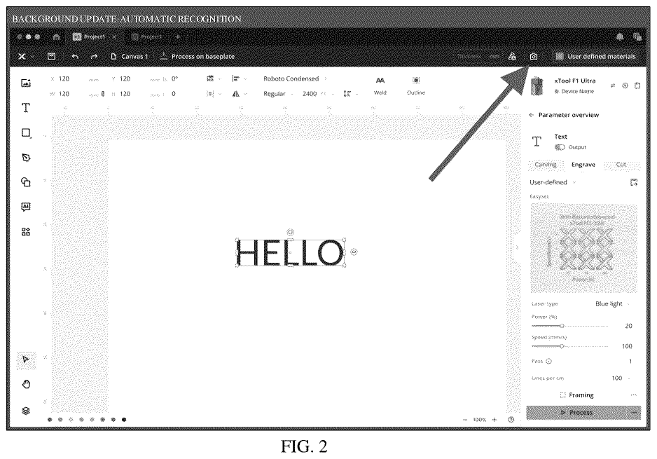

Reference may be made to FIG. 2. When the operator clicks on the “capture image” button, the terminal device hosting the interaction interface immediately monitors this operation. The built-in event handling program in the system is then activated. The program first sends the processing device an image capture instruction, which is accurately sent to the processing device via a pre-established communication link. Upon receiving the instruction, the processing device starts an image capture apparatus (typically a high-definition camera) according to a predetermined process, quickly capturing the processing area image corresponding to the processing platform. After the capture is completed, a built-in communication module packages the image data in a specific image format (such as JPEG or PNG) and sends it back to the terminal device system hosting the interaction interface via the same communication link.

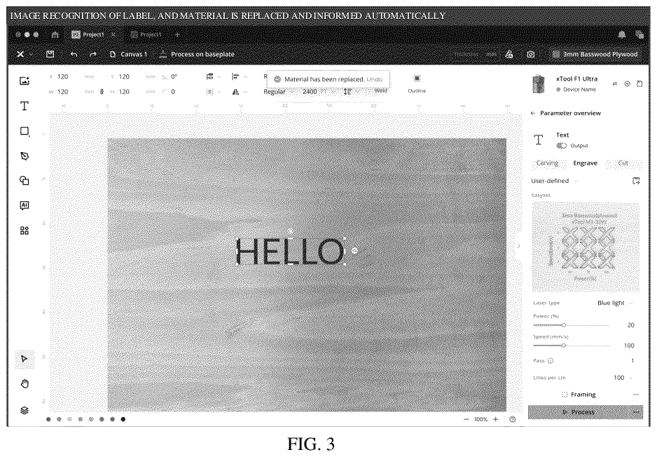

After receiving the image data, the terminal device system runs a dedicated image parsing program. The program decodes and decompresses the incoming image data, converting it into a format that can be directly displayed in the image display area of the interaction interface. Then, reference may be made to FIG. 3, and the processing area image is fully displayed at a designated position in the image display area, with an appropriate size (e.g., covering 80% of the display area while leaving some boundaries for auxiliary information) and with a clear resolution. In this case, the operator can visually observe key information, such as the placement status, surface feature, any possible label information, etc., of the workpiece to be processed on the processing device platform, thereby providing a visual basis for subsequent processing operations.

In this embodiment, the processing element refers to pattern content to be processed onto the material by using laser processing technology. The processing element may be a combination of various graphics or texts with specific shapes, colors, and functions, and represents the visual representation of a final laser-processed result on the material surface. After pre-designing or on-site drawing and processing, the processing element and the processing area image are merged with each other and displayed, providing the operator with an intuitive processing preview effect. The merging and displaying is to superimpose and combine a layer containing the processing element pattern and the layer of the processing area image according to certain rules (such as coordinate alignment, transparency adjustment, etc.) through specific image processing technology and layer management mechanism, such that the operator can view a preview diagram in the interaction interface that illustrates both the actual state of the workpiece to be processed and the pattern effect to be processed on the workpiece, facilitating the operator in previewing, confirming, and making necessary adjustments to the processing content.

In an optional embodiment, the operator may pre-design the required pattern by using a professional graphic design software (such as AdobeIllustrator, CorelDRAW, etc.). The pattern may be a brand logo, a decorative pattern, a functional symbol, or a specific-shaped hole contour, etc., may be saved in a specific graphic file format (such as SVG, DXF, etc., which effectively retains vector information of the graphic and facilitates subsequent processing), and then may be imported into the terminal device software. Alternatively, the operator may directly draw on-site by using a simplified graphic drawing tool built into the terminal device software. For example, simple geometric shapes can be drawn by clicking on and dragging with a mouse, or text patterns can be created by entering text content, thereby meeting the needs for temporary or simple processing patterns.

Once the processing area image is displayed in the interaction interface, image alignment and coordinate matching are performed first to accurately merge and display the processing element pattern and the processing area image. The terminal device system determines the actual coordinate position of the image in the interaction interface by recognizing certain reference features in the processing area image (such as fixed corner markers of the processing device platform or preset positioning points). Meanwhile, the terminal device system aligns a coordinate system of the processing element pattern with that of the processing area image, ensuring that the pattern can be precisely “placed” at the corresponding material position. For example, if the processing element pattern is a circular marker positioned at the center of the material, coordinate matching ensures that the center of the circular marker exactly corresponds to a pixel coordinate point of the center of the material in the processing area image in the interaction interface, which guarantees accurate positioning during subsequent merging and displaying.

Based on any embodiment mentioned above, in a possible embodiment of the present disclosure, the material type is determined based on the matching degree between the feature information and the various material features in the configured material feature database as follows.

At B10, if at least one candidate material type is obtained by matching the feature information with the configured material feature database, a material type determination control is displayed in the interaction interface, where at least one candidate box is displayed in the material type determination control, and one candidate material type is displayed in each candidate box.

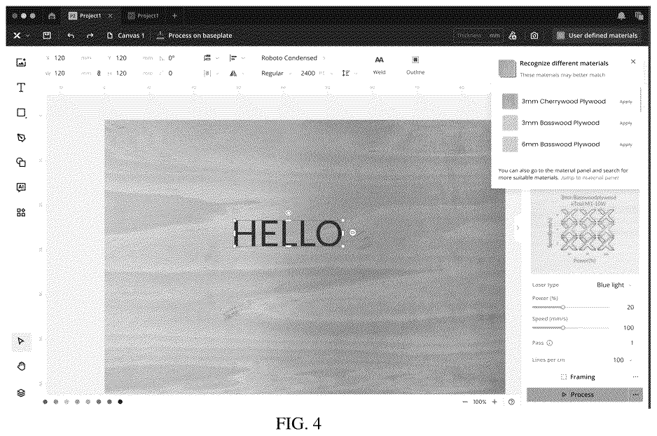

In this embodiment, the candidate material type refers to a type of material whose similarity to the feature of the workpiece to be processed reaches a certain threshold (the threshold is configured based on experience and experiments) after matching and comparing the feature information of the workpiece to be processed and the various material features in the configured material feature database. The candidate material type may be several potential types that may match the actual type of the workpiece to be processed. The material type determination control is an interactive component in the interaction interface specifically designed to assist the user in determining the type of the workpiece to be processed. The material type determination control is presented to the user in a visual form for easy and intuitive operation. The material type determination control includes at least one candidate box, and each candidate box corresponds to one candidate material type, allowing the user to clearly view all possible material type options obtained through matching. As illustrated in FIG. 4, at least one candidate material type is recognized. The upper right corner of FIG. 4 illustrates an example of the material type determination control, with drop-down candidate boxes displaying various candidate material types.

First, the processing system matches the extracted feature information of the workpiece to be processed with the configured material feature database, which involves complex algorithmic calculations. For example, for texture features, quantitative indicators such as the direction and roughness of the textures are compared; and for color features, the numerical distribution of colors in specific color space is compared. By comprehensively evaluating matching results of various features, a material type with relatively high similarity is selected as the candidate material type. Assume that three candidate material types, i.e., “oak”, “walnut”, and “maple”, are obtained after matching.

Then, the material type determination control is generated and displayed at an appropriate position (typically near the main area for easy attention and operation) in the interaction interface. This control is presented as a visual area including at least one candidate box, the number of which is equal to the number of candidate material types. In this example, three candidate boxes will be generated, each clearly displaying “oak”, “walnut”, and “maple” to clearly inform the user of all possible material type options obtained through matching, thereby facilitating further user confirmation.

At B20, in response to a selection instruction for the at least one candidate box, a candidate material type corresponding to a selected candidate box is determined as the material type of the workpiece to be processed.

In this embodiment, the selection instruction refers to an operation that the user selects a candidate box in the material type determination control by clicking on the mouse, using keyboard shortcuts, touching the screen (if touch interaction is supported for the device), etc. The operation is a key interactive behavior for the user to determine a final material type from the candidate material types based on their understanding of the workpiece, processing experience, or other reference information.

After the material type determination control which includes candidate boxes and corresponding material types is displayed in the interaction interface, the user can perform the selection instruction by moving a mouse pointer to a candidate box considered to be correct and clicking on a left button of the mouse according to factors such as their preliminary judgment of the workpiece to be processed (such as its origin, appearance, feel, etc.,) or previous processing experience. For example, if the user determines, by observing the texture and color of the material, that the material more closely resembles “walnut”, the user clicks on a candidate box labeled “walnut”. The system monitors this selection instruction in real time and immediately determines a candidate material type (in this case, “walnut”) corresponding to the selected box as the final material type for the workpiece to be processed. Subsequently, according to the determined material type, the system automatically associates and displays a corresponding processing parameter array and related specific processing parameters in a parameter configuration control area on the right side of the interaction interface. As such, the user can further adjust and confirm the processing parameter to prepare for the subsequent laser processing operation.

Exemplarily, the operator first places a timber on the platform of the laser processing device, clicks on a “capture processing area image” button through an operation control at the top of the interaction interface, to obtain a processing area image containing the timber, and then displays the image on the left side of the main area of the interaction interface. Subsequently, the system automatically extracts feature information of the timber, covering various features such as the unique texture direction, color depth, and shape contour of the timber surface, and matches the feature information with the configured material feature database.

After matching and calculation, the system filters out three candidate material type: “pine”, “fir”, and “cypress”, and concludes that the timber likely belongs to one of the three types. Subsequently, the material type determination control pops up in the interaction interface, where the control is presented as a bordered area containing three neatly arranged candidate boxes. Each candidate box clearly displays a word of “pine”, “fir”, or “cypress”, such that the operator can easily see all possible material type options.

For example, the operator carefully observes the texture of the timber, thinks that the relatively fine and uniform texture of the timber is more consistent with the feature of “fir”, and thus clicks on a candidate box displaying “fir”. The system immediately received this selection instruction, and then determines “fir” as the material type of the workpiece to be processed. Next, a processing parameter array corresponding to “fir” is automatically displayed in the parameter configuration control area on the right side of the interaction interface. The array includes different processing preview diagrams and multiple sets of reference processing parameters. Below the array, some specific processing parameters (such as laser power, pulse frequency, etc.,) and their corresponding parameter adjustment controls are listed, such that the operator can further adjust and determine the final processing parameter according to specific requirements of the engraving task.

Based on any embodiment mentioned above, in a possible embodiment of the present disclosure, the method further includes the following.

At C10, in response to a selection instruction via a material selection control in the interaction interface, a material list control is displayed over an editing area of the interaction interface. The material list control includes multiple material schematic diagrams, and each material schematic diagram corresponds to one material type. Each material schematic diagram displays at least one of material property, texture, color, and thickness information of a corresponding material type. The multiple material schematic diagrams are arranged in rows and/or columns.

In this embodiment, reference may be made to FIG. 2 to FIG. 4, the interaction interface includes an editing area, and the editing area is used for editing a processing element that is a pattern to be processed onto the workpiece to be processed. For example, “HELLO” as illustrated in FIG. 2 to FIG. 4 may be understood as the processing element in this embodiment. The material selection control is a button or a function option within an operation control area of the interaction interface. The material selection control is mainly used by the user to actively initiate selection of a material type. The material selection control may be clicked to trigger the subsequent display of material-related information, such that the user can perform searching and selection among various material types. The material selection control serves as an entry control for initiating material type filtering.

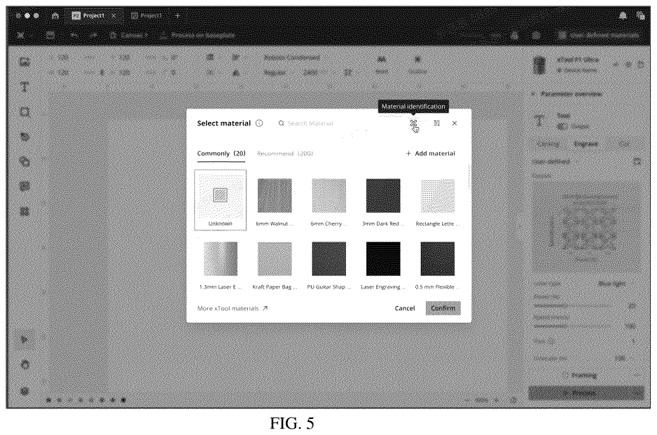

The material list control is a visual control that pops up in the system after the user clicks on the material selection control. The material list control is displayed over the editing area and presents multiple types of material-related information intuitively. The material list control includes multiple material schematic diagrams that are arranged in rows and/or columns. These schematic diagrams assist the user in quickly recognizing different material types through graphical representation, covering a wide range of common processable materials and providing a reference for the user to further determine the type of the workpiece to be processed. Reference may be made to FIG. 5, which is an example of a material list control. Multiple material types are displayed in the material list control, and each material type is represented by a material schematic diagram and its corresponding name. Each material schematic diagram displays the material property, texture, and color of the corresponding material type.

After opening the interaction interface corresponding to the laser processing device, the user focuses on the operation control area at the top of the interface and searches for the “material selection control” (this control may have a clear icon, such as a drop-down arrow labeled “select material”, for easy identification). The user clicks on the “material selection control” with the mouse. Upon receiving this instruction, the system immediately pops up and displays the “material list control” at an appropriate position (typically below or near the operation control area for convenient viewing) in the interaction interface. The “material list control” is presented as a scrollable area with multiple neatly arranged material schematic diagrams. Each schematic diagram clearly illustrates an appearance feature of a material. For example, for a timber, the schematic diagram might illustrate the texture, color, and approximate shape of the timber; and for a metal material, the schematic diagram displays the gloss, color, and other appearance features of the metal material. Each material schematic diagram corresponds to one specific material type, such as oak or aluminum alloy, allowing the user to intuitively browse different workpiece options.

At C20, in response to a selection instruction via a material identification control in the material list control, at least one candidate material type is determined by triggering capturing and recognizing the processing area image corresponding to the processing device platform.

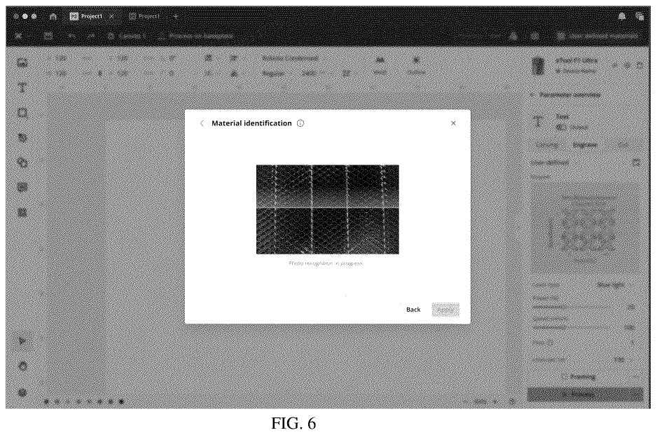

In this embodiment, the material identification control is an operation button within the material list control. The material identification control is mainly used to initiate an image capture and recognition process when clicked by the user. The processing area image is captured on the workpiece to be processed placed on the processing device platform. Then, based on the solution described above, at least one candidate material is obtained according to the processing area image. Reference may be made to FIG. 6, which is an example of a recognition process of a material identification control, i.e., an animated transition during material identification.

After viewing the multiple material schematic diagrams displayed in the “material list control”, according to their preliminary judgment of the appearance and other features of the workpiece to be processed on the processing device platform, the user locates a corresponding area of the material schematic diagrams and then finds the “material identification control” (the control may be labeled with prompts such as “identify this material”) within the area. When the user clicks on the “material identification control”, the system immediately triggers a series of background operations. First, the system controls an image capture apparatus (such as a camera) installed on the processing device to obtain a processing area image corresponding to the processing device platform, i.e., capturing an image of the workpiece to be processed placed on the platform. Then, the image recognition technology mentioned earlier is adopted to analyze the processing area image to extract material feature information (such as texture, color, shape, etc.). The material feature information is compared and matched with the configured material feature database to filter out a material type with a high similarity, and then at least one candidate material is determined. For example, if the user clicks on a material identification control in an area corresponding to a material schematic diagram of “acrylic”, the system determines “acrylic” and its similar material, such as “plexiglass”, as candidate materials through identification and analysis after capturing the processing area image.

At C30, at least one candidate box is displayed in the material type determination control in the interaction interface, where detailed information associated with one candidate material type is displayed in each candidate box, and the detailed information includes a material image and a material name.

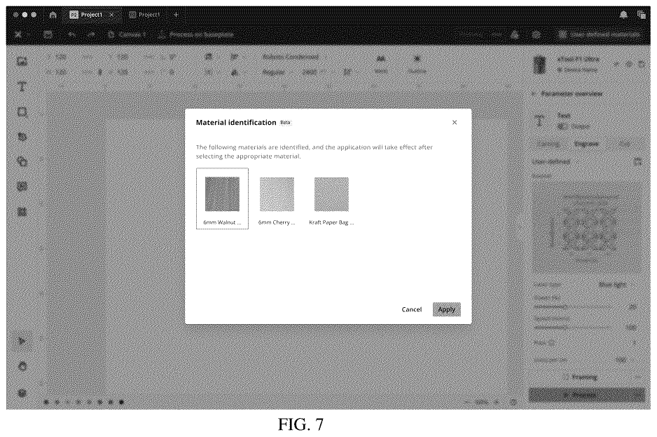

In this embodiment, the material type determination control is an interactive component in the interface used to assist the user in finally determining the type of workpiece to be processed. The material type determination control receives candidate material information identified in the previous operation and displays the candidate material information to the user in the form of candidate boxes. Each candidate box presents detailed information of a corresponding candidate material, facilitating user comparison and selection and ensuring the accuracy of the finally determined material type. Reference may be made to FIG. 7, which is an example of a material type determination control in a material list control. At least one identified candidate box is displayed in the material type determination control, detailed information associated with a candidate material type is displayed in each candidate box, and the detailed information includes a material image and a material name. FIG. 7 illustrates three candidate materials. The detailed information contains key descriptive content of the candidate material, where the material image allows the user to visually determine the appearance feature of the material again, and the material name clearly identifies a specific name of the material. The combination of these two helps the user better judge and select an appropriate material type, avoiding misjudgment caused by a single factor, such as a text or an image alone.

After the at least one candidate material is determined through the image recognition and matching operations mentioned above, the system generates and displays the “material type determination control” in an appropriate display area (typically near the main area for easy attention and operation) in the interaction interface. The material type determination control is presented as a visual area containing at least one candidate box, the number of which is equal to the number of candidate materials.

For each candidate material, the system displays its associated detail information in a corresponding candidate box. For example, for a candidate material “acrylic”, a clear image of the standard appearance of an acrylic material will be displayed in its corresponding candidate box, allowing the user to intuitively see the actual appearance of the acrylic. At the same time, a word “acrylic” will be clearly marked as the material name, such that the user can clearly know the specific name of the candidate material. Through such detailed information display, the user can easily select a material type that matches the actual workpiece to be processed from the multiple candidate materials.

At C40, in response to a selection instruction for the at least one candidate box, a candidate material type corresponding to a selected candidate box is determined as the material type of the workpiece to be processed.

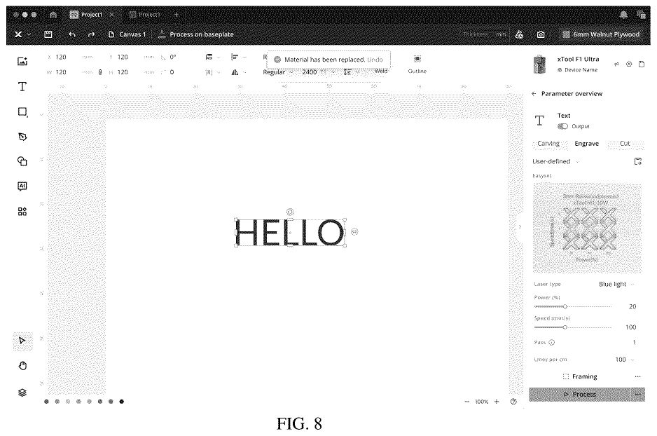

In this embodiment, the user carefully checks detail information associated with a candidate material displayed in each candidate box in the “material type determination control”. Combining with their understanding of the actual workpiece to be processed (such as the origin and feel of the material, previous experience, etc.), the user performs the selection instruction by moving the mouse pointer to the most suitable candidate box and clicking on the left button of the mouse. For example, if the user notices that a material image displayed in one candidate box closely resembles the actual workpiece to be processed and the corresponding material name matches their expectations, the user clicks on the candidate box. The system monitors the selection instruction in real time and immediately determines a candidate material type corresponding to the selected candidate box as the final material type for the workpiece to be processed. Subsequently, according to the determined material type, the system automatically associates and displays a corresponding processing parameter array, specific processing parameters, and related configuration controls in a corresponding area of the interaction interface (such as the parameter configuration control area on the right). As such, the user can further adjust and confirm the processing parameter to prepare for the subsequent laser processing operation. Reference may be made to FIG. 8, which illustrates an adjusted display interface after the user selects a candidate material type as the material type for the workpiece to be processed, where a processing parameter array and a processing parameter corresponding to a material type are displayed in the interface.

Exemplarily, the user opens the interaction interface corresponding to the laser processing device and sees the “material selection control” (with a small drop-down arrow icon) in the operation control area at the top of the interface. The user clicks on the “material selection control” with the mouse. Immediately, the “material list control” pops up below the operation control. The material list control is filled with various neatly arranged material schematic diagrams, including various schematic diagrams of wood with clear grain patterns, various schematic diagrams of metal materials with different surface gloss levels, and various schematic diagrams of materials with different appearances, such as plastic and glass. The user browses through and thinks that the transparent material might be similar to “acrylic” or “plexiglass”. Therefore, the user searches for an area of a schematic diagram corresponding to “acrylic” in the “material list control”, sees a “material identification control” (labeled with words “click to identify if this is the material”), and clicks on the material identification control with the mouse. Upon receiving the click instruction, the system immediately controls the camera on the processing device to capture a processing area image of the transparent material placed on the platform. Then, the system analyzes the image to extract feature information such as texture, color, transparency, etc., of the material, matches the feature information with the configured material feature database, and ultimately determines “acrylic” and “plexiglass” as the two candidate materials. Subsequently, the “material type determination control” appears next to the main area of the interaction interface, containing two candidate boxes. A candidate box displaying the candidate material “acrylic” shows a high-resolution image of a standard acrylic material, clearly demonstrating its clear, transparent, and smooth surface and explicitly labeled a word “acrylic”. The other candidate box displaying the candidate material “plexiglass” also shows a typical image of plexiglass and is labeled a word “plexiglass”. The user carefully compares the actual material with the images in the two candidate boxes, recalls previous experiences with similar materials, and thinks that the actual material better matches the feature of “acrylic”. Therefore, the user clicks on the candidate box displaying “acrylic”. The system immediately identifies the selection instruction and determines “acrylic” as the material type for the workpiece to be processed. Immediately, a processing parameter array corresponding to “acrylic”, specific processing parameters (such as recommended values for laser power and pulse frequency), and corresponding parameter adjustment controls are automatically displayed in the parameter configuration control area on the right side of the interaction interface.

Based on any embodiment mentioned above, in a possible embodiment of the present disclosure, after the material type is determined, the method further includes the following.

At D10, the material type of the workpiece to be processed is displayed in the material type display control in the interaction interface, where the displayed material type of the workpiece to be processed includes a material schematic diagram displayed in the interaction interface, and the material schematic diagram illustrates the texture, material, and color of the corresponding material type.

At D20, a processing parameter array corresponding to the material type is displayed in the parameter configuration control in the interaction interface.

Optionally, after the operations at D20, in response to a selection instruction for a processing preview diagram in the processing parameter array, the final processing parameter is determined according to parameters of a target processing preview diagram corresponding to the selection instruction.

Based on the existing interaction interface of the laser processing system, the layout is further refined, with a dedicated information display area adjacent to the display area of the processing area image, such that the operator can easily access key information while viewing the material image. The information display area can be further subdivided into a material type display area and a parameter configuration display area, which respectively correspond to a material type display control and a parameter configuration control that will be presented later.

As illustrated in FIG. 8, a multi-level drop-down control is displayed in the material type display area. The parameter configuration display area is in the form of a table as the parameter configuration control. The table header displays various processing parameter categories in bold, such as laser power, laser pulse frequency, scan speed, spot diameter, etc. Each row corresponds to one set of processing parameters. In addition to displaying the specific parameter values, a cell also reserves space for displaying processing preview diagrams. These preview diagrams are presented as thumbnails with a uniform size and appropriate resolution, displaying key details without occupying excessive space. Initially, the table is filled with corresponding information according to the default parameter set that is preconfigured by the system or used for the last processing, but the processing preview diagrams are in an unloaded or default preview state.

After the identification of the type of the workpiece to be processed is completed based on the label information, the terminal device system immediately obtains the type information and sends it as key data to a control logic module of the interaction interface. Upon receiving the information, the control logic module triggers an update event for the material type display control. According to the received trigger instruction, the material type display control fills the drop-down box with the text information of the type of the workpiece to be processed (such as “walnut sheet”, “acrylic sheet (5 mm thickness)”, etc.,) in real time, to clearly and intuitively inform the operator of the specific category of the workpiece to be processed. As such, the operator no longer needs to perform other complex operations to query the material type since the material type is very clear.

After learning the type of the workpiece to be processed, the terminal device quickly queries its local processing parameter database, extracts, according to preset selection rules and optimization algorithms, multiple processing parameters matching the material type to form a processing parameter array. These parameter sets cover optimized choices for different working conditions. For example, for scenarios requiring high-precision cutting, there is a set of parameters with low scan speed, small spot diameter, high laser power, and compatible pulse frequency; and for efficient batch processing, there is a set of parameters focusing on high scan speed and appropriate power. For each extracted processing parameter, a corresponding processing preview diagram is obtained. These preview diagrams reflect the surface quality, cutting edge condition, and engraving fineness that may be obtained using different parameter sets in actual processing. According to the order of the parameter sets in the array, the processing preview diagrams are sequentially loaded into corresponding positions in the table cells of the parameter configuration control.

The processing preview diagram is pre-generated. The terminal device uses its built-in simulation processing function module to perform virtual processing simulation based on a digital model of the workpiece to be processed (this model can be initially constructed according to the processing area image and the material type information, including the basic physical properties, geometric shape, etc., of the material) according to the corresponding parameter set. During the simulation, a physical model of the interaction between laser and material is considered, such as the melting, vaporization, heat conduction, or other effects of the material, and finally the processing preview diagram is generated.

Optionally, the operator can intuitively view the processing parameter array and various processing preview diagrams presented in the parameter configuration control in the interaction interface. The operator can hover the mouse over a preview diagram to view magnified details, compare the processing effects corresponding to different parameter sets, and select the most appropriate set of parameters according to actual processing needs (such as precision requirements, efficiency priorities, etc.). When the operator clicks on a row containing a parameter set, a corresponding parameter value corresponding to the row is highlighted for easy confirmation of the selection. At the same time, the system marks the selected parameter set as the current execution plan that is to be applied to subsequent actual processing operations. The entire process realizes a visual and interactive selection and optimization of the processing parameter.

In a possible embodiment of the present disclosure, the interaction interface displays the parameter configuration control, the processing parameter array is in an image format, and the array element corresponding to the selected processing preview diagram is taken as the target processing parameter in response to the selection instruction for the processing preview diagram in the processing parameter array as follows. An operation pointer is moved to the parameter configuration control in the interaction interface, and the processing parameter array is hovered in the interaction interface. In response to the hovering operation performed on the processing parameter array, one processing preview diagram in the hovered processing parameter array is clicked on, and a processing parameter indicated by the array element corresponding to the selected processing preview diagram is taken as the target processing parameter.

Further, after the processing parameter array corresponding to the material type is displayed in the parameter configuration control of the interaction interface, the method includes the following. In response to the selection instruction for the processing preview diagram in the processing parameter array, parameters of the target preview diagram corresponding to the selection instruction are taken as the final processing parameter.

When the operator clicks on a processing preview diagram (i.e., the target preview diagram), the monitor quickly captures this operation, accurately locates a position of the clicked target preview diagram in the processing parameter array, and then extracts the set of parameters from the corresponding cell. For example, if the target preview diagram corresponds to a set of parameters designed for fine engraving, including a laser power of 300 W, a laser pulse frequency of 18 kHz, a scan speed of 500 mm/s, and a spot diameter of 0.12 mm, these values are fully obtained. After extracting the parameters of the target preview diagram, the control logic module sets these parameters as the final processing parameter and updates the processing parameters in the system global state.

Further, to ensure the operator are clearly aware of their current selection, the following feedback measures are adopted in the interaction interface. In the parameter configuration control area, the row containing the selected target preview diagram is highlighted with a bright color (such as golden yellow) to make it stand out among the various parameter sets, and the corresponding parameter values are displayed in a larger and more prominent font for easy confirmation. A brief confirmation message, such as “processing parameter is selected based on [target preview diagram]”, is displayed in a status bar or a dedicated prompt area in the interaction interface to further remind the operator of their selection. The final selected processing parameters are sent to the processing device in real time. The control system of the device receives and stores these parameters, prepares for the upcoming actual processing, and ensures that the processing will achieve the desired effect as expected by the operator.

Optionally, after the processing parameters are determined, the method further includes the following.

At D30, the processing parameters are displayed in the parameter configuration control of the interaction interface, where the processing parameters include multiple processing parameters, and each processing parameter displays a corresponding parameter adjustment control in the parameter configuration control.

In this embodiment, the parameter adjustment control is an interactive element configured in the parameter configuration control for each processing parameter, and is used by the user to conveniently change the value of the processing parameter. The parameter adjustment control may be in various forms, such as a value input box, add/delete buttons, a slider, etc. By operating these controls, the processing parameters can be adjusted intuitively to meet specific processing needs.

After the system determines the final processing parameter through a series of operations (such as material type identification, reference processing parameter selection, etc.), the system will display the parameter set in the parameter configuration control area on the right side of the interaction interface. For example, assume that the determined processing parameters include a laser power of 50 W, a pulse frequency of 40 kHz, a scan speed of 300 mm/s, a spot size of 0.15 mm, and a defocus amount of +1 mm. In the parameter configuration control area, each processing parameter will have a corresponding display position and a corresponding parameter adjustment control. For the laser power parameter “50 W”, there may be a value input box (where the user can directly enter the desired value) next to it, as well as “+” and “−” increase/decrease buttons (each click increases or decreases the power value by a preset step size). The pulse frequency “40 kHz” may be accompanied by a slider control, which the user can drag to change the frequency value, and the current specific frequency value will also be displayed next to the slider in real time. Parameters such as scan speed, spot size, and defocus amount are also equipped with corresponding appropriate parameter adjustment controls in a similar manner, making it convenient for the user to clearly and intuitively see the current value of each processing parameter and perform subsequent adjustment operations.

At D40, in response to adjustment operations through the parameter adjustment control, adjusted processing parameters are taken as the final processing parameter to determine the final processing parameter.

In this embodiment, the adjustment operation means that the user operates the parameter adjustment control by clicking on or dragging the mouse, or typing with the keyboard to change the original value of the processing parameter. This is an operation process of personalizing the determined processing parameter based on the user's specific requirements for the current processing task (such as pursuing higher processing precision, faster processing speed, etc.) and expectations for the processing effect.

The user can adjust the various parameter configuration controls in the parameter configuration control according to their desired processing effect. For example, if the user expects to improve processing precision and thinks that the current laser power might be slightly too high and affect accuracy, the user may reduce the laser power by clicking on the “−” button corresponding to the laser power parameter or by entering a slightly smaller value (such as adjusting from 50 W to 45 W) in the value input box. If the user expects to increase the processing speed, the user can drag the slider of the scan speed to increase the scan speed value from 300 mm/s to 400 mm/s.

The system monitors every operation on the various parameter adjustment controls by the user in real time. After the user completes all necessary adjustments, the system recombines the adjusted value of each processing parameter to form a new set of processing parameters, and the new set of processing parameters is the final processing parameter. For example, after the above adjustments, the final processing parameter includes: a laser power of 45 W, a pulse frequency of 40 kHz, a scan speed of 400 mm/s, a spot size of 0.15 mm, and a defocus amount of +1 mm. The system records the final set of processing parameters and uses it to control the laser processing device to perform the actual processing operation, achieving the processing effect expected by the user.

For example, after determining a specific type of plastic sheet through material type recognition, the system determines an initial processing parameter through a series of operations such as selection, and the initial processing parameter is displayed in the parameter configuration control area on the right side of the interaction interface. In the initial processing parameter, the laser power is configured to 60 W, the pulse frequency is 30 kHz, the scan speed is 500 mm/s, the spot size is 0.2 mm, and the defocus is 0 mm. In the parameter configuration control area, each processing parameter has a corresponding parameter adjustment control. The laser power “60 W” is next to a text box for inputting a value and two small buttons, one labeled “+” and the other labeled “−”. “+” is clicked each time to increase the power by 5 W, and “−” is clicked each time to decrease the power by 5 W each time. The pulse frequency corresponds to a slider, with one end labeled “low” and the other end labeled “high”. When the slider is dragged, a current specific frequency value is displayed below the slider in real time. The scan speed is also adjusted with a slider. The spot size and the defocus amount are each equipped with an appropriate input box and increase/decrease buttons for parameter adjustment. If the operator reviews the initial parameters and decides to reduce the laser power, the operator can click on the “−” button next to the laser power parameter twice, adjusting the laser power from 60 W to 50 W. Simultaneously, to maximize processing speed while maintaining the precision, the operator drags the scan speed slider, increasing the scan speed from 500 mm/s to 600 mm/s. The system captures the operator's operations on these parameter adjustment controls in real time, records the set of adjusted parameters, i.e., a laser power of 50 W, a pulse frequency of 30 kHz, a scan speed of 600 mm/s, a spot size of 0.2 mm, and a defocus amount of 0 mm, as the final processing parameter, and controls, according to the set of final parameters, the laser processing device to perform the actual cutting operation.

Based on any embodiment mentioned above, in a possible embodiment of the present disclosure, after the processing parameters for the workpiece to be processed are obtained based on the material type matching, the method includes the following.

At S40, processing preview diagrams corresponding to the processing parameters are displayed in the interaction interface.

At S50, in response to the selection instruction for the processing preview diagrams in the interaction interface, the workpiece to be processed is processed based on the processing parameters.

In this embodiment, the processing preview diagram is an image generated based on determined processing parameters, which simulates the processing process or records previous processed results of the same material using the same parameter set. The processing preview diagram roughly illustrates the appearance of the material after processing with the current parameters. The processing preview diagram allows the user to intuitively understand the processing effect in advance, including the processed shape, surface quality, processing details, etc., thereby assisting the user in determining whether the processing parameters meet their expectations.

Once the system obtains the processing parameters for the workpiece to be processed based on the material type, the system immediately invokes a preset processing effect simulation module or searches the database of previous processing cases with the same parameters and material (if available). Based on the current processing parameters (such as the specific values of laser power, pulse frequency, scan speed, spot size, defocus amount, etc.), the system simulates the effect on the workpiece to be processed or extracts related historical processing image data to generate a corresponding processing preview diagram. Then, the generated processing preview diagram is displayed in an appropriate position in the interaction interface, typically in a place easily accessible to the user in the main area, such as near the area of merging and displaying the processing area image and the processing element, or in a prominent and logical position below the parameter configuration control area, presented at an appropriate size and clarity, such that the user can clearly observe the approximate effect after processing. For example, for engraving, the user can see the shape of the engraved pattern, the clarity of the lines, and the depth effect, etc., and for cutting, the user can see the flatness, width, etc., of the cut.

After viewing the processing preview diagram in the interaction interface, the user will carefully observe whether the processing effect presented in the image meets the requirements of their processing task, for example, whether the processing precision meets the standards, whether the overall appearance meets design expectations, etc. If the user is satisfied with the effect as illustrated in the processing preview diagram, the user may perform the selection instruction by moving the mouse pointer to the processing preview diagram and clicking on the left button of the mouse (taking a common computer operation as an example). Upon monitoring the selection instruction for the processing preview diagram by the user in real time, the system immediately enables the laser processing device, and sends the determined processing parameters (specific values of various parameters) to the control system of the processing device, such that the control system can control the laser head (or other processing execution components) to perform corresponding processing actions on the workpiece to be processed according to these parameter configurations. For example, the power, pulse frequency, scan speed, etc., of the laser head are adjusted, and a specific processing operation such as cutting, engraving, etc., is performed on the workpiece to be processed according to the configured parameters such as spot size and defocus amount, until the entire processing task is completed.

For example, through the above operations, after the system identifies the material type of the workpiece to be processed as oak, a set of processing parameters, including laser power of 80 W, pulse frequency of 50 kHz, scan speed of 300 mm/s, spot size of 0.15 mm, and defocus amount of +1 mm, is obtained based on the feature of oak. Subsequently, based on the set of processing parameters, the system generates a corresponding processing preview diagram by utilizing actual case data from previous engraving operations performed on the oak material using the same parameters. The processing preview diagram is displayed below the main area of the interaction interface, clearly illustrating the effect of engraving the company logo. The lines of the logo appear to be of uniform thickness and smooth edges, and the overall engraving depth is also appropriate, effectively highlighting the three-dimensionality of the logo. The operator can clearly see the approximate appearance after engraving. After carefully reviewing the processing preview diagram, the operator thinks that the processing preview diagram meets the requirements of this customized gift in all aspects and then clicks on the processing preview diagram with the mouse. Upon receiving the selection instruction, the system immediately controls the laser processing device to operate according to the previously determined processing parameters. The laser head outputs a laser beam with a laser power of 80 W and a pulse frequency of 50 kHz, moves on the oak thin board at a scan speed of 300 mm/s, and performs processing based on the configured parameters, such as a spot size of 0.15 mm and a defocus amount of +1 mm.

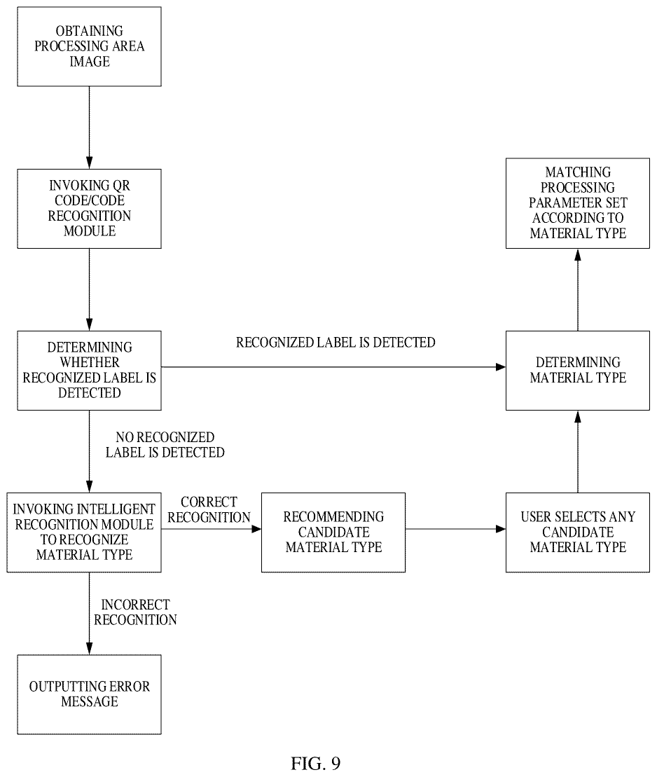

For example, to facilitate understanding this embodiment, reference may be made to FIG. 9, which is a simplified flowchart of a method for determining a processing parameter as follows. A user clicks on an image capture control in an interaction interface. A terminal device sends an instruction to a processing device, enabling the processing device to obtain a processing area image on a processing device platform. The processing device then sends the processing area image back to the terminal device. The terminal device invokes a QR code/coding recognition module to recognize whether there is label information in the processing area image. If a label is present, a material type of a workpiece to be processed is determined based on the label information, and the workpiece to be processed is the one placed on the processing device platform. If no label information is present in the image, an intelligent identification module is invoked to identify the material type. If the identification fails (no material type is identified), an error message is output. If the identification is successful (at least one candidate material type is identified), candidate boxes are displayed in the interaction interface, and each candidate box corresponds to one candidate material type. In response to the user's selection instruction for a candidate box, a candidate material type corresponding to the selected candidate box is determined as the material type of the workpiece to be processed. After the material type is determined, processing parameters corresponding to the workpiece to be processed are obtained through matching according to the material type, and the processing parameters are sent to the processing device, such that the processing device can perform processing on the workpiece to be processed based on the processing parameters.

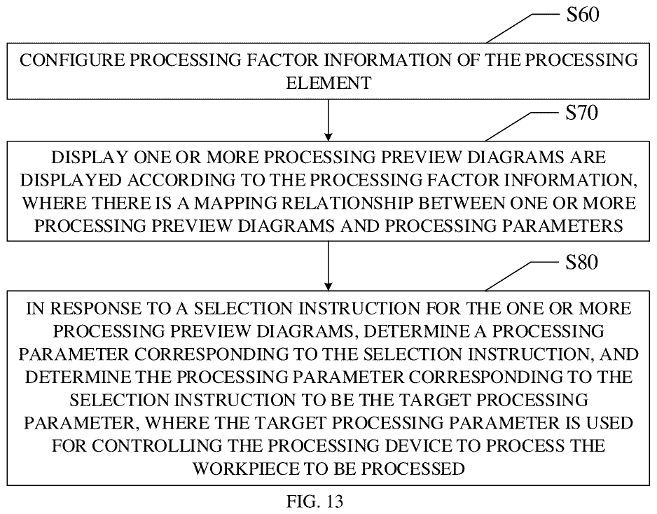

A method for determining a processing parameter is further provided in the present disclosure. Reference may be made to FIG. 13, which is a flowchart of Embodiment 3 in the present disclosure.

In this embodiment, when a processing element is displayed in an interaction interface, there may be at least one processing element, and the method for determining the processing parameter includes operations at S60 to S90.

At S60, processing factor information of the processing element is configured.

It can be noted that, the processing factor information includes factor information used for processing a workpiece to be processed, that is, the processing factor information refers to processing factor information of the processing element that is to be processed onto the workpiece to be processed, such as a material type of the workpiece to be processed (e.g., material property, color, thickness, etc.), a type of a processing device used (e.g., a laser processing device, a computer numerical control (CNC) milling machine, a three-dimensional (3D) printing device, etc.), a type of a processing method used (e.g., laser line engraving, laser line cutting, laser infill engraving, tool cutting, inkjet printing, etc.), etc.

In this embodiment, user input data can be received, and the processing factor information of the workpiece to be processed can be obtained and configured by parsing the user input data. In this embodiment, device information of the processing device and material information of the workpiece to be processed placed on the processing device can also be obtained and configured through communication with a connected processing device. Based on the device information and the material information, the processing factor information of the workpiece to be processed is obtained and configured.

In a possible embodiment of the present disclosure, the processing factor information includes a material type and a processing type, and at least two different material types and at least two different processing types are preconfigured in the interaction interface. The operations at S60 include operations at S61 to S63.

At S61, one or more processing elements are displayed in the interaction interface, where the one or more processing elements are patterns that are intended to be processed onto the workpiece to be processed.

At S62, the material type of the workpiece to be processed is configured in response to the selection instruction in the interaction interface.

At S63, a processing type for the one or more processing elements is configured in response to the selection instruction in the interaction interface.

It can be understood that, at least one processing element is displayed in the interaction interface of the terminal device, and the processing element is a pattern to be processed onto the workpiece to be processed. The interaction interface includes a material list control that is preconfigured with multiple different material types for the workpiece to be processed, and a material type is configured for the workpiece to be processed through a selection instruction. The interaction interface of the terminal device further includes a processing type control that is preconfigured with multiple different processing types for the processing element, and a processing type is configured for the processing element through a selection instruction.

In a possible embodiment, when one processing element is displayed in the interaction interface, a corresponding processing parameter array is obtained based on the material type of the workpiece to be processed and the processing type for the processing element, where in a case where the material type of the workpiece to be processed is the same, the corresponding processing parameter array has different display effect when the processing type for the processing element is different.

In a possible embodiment, when multiple processing elements are displayed in the interaction interface, after the operations at S63, the method can include the following operations at S64. A processing parameter array corresponding to each of the multiple processing elements is obtained based on the configured material type and a processing type for each of the multiple processing elements, where the multiple processing elements correspond to one or more processing types. When the multiple processing elements correspond to multiple processing types, respectively, the multiple processing types correspond to multiple processing parameter arrays with different display effects, respectively.

Through the operations at S64, since the processing element is the pattern to be processed onto the workpiece to be processed, when there are multiple processing elements, a processing type can be configured for each of the multiple processing elements, and a different processing type can be configured for a different processing element, that is, the same workpiece to be processed may be processed with multiple different processing types.

It can be understood that, the processing parameter array includes one or more processing preview diagrams, and there is a mapping relationship between the one or more processing preview diagrams and array elements. Multiple array elements may be arranged in various ways. In some embodiments, the multiple array elements are arranged in parallel rows and columns, and each array element indicates a processing parameter. Alternatively, the processing parameter array is arranged in a circular shape, where an array element closer to the center of the circle indicates a smaller processing parameter, and an array element farther from the center of the circle indicates a greater processing parameter. Alternatively, the processing parameter array is arranged in a spiral shape, where an array element closer to the center of the spiral indicates a smaller processing parameter, and an array element farther from the center of the spiral indicates a greater processing parameter.

In a possible embodiment of the present disclosure, when the multiple processing elements are displayed over a layer of a processing area image, the operations at S62 include the following. In response to the selection instruction in the interaction interface, at least one processing element among the multiple processing elements is selected, and a processing type for the at least one processing element is configured.

In embodiments of the present disclosure, since there are multiple processing types, a target processing type for a processing element can be configured by selecting at least one processing element.

In a possible embodiment, in response to the selection instruction in the interaction interface, the at least one processing element is selected and the processing type for the at least one processing element is configured as follows. In response to the selection instruction in the interaction interface, at least two processing elements among the multiple processing elements are selected, and a processing type for the at least two processing elements is configured. Additionally/alternatively, in response to the selection instruction in the interaction interface, at least two processing elements among the multiple processing elements are selected for performing combination instruction, and a processing type is configured for the at least two processing elements subject to the combination instruction.

It can be understood that, in the interaction interface of the terminal device, at least two processing elements can be simultaneously selected by operating a pointer, and a processing type for the at least two processing elements can be simultaneously configured, that is, a processing type for the multiple processing elements can be configured in batches.

It can be understood that, in the interaction interface of the terminal device, at least two processing elements can be simultaneously selected by operating the pointer for performing combination instruction. The at least two processing elements performing combination operation are on the same layer, such that processing elements of the same processing type can be selected.

Through embodiments of the present disclosure, greater freedom can be provided to the user to edit the multiple processing elements in the interaction interface of the terminal device.

At S70, the one or more processing preview diagrams are displayed according to the processing factor information, where there is a mapping relationship between the one or more processing preview diagrams and the processing parameters.

It can be noted that, the processing preview diagram is a preview diagram of the processing effect under the processing factor information. In this embodiment, a database storing the processing preview diagrams can be accessed through an embedded site or an external browser. It can be understood that, the type of the processing preview diagrams may include fixed preview diagrams corresponding to multiple sets of processing parameters, or may include real-time preview diagrams generated according to real-time processing parameters.

It can also be noted that, there is a mapping relationship between the processing preview diagrams and the processing parameters. That is, under the same processing factor information, a different processing parameter corresponds to a different processing preview diagram. The processing parameters include processing parameter values of parameter items in the processing parameters of the processing device, such as a processing power of 80% and a processing speed of 10 mm/s.

In an example, the type of the processing preview diagrams is the fixed preview diagrams corresponding to the multiple sets of processing parameters. The processing preview diagrams include processing preview diagrams corresponding to the processing parameter array. In this embodiment, a corresponding processing parameter array can be determined according to the processing factor information, and the processing parameter array is displayed in the interaction interface, where the processing parameter array corresponds to one or more array elements, and each array element indicates one processing parameter. Therefore, available processing parameters can be directly provided to the user, such that the user can intuitively know processing effects under different processing parameters, so as to select appropriate processing parameters.

In another example, the type of the processing preview diagrams is the real-time preview diagrams generated according to the real-time processing parameters. In this embodiment, the interaction interface further includes a parameter configuration control, and the parameter configuration control at least includes parameter adjustment controls for the processing parameters. Therefore, in this embodiment, in response to an adjustment operation through each parameter adjustment control, an adjusted processing parameter is displayed in the interaction interface, a processing preview diagram corresponding to the workpiece to be processed is generated according to the adjusted processing parameters and the processing factor information, and then the processing preview diagram is displayed in the interaction interface. When the fixed processing parameters are insufficient to meet user needs, in this embodiment, corresponding real-time preview diagrams can be generated based on the real-time processing parameters, such that the user can intuitively know the processing effects corresponding to different processing parameters, which not only facilitates the selection of the processing parameters but also helps the user clearly obtain the processing effect that meets their needs.

In a possible embodiment of the present disclosure, the processing factor information includes a material type and a processing type, at least two different material types and at least two different processing types are preconfigured in the interaction interface, the processing type includes laser line engraving, laser fill engraving, and laser line cutting, and the processing factor information of the workpiece to be processed is configured and the one or more processing preview diagrams are displayed according to the processing factor information as follows. In response to the selection instruction in the interaction interface, the material type of the workpiece to be processed is configured. A processing preview diagram corresponding to the configured material type is displayed according to the configured material type, where the background of the processing preview diagram is filled with a material schematic diagram corresponding to the material type, and the material schematic diagram displays at least two of a texture, a material property, and a color of the corresponding material type. In response to the selection instruction in the interaction interface, a processing type for the processing element displayed in the interaction interface is configured. A preview pattern corresponding to the configured processing type is displayed over a layer of the material schematic diagram according to the configured processing type, where processing preview diagrams corresponding to the laser line engraving, the laser fill engraving, and the laser line cutting are different.

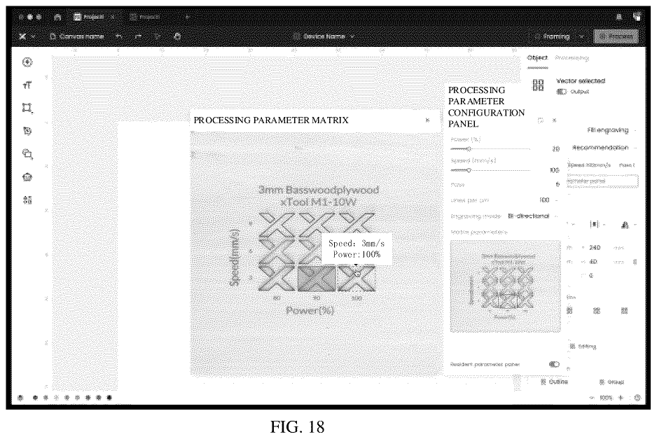

Reference may be made to FIG. 18, in a possible embodiment of the present disclosure, the processing parameter array is configured with multiple processing preview diagrams. Each processing preview diagram has a background filled with a material schematic diagram, such that the user can preview the currently selected material type based on two of the texture, the material property, and the color displayed in the material schematic diagram. Each processing preview diagram further includes a preview pattern configured over the layer of the material schematic diagram, such that the user can visualize the effect of the currently selected processing type through the preview pattern. The preview pattern includes at least one of a reference pattern and an intended processing pattern, where the reference pattern is a preset schematic pattern, and the intended processing pattern is a pattern that is intended to be processed onto the workpiece to be processed. For example, as illustrated in FIG. 18, the processing parameter array includes multiple processing preview diagrams, each processing preview diagram has a background filled with a material schematic diagram, and an “X” is a reference pattern.

In a possible embodiment of the present disclosure, the preview pattern corresponding to the configured processing type is displayed over the layer of the material schematic diagram according to the configured processing type as follows. In response to the selection instruction in the interaction interface, the processing type for the workpiece to be processed is configured as the laser line engraving, and multiple different preview patterns are displayed on the material schematic diagram according to the configured material type, where the preview pattern is formed by lines, and a greater target processing parameter leads to darker lines in the preview pattern. Additionally/alternatively, in response to the selection instruction in the interaction interface, the processing type for the workpiece to be processed is configured as the laser fill engraving, and multiple different preview patterns are displayed on the material schematic diagram according to the configured material type, where the preview pattern is formed by filled color blocks, and a greater target processing parameter leads to darker filled color blocks in the preview pattern.

Additionally/alternatively, in response to the selection instruction in the interaction interface, the processing type for the workpiece to be processed is configured as the laser line cutting, and multiple different preview patterns are displayed on the material schematic diagram according to the configured material type, where the preview pattern is formed by lines, a greater target processing parameter leads to darker lines in the preview pattern, and an area defined by lines of the preview pattern is displayed as a hollowed-out pattern when the target processing parameter is sufficient for cutting through the workpiece to be processed.

It can be understood that, a material schematic diagram corresponding to each material type is preconfigured in the terminal device, and the material schematic diagram can display the material property, color, texture, etc., of the material. It can be understood that, a preview pattern corresponding to each processing type is preconfigured in the terminal device. For example, when the processing type is laser line engraving, a reference pattern over the material schematic diagram is formed by lines, indicating that the surface of the workpiece to be processed will be engraved along the lines by the laser during actual processing. When the processing type is laser fill engraving, the preview pattern over the material schematic diagram is an internally filled pattern, indicating that the surface of the workpiece to be processed will be engraved by the laser during actual processing. When the processing type is laser line cutting, the preview pattern over the material schematic diagram is an internally hollowed-out pattern, indicating that the surface of the workpiece to be processed will be cut along the lines by the laser during actual processing. The user can select a corresponding material type on the terminal device according to the desired processing effect.

At S80, in response to a selection instruction for the one or more processing preview diagrams, a processing parameter corresponding to the selection instruction is determined, and the processing parameter corresponding to the selection instruction is determined to be the target processing parameter, where the target processing parameter is used for controlling the processing device to process the workpiece to be processed.

After displaying the processing preview diagrams, in this embodiment, in response to the selection instruction for the processing preview diagrams, the processing parameter selected by the selection instruction is determined, where the selection instruction includes, but is not limited to, single-click, double-click, and any other operations representing the selection. As such, the processing parameter corresponding to the selection instruction can be taken as the target processing parameter, and the target processing parameter is used for controlling the processing device to process the workpiece to be processed. It can be understood that, after the target processing parameter is determined, the target processing parameter may be directly used for processing, shared with other users, or saved for subsequent use. Exemplarily, in this embodiment, the target processing parameter can be sent to a connected processing device, such that the processing device can process the workpiece to be processed according to the target processing parameter. For example, in this embodiment, the selected target processing parameter can also be sent to a target shared entity as a shared processing parameter.

In a feasible embodiment, after the operations at S80, the method for determining the processing parameter includes the operations at S90 to S100.

At S90, a corresponding processing execution instruction is generated in response to a parameter application instruction, where the processing execution instruction includes an execution instruction and a motion plan.

At S100, the processing execution instruction is sent to the processing device, to enable the processing device to process, based on the execution instruction, the workpiece to be processed according to the motion plan.

In this embodiment, after receiving the parameter application instruction, the corresponding processing execution instruction, such as a Gcode instruction, can be generated based on the target processing parameter. Therefore, in this embodiment, after the processing execution instruction is sent to the processing device, the processing device can execute the processing execution instruction to process the workpiece to be processed according to the target processing parameter.

In a feasible embodiment, after the operations at S80, the method for determining the processing parameter includes the operations at S110 to S130.

At S110, a parameter sharing interface is displayed, where the parameter sharing interface includes the target processing parameter.

At S120, in response to a sharing instruction for the displayed parameter sharing interface, a target processing parameter selected by the sharing instruction is taken as a shared processing parameter, and an entity to be shared selected by the sharing instruction is taken as a target shared entity.

At S130, the shared processing parameter is sent to the target shared entity.

It can be noted that, the parameter sharing interface includes at least one set of target processing parameters.

In this embodiment, the parameter sharing interface is displayed, such that the user can select the target processing parameter in the parameter sharing interface. Subsequently, in response to the sharing instruction for the displayed parameter sharing interface, the target processing parameter selected by the sharing instruction is taken as the shared processing parameter, and the entity to be shared selected by the sharing instruction is taken as the target shared entity. The entity to be shared may be a preset communication account (such as an account of a social network application or an email address), or may be a user account displayed in the parameter sharing interface. The shared processing parameter can then be sent to the target shared entity. It can be understood that, the shared processing parameter may include one or more target processing parameters, and the target shared entity may include one or more entities to be shared.

In this embodiment, the parameter sharing interface is displayed, in response to the sharing instruction for the displayed parameter sharing interface, the target processing parameter selected by the sharing instruction is taken as the shared processing parameter and the entity to be shared selected by the sharing instruction is taken as the target shared entity, and then the shared processing parameter is sent to the target shared entity. In this way, the target processing parameter can be shared between the users, which not only improves the interaction among the users in processing scenarios, but also facilitates other users to quickly obtain the corresponding processing parameter information.

In an embodiment of the present disclosure, the method for determining the processing parameter is provided. In this method, the processing factor information of the workpiece to be processed is obtained, and thus the processing factor information of the workpiece to be processed is obtained. Subsequently, the at least one processing preview diagram is displayed based on the processing factor information, where there is a mapping relationship between the one or more processing preview diagrams and the processing parameters, i.e., a different processing parameter is provided with a corresponding processing preview diagram. As such, the user can select a corresponding processing preview diagram based on their requirements for the processing effect. Therefore, in this embodiment, in response to the selection instruction for the one or more processing preview diagrams, the processing parameter corresponding to the selection instruction is determined, and the processing parameter corresponding to the selection instruction is taken as the target processing parameter, where the target processing parameter is used for controlling the processing device to process the workpiece to be processed. Compared with a method where the user obtains an appropriate target processing parameter by separately adjusting each processing parameter, in embodiments of the present disclosure, processing preview diagrams related to the processing factor information are displayed in advance, such that the user can see preview examples related to the processing factor information, select a processing preview diagram that meets their needs, and take processing parameters corresponding to the selected processing preview diagram as the target processing parameters. In this way, the processing parameters that match the workpiece to be processed can be determined rapidly, which not only effectively improves the efficiency of selecting the processing parameters that meet the user's needs, but also facilitates the user to obtain a satisfactory processed result.

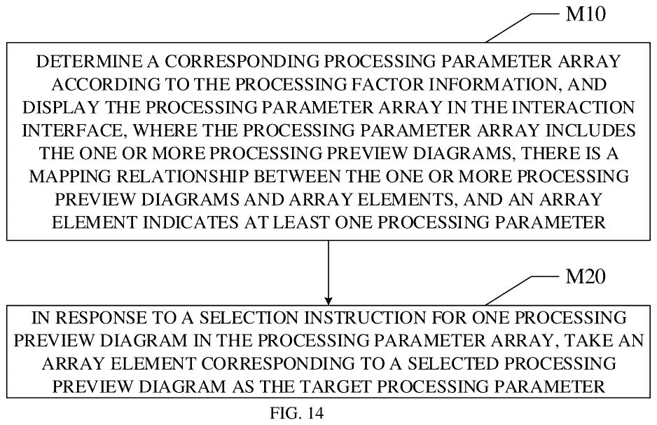

As illustrated in FIG. 14, the operations at S70 further include the following.

At M10, a corresponding processing parameter array is determined according to the processing factor information, and the processing parameter array is displayed in the interaction interface, where the processing parameter array includes the one or more processing preview diagrams, there is a mapping relationship between the one or more processing preview diagrams and array elements, and an array element indicates at least one processing parameter.

At M20, in response to a selection instruction for one processing preview diagram in the processing parameter array, an array element corresponding to a selected processing preview diagram is taken as the target processing parameter.

It can be noted that, the processing parameter array includes processing preview diagrams corresponding to array elements, and each array element indicates the at least one processing parameter. For example, the array element may indicate a processing parameter in one dimension, where different array elements may differ only in the value of the processing power, or different array elements may differ only in the value of the processing speed. For example, the array element may indicate processing parameters in two dimensions, where the array element may indicate the value of the processing speed and the value of the processing power. For example, the array element may also indicate processing parameters in three or more dimensions.

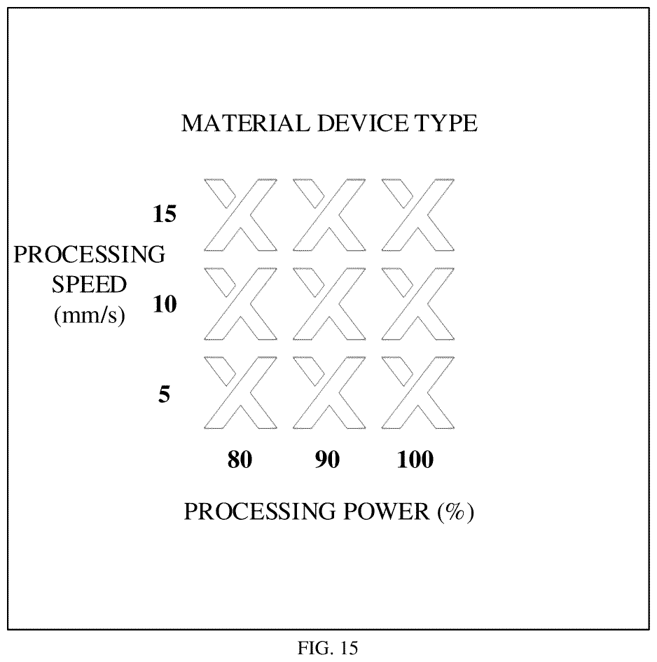

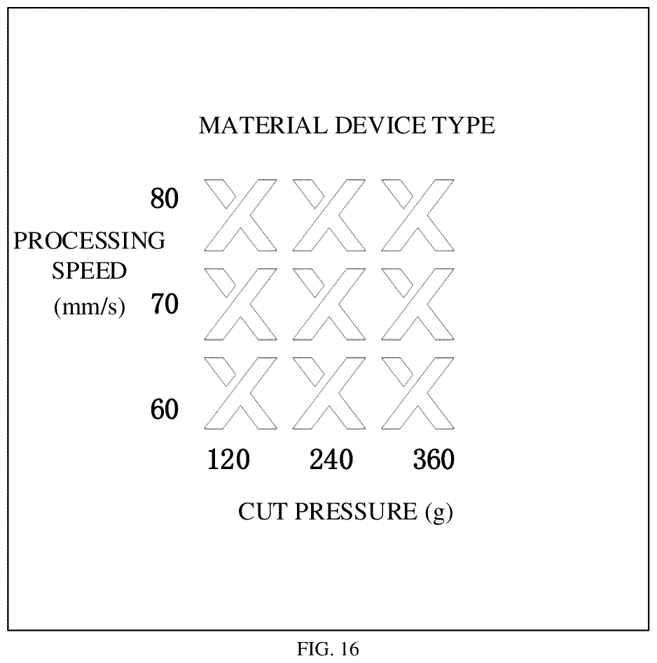

The following is given with an example that the array element indicates the processing parameters in two dimensions. Reference may be made to FIG. 15 and FIG. 16, which are exemplary diagrams each illustrating a processing parameter array involved in embodiments of the present disclosure. FIG. 15 illustrates a processing parameter array when the processing device uses a laser as a processing mean. FIG. 16 illustrates a processing parameter array when the processing device uses a cutter as a processing mean. The array elements corresponding to the processing parameter array include parameter items of the processing parameters and their value ranges, and the processing speed, the processing power, and the cut pressure are the parameter items of the processing parameters. The processing power as illustrated in FIG. 15 refers to the laser power, and the cut pressure as illustrated in FIG. 16 refers to the cutting pressure of the cutter. “X” shaped patterns as illustrated in FIG. 15 and FIG. 16 are processing preview diagrams in the processing parameter arrays. Each processing preview diagram corresponds to one array element, and each array element corresponds to two processing parameters. For example, as illustrated in FIG. 15, each array element corresponds to a combination (i.e., the processing parameters) of a value of the processing power and a value of the processing speed. As illustrated in FIG. 16, each array element corresponds to a combination (i.e., the processing parameters) of a value of the cut pressure and a value of the processing speed. The processing parameter array displayed in the interaction interface may further illustrate information such as the material type and the processing device type in the processing factor information.

In this embodiment, there is a mapping relationship between processing parameter arrays and processing factors. Therefore, in this embodiment, the processing parameter array corresponding to the processing factor information can be obtained according to the mapping relationship. Further, in this embodiment, the processing parameter array can be displayed in the interaction interface, where the processing parameter array corresponds to multiple array elements, and each array element indicates a processing parameter(s), such that the user can intuitively know processing effects under multiple different processing parameters. As such, the user can select a processing preview diagram that meets their needs from the processing parameter array. In this embodiment, in response to the selection instruction for a processing preview diagram in the processing parameter array, an array element corresponding to the selected processing preview diagram can be taken as the target processing parameter.

In this embodiment, a processing parameter array formed by one or more processing preview diagrams is provided for the user to select. The processing preview diagrams are mapped to the array elements, such that the user can select, according to their personalized needs, a processing preview diagram from the processing parameter array that is compatible with the workpiece to be processed, determine an array element corresponding to the processing preview diagram, and then takes one or more processing parameters corresponding to the array element as the target processing parameters. Compared with the method where the user obtains an appropriate target processing parameter by separately adjusting each processing parameter, in this embodiment, the efficiency of selecting the processing parameter that meets the user's needs can be effectively improved, and the user can easily obtain a more satisfactory processed result.

It can be understood that, the processing parameter array can include the one or more processing preview diagrams corresponding to the array element. As illustrated in FIG. 18, the processing parameter array includes multiple processing preview diagrams, each processing preview diagram corresponds to a different preset processing parameter and different preset processing factor information, such that the multiple processing preview diagrams can display simulation preview diagrams under different preset processing parameters and different preset processing factor information, respectively. Alternatively, the processing preview diagram may be a processing preview diagram corresponding to a processing element. As illustrated in FIG. 4, in the editing area of the interaction interface, the background of the editing area is filled with a material schematic diagram corresponding to the material type of the workpiece to be processed. The material schematic diagram has a processing element “HELLO”. By adjusting the processing parameter, a processing effect of the processing element “HELLO” being processed onto the workpiece to be processed can be simulated.

In a feasible embodiment, the array element at least includes a first parameter item and a second parameter item, and the operations at M10, i.e., the corresponding processing parameter array is determined according to the processing factor information, include operations at N10 to N30.

At N10, a first sorting position of each processing preview diagram in a first direction is determined based on a processing parameter value of a first parameter item corresponding to each array element.

At N20, a second sorting position of each processing preview diagram in a second direction is determined based on a processing parameter value of a second parameter item corresponding to each array element.

At N30, the processing parameter array is obtained by arranging each processing preview diagram based on the first sorting position of each processing preview diagram and the second sorting position of each processing preview diagram.

In this embodiment, for example, the processing parameter at least includes the first parameter item and the second parameter item. It can be understood that, the processing parameter may include processing parameter values for more or fewer parameter items. During construction of the processing parameter array, in this embodiment, the first sorting position of each processing preview diagram in the first direction is determined based on the processing parameter value of the first parameter item corresponding to each array element. The first sorting position may be determined in an ascending order, i.e., a larger processing parameter value of the first parameter item can have a first sorting position shifted further to the top in the first direction. Alternatively, the first sorting position may be determined in a descending order, i.e., a larger processing parameter value of the first parameter item can have a first sorting position shifted further to the bottom in the first direction. The second sorting position of each processing preview diagram in the second direction is determined based on the processing parameter value of the second parameter item corresponding to each array element. Similarly, the second sorting position may be determined in an ascending order, i.e., a larger processing parameter value of the second parameter item can have a second sorting position shifted further to the right in the second direction. Alternatively, the second sorting position may be determined in a descending order, i.e., a larger processing parameter value of the second parameter item can have a second sorting position shifted further to the left in the second direction. Then, the processing parameter array can be obtained by arranging each processing preview diagram based on the first sorting position of each processing preview diagram and the second sorting position of each processing preview diagram.

In an embodiment, the processing parameter of the first parameter item is positively correlated with an arrangement order of the first sorting position in the first direction. For example, a larger processing parameter value of the first parameter item can have a first sorting position shifted further to the top in the first direction. The processing parameter of the second parameter item is positively correlated with an arrangement order of the second sorting position in the second direction. For example, a larger processing parameter value of the second parameter item can have a second sorting position shifted further to the right in the second direction.

In an embodiment, the reference pattern is a processing preview diagram generated based on the processing parameters, and the reference pattern includes a pattern formed by lines.

In this embodiment, a processed image can be obtained after processing based on the processing parameters, the processed image is cropped according to a preset shape (such as an X-shape, a circle, a rectangle, etc.,) to obtain a processing preview diagram (i.e., the reference pattern), and then the reference pattern is taken as a processing parameter array.

In a feasible embodiment, the processing factor information is further displayed in the interaction interface, and the processing factor information includes at least one of a material type, a processing device type, and a processing type.

In this embodiment, the corresponding processing factor information is further displayed in the interaction interface, and the processing factor information includes at least one of a material type, a processing device type, and a processing type, such that the user can verify whether the processing factor information is correct when selecting a processing preview diagram.

In a feasible embodiment, the processing parameter array is in an image format, and operations at O10 to O30 are performed before the operations at M20.

At O10, in response to a hovering operation performed on the processing parameter array in an image format, a relative position of the hovering operation is obtained with respect to the processing parameter array.

At O20, according to the relative position of the hovering operation, a processing preview diagram pointed to by the hovering operation is determined in the processing parameter array, and a position of the processing preview diagram is determined.

At O30, a hovering identification diagram is displayed at the position of the processing preview diagram, where the hovering identification diagram includes an identification preview diagram matching a pattern size of the processing preview diagram and a processing parameter indicated by an array element corresponding to the processing preview diagram.

It can be noted that, the hovering operation refers to moving the operation pointer over an object and pausing temporarily without clicking. The hovering identification diagram is a preview diagram used to identify the hover operation, such as a skin overlay, a border line, etc.

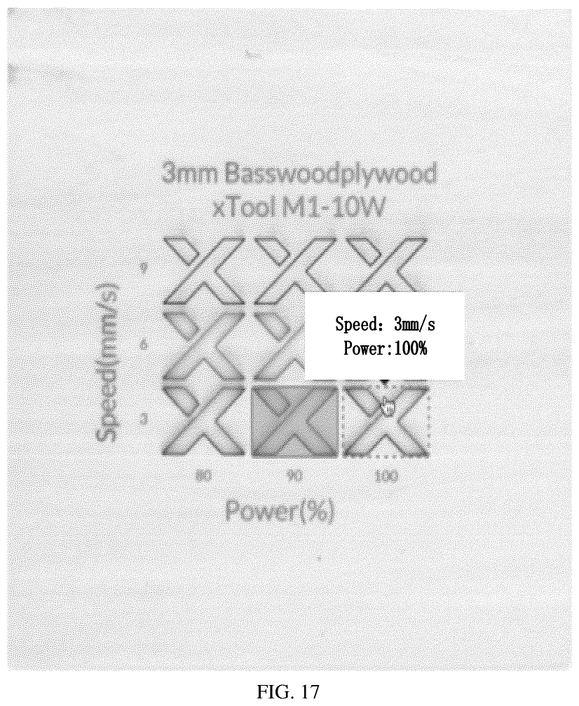

In the case where the processing parameter array is in an image format, when the user moves the operation pointer to a certain processing preview diagram, no feedback can be obtained from the processing parameter array, and thus the user may find it difficult to intuitively know whether a desired array element is selected. Therefore, in this embodiment, in response to the hovering operation performed on the processing parameter array in an image format, the relative position of the hovering operation is obtained with respect to the processing parameter array. Then, according to the relative position, the processing preview diagram pointed to by the hovering operation can be determined in the processing parameter array, and an element position of the processing preview diagram can be determined. As illustrated in FIG. 17, in this embodiment, the hovering identification diagram is displayed at the element position of the processing preview diagram, where the hovering identification diagram includes the identification preview diagram matching the pattern size of the processing preview diagram (as illustrated in a green dashed box in FIG. 17) and the processing parameter indicated by the array element corresponding to the processing preview diagram. Exemplarily, to ensure that the size of the hovering identification diagram always matches the selected processing preview diagram, in this embodiment, an original pattern of the hovering identification diagram is converted into pixel form by using a mmTOpx (millimeters to pixels) method, to avoid the difficulty in matching the hovering identification diagram with the pattern size of the processing preview diagram due to changes in screen specifications on different display devices.

In this embodiment, in response to the hovering operation on the processing parameter array in an image format, the relative position of the hovering operation is obtained with respect to the processing parameter array. According to the relative position, the processing preview diagram pointed to by the hovering operation is determined in the processing parameter array, and the element position of the processing preview diagram is determined. The hovering identification diagram is displayed at the element position of the processing preview diagram, where the hovering identification diagram includes the identification preview diagram matching the pattern size of the processing preview diagram and the processing parameter indicated by the array element corresponding to the processing preview diagram. Therefore, the user can be provided with intuitive feedback even from the processing parameter array in an image format, effectively improving the user's intuitiveness in selecting the processing preview diagram.

In a feasible embodiment, the operations at M10, i.e., the processing parameter array is displayed in the interaction interface, include operations at P10 to P20.

At P10, a parameter configuration control is displayed in the interaction interface, where the parameter configuration control at least includes the processing parameter array.

At P20, in response to a selection instruction for the processing parameter array, the processing parameter array is enlarged and then displayed in the interaction interface.

In this embodiment, the parameter configuration control is further displayed in the interaction interface, and the parameter configuration control at least includes the processing parameter array, such that the user can preview the processing parameter array on the parameter configuration control. After determining that the processing parameter array meets the requirements, the user can click on the processing parameter array in the parameter configuration control. Further, in this embodiment, in response to the selection instruction for the processing parameter array, the processing parameter array can be enlarged and displayed in the interaction interface, thereby improving the display effect of the processing parameter array.

In a feasible embodiment, reference may be made to FIG. 4, a processing element is displayed in the editing area of the interaction interface, the processing element is a pattern that is intended to be processed onto the workpiece to be processed, such as “HELLO” in the figure, the one or more processing preview diagrams includes one or more processing preview diagrams corresponding to the processing element, the parameter configuration control is further displayed in the interaction interface, and the parameter configuration control at least includes a parameter adjustment control for the processing parameter.

After the operations at M20, i.e., the array element corresponding to the selected processing preview diagram is taken as the target processing parameter, the method for determining the processing parameter includes operations at E10.

At E10, in response to an adjustment operation through the parameter adjustment control, an adjusted processing parameter is taken as a new target processing parameter.

As illustrated in FIG. 18, the parameter configuration control is further displayed in the interaction interface, and the parameter configuration control at least includes the parameter adjustment control for the processing parameter. Therefore, after the user takes the array element corresponding to the selected processing preview diagram as the target processing parameter in response to the selection instruction for the processing preview diagrams in the processing parameter array, the user can further adjust the target processing parameter by using the parameter adjustment control in the parameter configuration control. Therefore, in this embodiment, in response to the adjustment operation through the parameter adjustment control, the adjusted processing parameter can be taken as the new target processing parameter. Therefore, in this embodiment, the user cannot only be provided with various processing parameters, but also supports further adjustment based on the selected target processing parameter, making the target processing parameter more closely match the user's needs.

In a feasible embodiment, reference may be made to FIG. 4 again, after the operations at E10, the method further includes operations at E20.

At E20, a processing preview diagram corresponding to the processing element is generated based on the target processing parameter and the processing factor information, and the processing preview diagram corresponding to the processing element is displayed in the interaction interface, where the processing preview diagram corresponding to the processing element is a processing effect of the processing element under the target processing parameter and the processing factor information.

Specifically, FIG. 4 illustrates an embodiment of a processing preview diagram corresponding to a workpiece to be processed. In the editing area of the interaction interface, the background of the editing area is filled with a material schematic diagram corresponding to a material type of the workpiece to be processed. The material schematic diagram has a processing element “HELLO”. By adjusting the processing parameter, a processing effect of the processing element “HELLO” being processed onto the workpiece to be processed can be simulated. For example, the processing parameter includes a laser processing power, and the material type of the workpiece to be processed is “walnut”. As an adjusted laser processing power parameter gradually increases, scorch marks gradually appear around the processing element “HELLO”, which simulates that scorch marks on the surface of the walnut become more obvious when the laser processing power becomes larger. Therefore, through the simulation of the processing effect in this embodiment, the processing preview diagram corresponding to the processing element under the current processing parameter can be previewed, and the corresponding processing preview diagram can be dynamically displayed according to the adjustment of the processing parameter, thereby improving the processing quality of the workpiece to be processed for the user.

Although the processing parameter array includes fixed processing preview diagrams corresponding to multiple sets of processing parameters, if the adjusted processing parameter differs from the processing parameter indicated by each array element in the processing parameter array, the processing preview diagram displayed in the processing parameter array cannot match the new target processing parameter. Therefore, in this embodiment, after the new target processing parameter is obtained, the processing preview diagram corresponding to the processing element can be generated based on the target processing parameter and the processing factor information. As an example, in this embodiment, the processing effect of the workpiece to be processed can be simulated according to the target processing parameter and the processing factor information, to generate the processing preview diagram corresponding to the workpiece to be processed. For example, if the user expects to engrave a cat pattern on the workpiece to be processed, the cat is the processing element in this embodiment, and then the engraving effect of the cat pattern on the workpiece to be processed is obtained through simulation under the target processing parameter and the processing factor information. In addition, in this embodiment, a preview diagram of the processed surface of the workpiece to be processed may only be provided. Exemplarily, in this embodiment, a processed diagram that matches the new target processing parameter and the processing factor information can be searched from a preconfigured processing preview diagram library. The preconfigured processing preview diagram library is a database that pre-stores processed diagrams obtained through processing under different processing parameter values and processing elements. In this embodiment, a processed image that matches the adjusted processing parameters and the processing factor information can be cropped according to a preset shape (e.g., an X-shape, a circle, a rectangle, etc.) to obtain the processing preview diagram corresponding to the processing element. Alternatively, in this embodiment, simulation can be used. A processed diagram that matches the adjusted processing parameters and the processing factor information is obtained through simulation according to the adjusted processing parameters and the processing factor information. Then, the processed diagram that matches the adjusted processing parameters and the processing factor information can be cropped according to the preset shape (e.g., an X-shape, a circle, a rectangle, etc.) to obtain the processing preview diagram corresponding to the processing element. Subsequently, the processing preview diagram can be displayed in the interaction interface for user viewing. Therefore, in this embodiment, a corresponding processing preview diagram can be generated in real time as the user adjusts the target processing parameter, such that the user can intuitively understand the processing preview diagrams corresponding to the new target processing parameter, which can greatly improve the efficiency of selecting the processing parameter that meet the user's needs and make it easier for the user to obtain a more satisfactory processed result.

In a feasible embodiment, before the operations at M10, i.e., the corresponding processing parameter array is obtained, the method further includes operations at F10 to F40.

At F10, at least one processing parameter and a candidate value range of the at least one processing parameter are selected.

At F20, with a configured processing factor, a processing test is performed based on the at least one processing parameter and the candidate value range of the at least one processing parameter, to obtain a test result corresponding to the processing factor, where the configured processing factor at least includes a material type of the target workpiece to be processed.

At F30, the candidate value range of the at least one processing parameter is adjusted according to the test result, to obtain a target value range of the at least one processing parameter corresponding to the processing factor.

At F40, the at least one processing parameter is taken as a dimension of an array element corresponding to the processing parameter array, and a processing parameter is selected from the target value range as the array element corresponding to the processing parameter array, to obtain the array elements corresponding to the processing parameter array.

It can be noted that, the configured processing factor at least includes the material type of the target workpiece to be processed, and may further include factors such as a device type, a processing type, etc.

In this embodiment, the at least one processing parameter (such as processing power, cut pressure, processing speed, etc.) and the candidate value range of the at least one processing parameter can be selected. Then, with the configured processing factor, the processing test is performed based on the at least one processing parameter and the candidate value range of the at least one processing parameter, to obtain the test result corresponding to the processing factor. The test result represents the workpiece performance of the workpiece processed under the configured processing factor, and the workpiece performance at least includes the workpiece surface effect. Further, the candidate value range of the at least one processing parameter is adjusted according to the test result, to obtain the target value range of the at least one processing parameter corresponding to the processing factor, where the target value range is a candidate value range where the test result meets expectations, i.e., a candidate value range with better workpiece surface effect. Subsequently, in this embodiment, the at least one processing parameter is taken as the dimension of the array element corresponding to the processing parameter array, and the processing parameter is selected from the target value range as the array element corresponding to the processing parameter array, to obtain the array elements corresponding to the processing parameter array. Exemplarily, in this embodiment, a processing parameter value can be selected from the target value range of the processing parameter, the processing parameter can be used as the array element of the processing parameter array, and the processing parameter at least includes one processing parameter value. The method for selecting the processing parameter value may be random sampling, sampling at equal intervals, or sampling a preset number of processing parameter values that produce the best surface effect, which is not limited in this embodiment.

In a feasible embodiment, after the operations at F40, i.e., the at least one processing parameter is taken as the dimension of the array element corresponding to the processing parameter array, and the processing parameter is selected from the target value range as the array element corresponding to the processing parameter array, to obtain the array elements corresponding to the processing parameter array, the method further includes operations at F50.

At F50, the processing parameter array, the array element corresponding to the processing parameter array, and a mapping relationship between the processing factor and the processing parameter array are stored.

In this embodiment, after constructing the processing parameter array, the processing parameter array, the array element corresponding to the processing parameter array, and the mapping relationship between the processing factor and the processing parameter array can be stored. Exemplarily, in this embodiment, the processing parameter array, the array element corresponding to the processing parameter array, and the mapping relationship between the processing factor and the processing parameter array can be stored in a local database or a cloud database.

In a feasible embodiment, the operations at F40 include operations at G10 to G30.

At G10, the at least one processing parameter is taken as the dimension of the array element corresponding to the processing parameter array, and the processing parameter is selected from the target value range.

At G20, a corresponding processing preview diagram is generated based on the selected processing parameter, and the processing preview diagram is taken as a reference pattern.

At G30, a processing parameter array is obtained based on the reference pattern.

In this embodiment, the at least one processing parameter is taken as the dimension of the array element corresponding to the processing parameter array, and the processing parameter is selected from the target value range. Then, the corresponding processing preview diagram is generated based on the selected processing parameter, and the processing preview diagram is taken as the reference pattern. For example, if the test result contains a processed diagram corresponding to the selected processing parameter, the processed diagram corresponding to the selected processing parameter can be directly cropped according to the preset shape (such as an X-shape, a circle, a rectangle, etc.) to obtain a processing preview diagram (i.e., the reference pattern). If the test result do not contain the processed image corresponding to the selected processing parameter, processing may be performed according to the selected processing parameter; alternatively, simulation may be used to obtain the processed image corresponding to the selected processing parameter, and then the processed image corresponding to the selected processing parameter can be cropped according to the preset shape (such as an X-shape, a circle, a rectangle, etc.,) to obtain the processing preview diagram (i.e., the reference pattern). The reference pattern can then be used as the array element corresponding to the processing parameter array, to obtain the processing parameter array.

In this embodiment, the processing preview diagram is directly used as the array element corresponding to the processing parameter array, which makes it easier for the user to understand the processing effect that the processing parameter indicated by each array element can bring.

In a feasible embodiment, the processing factor information at least includes a material type, and the operations at M10, i.e., the corresponding processing parameter array is determined according to the processing factor information, include operations at H10 to H20.

At H10, a factor-array mapping table is obtained, where the factor-array mapping table is used for describing a mapping relationship between processing factors and processing parameter arrays.

At H20, the factor-array mapping table is queried according to the material type, to obtain a processing parameter array that matches the material type.

In this embodiment, the mapping relationship between the processing factors and the processing parameter arrays can be described in the form of a mapping table. Therefore, in this embodiment, the factor-array mapping table can be obtained, where the factor-array mapping table is used for describing a mapping relationship between processing factors and processing parameter arrays. Then, the factor-array mapping table can be queried according to the material type, to obtain the processing parameter array that matches the material type.

In a feasible embodiment, the processing factor information further includes at least one of a processing device type and a processing type, and the operations at M10, i.e., the corresponding processing parameter array is determined according to the processing factor information, include one of operations at I10 to I30.

At I10, the factor-array mapping table is queried according to the material type and the processing device type, to obtain a processing parameter array that matches the material type and the processing device type.

At I20, the factor-array mapping table is queried according to the material type and the processing type, to obtain a processing parameter array that matches the material type and the processing type.

At I30, the factor-array mapping table is queried according to the material type, the processing device type, and the processing type, to obtain a processing parameter array that matches the material type, the processing device type, and the processing type.

Since the processing factor information may further include at least one of the processing device type and the processing type, in this embodiment, when the processing factor information includes the material type and the processing device type, the factor-array mapping table can be queried according to the material type and the processing device type, to obtain the processing parameter array that matches the material type and the processing device type. Similarly, when the processing factor information includes the material type and the processing type, the factor-array mapping table can be queried according to the material type and the processing type, to obtain the processing parameter array that matches the material type and the processing type. Similarly, when the processing factor information includes the material type, the processing device type, and the processing type, the factor-array mapping table can be queried according to the material type, the processing device type, and the processing type, to obtain the processing parameter array that matches the material type, the processing device type, and the processing type.

In a feasible embodiment, after the operations at S60, the method for determining the processing parameter further includes operations at J10 to J20.

At J10, the processing factor information is sent to a configured server, to enable the configured server to match a corresponding processing parameter array according to the processing factor information and feed back the processing parameter array.

At J20, a received processing parameter array is displayed, and in response to the selection instruction for the processing preview diagram in the processing parameter array, an array element corresponding to a selected processing preview diagram is taken as a target processing parameter.

In this embodiment, the matching of the processing factor information with the processing parameter array may also be performed by the configured server, to reduce the operating resource requirements of the terminal device and improve the efficiency. In this embodiment, the processing factor information is sent to the configured server, to enable the configured server to match the corresponding processing parameter array according to the processing factor information and feed back the processing parameter array. The configured server may be a cloud server or a physical server. The received processing parameter array is displayed, and in response to the selection instruction for the processing preview diagram in the processing parameter array, the array element corresponding to the selected processing preview diagram is taken as the target processing parameter. As an example, in this embodiment, a database storing the processing preview diagram can be accessed through an embedded site. After the target processing parameter is determined, a ‘webCommandWorkpiece’ event is sent. After the processing device monitors the ‘webCommandWorkpiece’ event and successfully receives the ‘webCommandWorkpiece’ event, the processing device can invoke an interface to receive the target processing parameter, and then process the workpiece to be processed according to the target processing parameter. As another example, in this embodiment, a custom protocol may be applied to awaken the processing device. After the processing device is started, the processing factor information is loaded locally through the “webCommandMaterial” event, and the database storing the processing preview diagram is accessed through an external browser, to determine the target processing parameter corresponding to the processing factor information.

Therefore, in this embodiment, the matching of the processing factor information with the processing parameter array is stored and implemented by the configured server, which can reduce the pressure on the terminal device and improve the efficiency of determining the processing parameter.

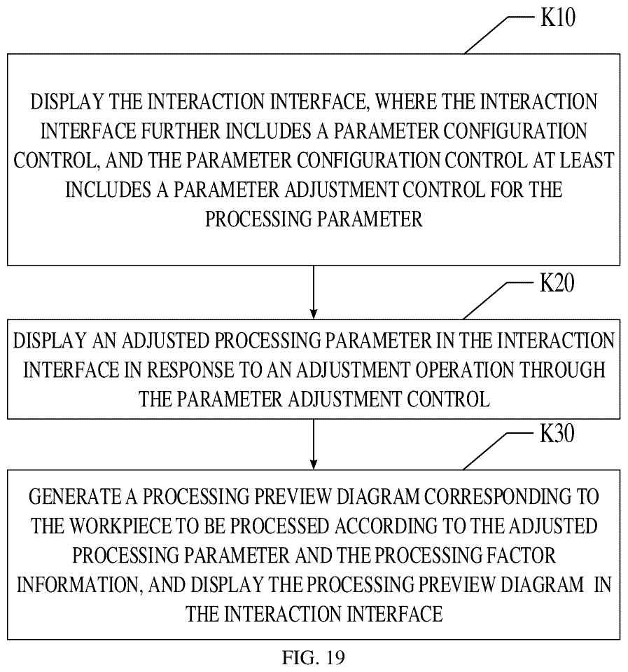

Based on Embodiment 3 in the present disclosure, in Embodiment 5 in the present disclosure, for the content that is the same as or similar to Embodiment 3 and Embodiment 2 mentioned above, reference may be made to the above descriptions, which will not be repeated hereafter. Based on this, reference may be made to FIG. 19, and the operations at S70 further include operations at K10 to K30.

At K10, the interaction interface is displayed, where the interaction interface further includes a parameter configuration control, and the parameter configuration control at least includes a parameter adjustment control for the processing parameter.

At K20, an adjusted processing parameter is displayed in the interaction interface in response to an adjustment operation through the parameter adjustment control.

At K30, a processing preview diagram corresponding to the workpiece to be processed is generated according to the adjusted processing parameter and the processing factor information, and the processing preview diagram is displayed in the interaction interface.

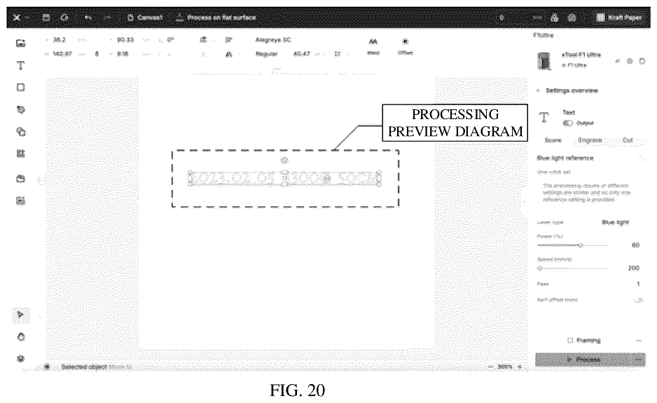

As illustrated in FIG. 20, in this embodiment, the interaction interface can be displayed, where the interaction interface further includes the parameter configuration control, and the parameter configuration control at least includes the parameter adjustment control for the processing parameter, such that the user can adjust the processing parameter. In this embodiment, the adjusted processing parameter can be displayed in the interaction interface in response to the adjustment operation through the parameter adjustment control. Further, in this embodiment, the processing preview diagram corresponding to the workpiece to be processed can be generated according to the adjusted processing parameter and the processing factor information, and the processing preview diagram is displayed in the interaction interface. As an example, in this embodiment, the processing effect of the workpiece to be processed can be simulated according to the adjusted processing parameter and the processing factor information, to generate the processing preview diagram corresponding to the workpiece to be processed. For example, if the user expects to engrave a cat pattern on the workpiece to be processed, the cat is the processing element in this embodiment, and then the engraving effect of the cat pattern on the workpiece to be processed is obtained through simulation under the adjusted processing parameter and the processing factor information. In addition, in this embodiment, a preview diagram of the processed surface of the workpiece to be processed may only be provided. Exemplarily, in this embodiment, the processing preview diagram corresponding to the workpiece to be processed can be generated as follows. According to the adjusted processing parameter and the processing factor information, a processed diagram that matches the adjusted processing parameter and the processing factor information can be searched from a preconfigured processing preview diagram library. The preconfigured processing preview diagram library is a database that pre-stores processed diagrams obtained through processing under different processing parameter values and processing elements. In this embodiment, a processed image that matches the adjusted processing parameters and the processing factor information can be cropped according to a preset shape (e.g., an X-shape, a circle, a rectangle, etc.) to obtain the processing preview diagram corresponding to the processing element. Alternatively, in this embodiment, simulation can be used. A processed diagram that matches the adjusted processing parameters and the processing factor information is obtained through simulation according to the adjusted processing parameters and the processing factor information. Then, the processed diagram that matches the adjusted processing parameters and the processing factor information can be cropped according to the preset shape (e.g., an X-shape, a circle, a rectangle, etc.) to obtain the processing preview diagram corresponding to the processing element. Subsequently, the processing preview diagram can be displayed in the interaction interface for user viewing.

In a feasible embodiment, the operations at S80 further include operations at L10 to L20.

At L10, a processing preview diagram corresponding to the latest adjustment operation is determined when no adjustment operation is received through the parameter adjustment control within a preset duration.

At L20, an adjusted processing parameter corresponding to the latest adjustment operation is taken as the target processing parameter in response to a selection instruction for the processing preview diagram corresponding to the latest adjustment operation.

In this embodiment, since the processing preview diagram changes in real time as the user adjusts the processing parameter, when no adjustment operation is received through the parameter adjustment control within the preset duration (such as 5 s, 8 s, 10 s, etc.), the processing preview diagram corresponding to the latest adjustment operation is determined. The user can then select the processing preview diagram corresponding to the latest adjustment operation. In response to the selection instruction for the processing preview diagram corresponding to the latest adjustment operation, the adjusted processing parameter corresponding to the latest adjustment operation is taken as the target processing parameter.

In Embodiment 5 in the present disclosure, the interaction interface is displayed, where the interaction interface further includes the parameter configuration control, and the parameter configuration control at least includes the parameter adjustment control for the processing parameter. In response to the adjustment operation through the parameter adjustment control, the adjusted processing parameter is displayed in the interaction interface. The processing preview diagram corresponding to the workpiece to be processed is generated according to the adjusted processing parameters and the processing factor information, and then the processing preview diagram is displayed in the interaction interface. Therefore, in this embodiment, the processing preview diagram changes in real time as the user adjusts the processing parameter, such that the user can select the processing parameter according to the processing preview diagram, which can greatly improve the efficiency of selecting the processing parameter that meet the user's needs and make it easier for the user to obtain a more satisfactory processed result.

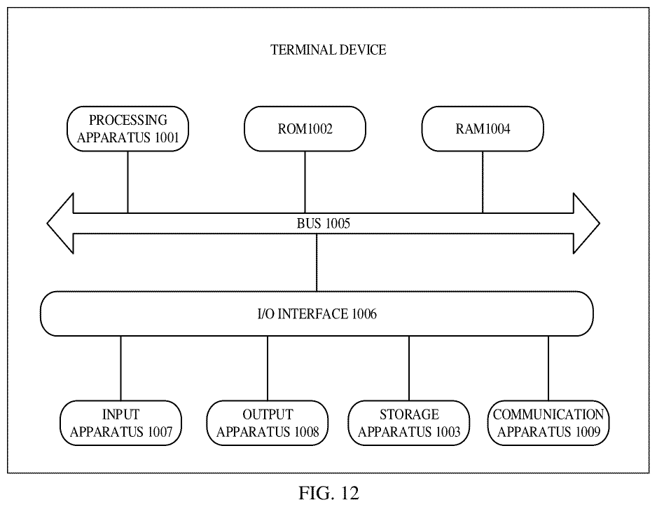

In a feasible embodiment, after the operations at M20, i.e., in response to the selection instruction for the processing preview diagram in the processing parameter array, the array element corresponding to the selected processing preview diagram is taken as the target processing parameter, operations at K10 are to be performed. The interaction interface is displayed, where the interaction interface further includes the parameter configuration control, and the parameter configuration control at least includes the parameter adjustment control for the processing parameter. In response to the adjustment operation through the parameter adjustment control, the adjusted processing parameter is displayed in the interaction interface. The processing preview diagram corresponding to the workpiece to be processed is generated according to the adjusted processing parameters and the processing factor information, and then the processing preview diagram is displayed in the interaction interface. Reference may be made to FIG. 12, in this embodiment, fixed processing parameter arrays corresponding to the multiple sets of processing parameters are provided for the user to select. If the processing parameters indicated by the array elements corresponding to the processing preview diagrams in the processing parameter array do not meet the user's needs, the user can adjust the processing parameters through the parameter adjustment control, and thus a real-time processing preview diagram can be generated according to the adjusted processing parameter and the processing factor information, thereby displaying the processing effect of the adjusted processing parameters to the user.

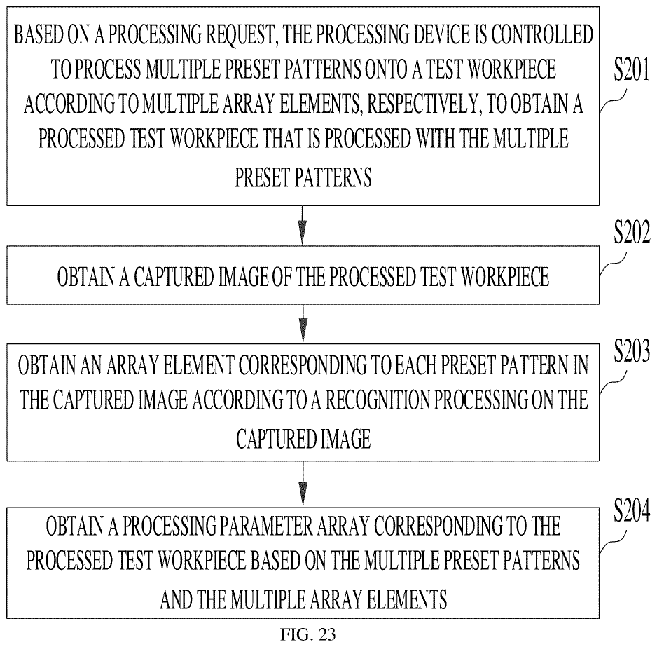

Reference may be made to FIG. 23, which is a flowchart illustrating a method for data processing based on a processing device according to an embodiment of the present disclosure. The method for data processing based on the processing device may be executed by a terminal device 202. As illustrated in FIG. 23, the method for data processing based on the processing device at least includes operations at S201 to S204, which are described in detail below.

At S201, based on a processing request, the processing device is controlled to process multiple preset patterns onto a test workpiece according to multiple array elements, respectively, to obtain a processed test workpiece that is processed with the multiple preset patterns, where each of the multiple array elements includes at least two different types of processing parameters.

In embodiments of the present disclosure, the processing request refers to a request issued by the user to instruct the terminal device to perform processing test.

In embodiments of the present disclosure, the array element refers to a combination of multiple (two or more, hereinafter the same) processing parameters. The processing parameter is an operating parameter of the processing device used to process the workpiece to be processed, and is generally related to the processing device type. Taking a laser processing device as an example, the processing parameters include, but are not limited to, at least one of: a laser power, a scan speed, a laser beam diameter, a pulse frequency, a beam mode, a gas type and flow, a focal length, and a light source. In practical applications, the processing parameter may be flexibly adjusted according to specific application scenarios. It can be understood that, the processing parameters have corresponding values. In other words, the array element includes multiple parameter values.

In embodiments of the present disclosure, the test workpiece refers to a workpiece that is used for testing and is not filled with multiple preset patterns. Correspondingly, the processed test workpiece refers to a workpiece on which multiple preset patterns are processed.

In an embodiment of the present disclosure, the operations at S201, i.e., based on the processing request, the processing device is controlled to process the multiple preset patterns onto the test workpiece according to the multiple array elements, respectively, to obtain the processed test workpiece that is processed with the multiple preset patterns, may include the following. The multiple preset patterns in the interaction interface are obtained. In response to a request to generate the processing parameter test array corresponding to the multiple preset patterns, a processing parameter test array corresponding to the multiple preset patterns is generated and displayed in the interaction interface. In response to an input operation on property information of a test workpiece, a processing interface is displayed, where the processing interface includes a processing control. A processing request is generated in response to a triggering operation through the processing control. The processing request is sent to the processing device, to enable the processing device to process the multiple preset patterns onto the test workpiece based on an array element of each of the multiple preset patterns in the processing parameter test array, to obtain the processed test workpiece that is processed with the multiple preset patterns.

Specifically, in some embodiments, the preset patterns in the interaction interface need to be determined first. The user can upload preset patterns or select preset patterns in the interaction interface. Based on the preset patterns uploaded or selected by the user, the preset patterns in the processing parameter test array are determined.

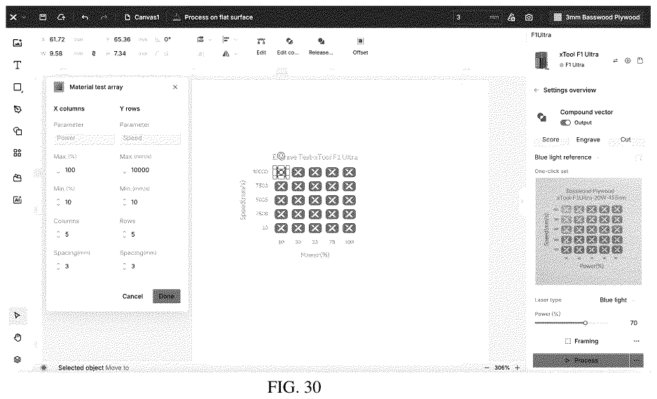

After the preset patterns are obtained, if the user's request to generate the processing parameter test array corresponding to the preset patterns is detected, based on the request, the processing parameter test array corresponding to the multiple preset patterns is generated and displayed in the interaction interface. Herein, upon receiving the request to generate the processing parameter test array, the processing parameter test array can be generated directly based on the default processing parameter test array information. For example, by default, the processing parameter type, the maximum and the minimum of processing parameters, the number of preset patterns, and an interval of preset patterns corresponding to an X-axis of the processing parameter test array are configured by default. Similarly, the processing parameter type, the maximum and the minimum of processing parameters, the number of preset patterns, and an interval of preset patterns corresponding to a Y-axis of the processing parameter test array are also configured by default. The processing parameter test array is generated based on the default processing parameters, which can simplify user operations and improve the efficiency of generating the processing parameter test array. For example, reference may be made to FIG. 30, the user can click on a preset pattern (i.e., small square patterns containing the X shape) in the interaction interface, select the preset pattern, and then click on a processing parameter test array generation control (i.e., material test array control) in the interaction interface to directly generate a processing parameter test array (i.e., the array in the figure) based on the default processing parameter test array information. In this case, the processing parameter type corresponding to the X-axis of the processing parameter test array defaults to power, the maximum value of the processing parameter defaults to 100, the minimum value of the processing parameter defaults to 10, the number of preset patterns defaults to 5, and the interval between preset patterns defaults to 3 mm. The processing parameters corresponding to the Y-axis are similar. Based on the default information, a corresponding 5*5 processing parameter test array is generated.

After the processing parameter test array corresponding to the preset patterns is determined, the user can send an input operation for the property information corresponding to the test workpiece to the terminal device. Correspondingly, the terminal device receives the input operation for the property information corresponding to the test workpiece, and in response to the input operation for the property information corresponding to the test workpiece, displays a processing interface, where the processing interface includes a processing control. The user can then send a trigger operation for the processing control to the terminal device. Correspondingly, the terminal device receives the trigger operation the processing control and generates a processing request. The terminal device then sends the processing request to the processing device. Correspondingly, the processing device receives the processing request from the terminal device, and based on the array element corresponding to each preset pattern in the processing parameter test array, processes the preset patterns onto the test workpiece, to obtain a processed test workpiece with multiple preset patterns.

In an optional embodiment, the property information refers to the basic information of the test workpiece, which is used to identify and describe the test workpiece. The property information includes, but is not limited to, at least one of: the name, type, size, thickness, etc., of the test workpiece.

By implementing the optional embodiment, after receiving the input operation on the property information corresponding to the test workpiece, the terminal device displays a processing interface containing a processing control, such that the user can select whether to trigger the processing control, leading to good human-computer interaction performance. After the user selects to trigger the processing control, the processing request is sent to the processing device, such that the test workpiece can be processed timely, thereby enabling real-time processing of the test workpiece with the multiple preset patterns.

In some embodiments, the processing parameter test array corresponding to the multiple preset patterns is generated and displayed in the interaction interface in response to the request to generate the processing parameter test array corresponding to the multiple preset patterns as follows. In response to the request to generate the processing parameter test array corresponding to the multiple preset patterns, a configuring control for processing parameter test array information is displayed in the interaction interface, where the processing parameter test array information includes a processing parameter type, a processing parameter value, the number of rows and the number of columns of preset patterns in the processing parameter test array, and an interval between two adjacent preset patterns in the processing parameter test array. In response to a configuration operation through the configuring control for the processing parameter test array information, the processing parameter test array corresponding to the multiple preset patterns is displayed in the interaction interface based on the configured processing parameter test array information.

Specifically, in some cases, after the request to generate the processing parameter test array corresponding to the preset pattern is received, the configuring control for processing parameter test array information is first displayed in the interaction interface. As illustrated in FIG. 30, a configuring control for the processing parameter type, the maximum and the minimum of processing parameters, the number of preset patterns, and the interval of preset patterns corresponding to the X/Y axes is displayed on the left side of the interaction interface. The user can flexibly adjust and configure the information according to their needs. Then, based on the configured processing parameter test array information, the interaction interface can display the processing parameter test array corresponding to the preset pattern. For example, if the user sets the number of preset patterns on both the X axis and the Y axis to 3, a 3×3 processing parameter test array will be displayed on the interaction interface. With this method, the user can easily determine the processing parameter test array according to their needs, thereby improving the flexibility of the processing parameter test array.

At S202, a captured image of the processed test workpiece is obtained.

In embodiments of the present disclosure, the terminal device obtains the processed test workpiece with the multiple preset patterns, and then can obtain a captured image of the processed test workpiece.

In embodiments of the present disclosure, the captured image of the processed test workpiece refers to an image obtained by taking images of the processed test workpiece. The number of captured images may be one or more, and the image may be captured by at least one of the processing device, the terminal device, and other external devices. In practical applications, the number of images and the capturing device can be flexibly adjusted according to the specific application scenario.

In an embodiment of the present disclosure, the operations at S202, i.e., the captured image of the processed test workpiece is obtained, may include the following. After the processing device completes the processing, a capturing interface is displayed, and the capturing interface includes a capturing control. If a trigger operation for the capturing control is received, the processed test workpiece is photographed to obtain a captured image of the processed test workpiece.

That is, in an optional embodiment, the terminal device displays the capturing interface after the processing device completes the processing. The capturing interface includes the capturing control. Then, the user can send a trigger operation for the capturing control to the terminal device. Correspondingly, the terminal device receives the trigger operation for the capturing control and captures an image of the processed test workpiece, so as to obtain the captured image of the processed test workpiece.

In an optional embodiment, after the capturing control contained in the capturing interface is triggered, the terminal device can invoke the camera to capture the processed test workpiece, and can store and/or display the captured image for the user to view.

By implementing this optional embodiment, the terminal device displays the capturing interface with the capturing control after the processing device completes the processing, such that the user can select whether to trigger the capturing control, leading to good human-computer interaction performance. The image is captured after the user selects to trigger the capturing control, such that real-time images of the processed test workpiece can be obtained, thereby improving the user experience.

At S203, an array element corresponding to each preset pattern in the captured image is obtained according to a recognition processing on the captured image, where a preset pattern includes at least one of a line pattern, a filled pattern, and a hollowed-out pattern.

In embodiments of the present disclosure, the terminal device obtains a captured image of the processed test workpiece, and then obtains the array element corresponding to each preset pattern in the captured image based on the recognition processing result of the captured image.

It can be understood that, since the image is captured on the processed test workpiece and the processed test workpiece has multiple preset patterns, the image recognition processing can obtain the array element corresponding to each preset pattern in the captured image.

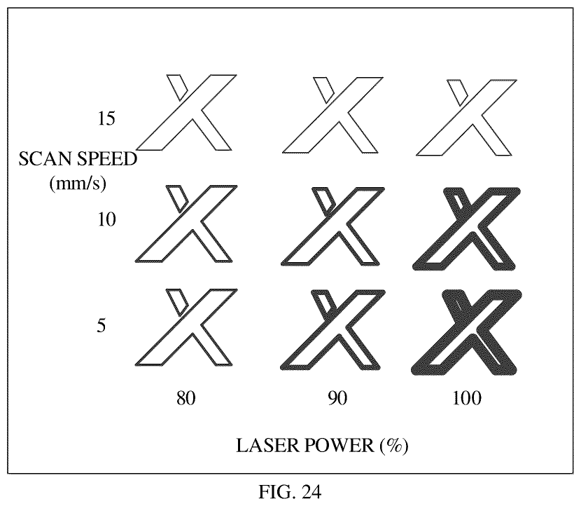

Reference may be made to FIG. 24, which is a schematic diagram of a captured image. As illustrated in FIG. 24, the captured image includes nine preset patterns X={X11, X12, X13, X21, X22, X23, X31, X32, X33}, where i represents a row number and j represents a column number in Xij. It can be understood that, the array elements corresponding to the preset patterns illustrated in FIG. 24 include a laser power and a scan speed.

In an embodiment of the present disclosure, the operations at S203, i.e., the array element corresponding to each preset pattern in the captured image is obtained according to the recognition processing on the captured image, may include the following. The captured image is preprocessed, including at least one of cropping and tilt correction. The preprocessed captured image is subjected to recognition processing to obtain an array element corresponding to each preset pattern in the preprocessed captured image.

That is, in an optional embodiment, the terminal device can first preprocess the captured image to obtain the preprocessed captured image, and then perform recognition processing on the preprocessed captured image to obtain the array element corresponding to each preset pattern in the preprocessed captured image.

In an optional embodiment, preprocessing includes, but is not limited to, at least one of cropping and tilt correction. Cropping refers to adjusting the boundaries or size of the captured image to remove unwanted parts, thereby enabling better recognition processing of the captured image. Tilt correction refers to adjusting a tilted or distorted captured image to align it horizontally or vertically, thereby improving the visual effect of the captured image and enhancing its image quality, and enabling better recognition processing of the captured image.

By implementing this optional embodiment, the captured image is preprocessed, resulting in better image quality that meets the requirements of recognition processing. As such, the accuracy and efficiency of recognition processing can be improved when the preprocessed image is used for recognition processing.

In an embodiment of the present disclosure, the processing parameter includes at least two of a laser power, a pulse frequency, a pulse width, a scan speed, a processing speed, a spot size, a defocus amount, and the number of processing times, the captured image contains the multiple preset patterns, and the operations at S203, i.e., the array element corresponding to each preset pattern in the captured image is obtained according to the recognition processing on the captured image, may include the following. A position of each of the multiple preset patterns in the captured image is identified, to obtain position information of each of the multiple preset patterns in the captured image. At least two different types of processing parameters corresponding to each of the multiple preset patterns are identified, to obtain the array element corresponding to each of the multiple preset patterns, where the position information of each of the multiple preset patterns and the array element corresponding to each of the multiple preset patterns are correlated with each other.

That is, in an optional embodiment, the terminal device performs pattern-position recognition on the captured image to obtain the position information of each preset pattern on the captured image, and performs array-element recognition on the preset pattern corresponding to each position information to obtain the array element of each preset pattern in the captured image.

In an optional embodiment, the position information of the preset pattern on the captured image can be represented by coordinates, such as (x, y), where x represents the horizontal coordinate, and y represents the vertical coordinate. For example, the preset pattern can be outlined with a regular border, and its position information on the captured image can be represented by the coordinates of the upper left corner and the lower right corner of the regular border.

By implementing this optional embodiment, the terminal device first identifies the position of each preset pattern in the captured image, and then identifies the array element after determining the position of each preset pattern in the captured image, thereby avoiding issues such as incorrect identification and omission of identification and improving the accuracy of recognition processing.

In an embodiment of the present disclosure, the captured image includes multiple preset patterns and multiple array elements. Reference may be made to FIG. 24 again, the horizontal axis corresponds to the laser power, from left to right: 80%, 90%, and 100%; and the vertical axis corresponds to the scan speed, from bottom to top: 5 mm/s, 10 mm/s, and 15 mm/s. It can be understood that, any combination of any laser power (80%, 90%, 100%) with any scan speed (5 mm/s, 10 mm/s, 15 mm/s) constitutes an array element. There are a total of 9 array elements: PPG={PPG11, PPG12, PPG13, PPG21, PPG22, PPG23, PPG31, PPG32, PPG 33}. Specifically, PPG11=[80%, 15 mm/s], PPG 12=[80%, 10 mm/s], PPG 13=[80%, 5 mm/s], PPG 21=[90%, 15 mm/s], PPG 22=[90%, 10 mm/s], PPG 23=[90%, 5 mm/s], PPG 31=[100%, 15 mm/s], PPG 32=[100%, 10 mm/s], PPG 33=[100%, 5 mm/s].

Correspondingly, array-element recognition may be performed on the preset pattern corresponding to each position information to obtain the array element of each preset pattern in the captured image as follows. The array element associated with the preset pattern corresponding to each position information is identified from multiple array elements to obtain the array element of each preset pattern in the captured image.

That is, in an optional embodiment, the terminal device associates/maps the preset pattern corresponding to each position information with the corresponding array element to obtain the array element of each preset pattern in the captured image.

For example, following the example in FIG. 24 above, recognition processing is performed on the captured image, such that the array element corresponding to each preset pattern in the captured image can be obtained, where m in PPGmn corresponds to i in Xij, and n in PPGmn corresponds to j in Xij. For example, an array element corresponding to X11 is PPG11, an array element corresponding to X12 is PPG12, and so on.

By implementing this optional embodiment, the terminal device can easily and accurately associate/map the preset pattern with the corresponding array element to obtain the array element of each preset pattern in the captured image.

In an embodiment of the present disclosure, pattern-position recognition may be performed on the captured image to obtain the position information of each preset pattern on the captured image, and array-element recognition may be performed on the preset pattern corresponding to each position information to obtain the array element of each preset pattern in the captured image as follows. The captured image is input into the recognition processing model, to enable the recognition processing model to perform pattern-position recognition and perform array-element recognition on each of the multiple preset patterns in the captured image. Position information of each of the multiple preset patterns in the captured image and the array element corresponding to each of the multiple preset patterns in the captured image that are input from the recognition processing model are obtained.

That is, in an optional embodiment, the terminal device inputs the captured image into the recognition processing model, and then the recognition processing model can perform pattern-position recognition and perform array-element recognition on each of the multiple preset patterns in the captured image. Correspondingly, the recognition processing model outputs the identification processed result, that is, outputs the position information of each preset pattern in the captured image and the array element of each preset pattern in the captured image, thereby obtaining the position information of each preset pattern in the captured image and the array element of each preset pattern in the captured image.

By implementing this optional embodiment, the terminal device applies the recognition processing model to perform pattern-position recognition and perform array-element recognition on each preset pattern in the captured image, which results in a high degree of intelligence and improves the accuracy and efficiency of the identification processing.

In an embodiment of the present disclosure, the operations at S203, i.e., the array element corresponding to each preset pattern in the captured image is obtained according to the recognition processing result on the captured image, may include the following. Identification processing is performed on the captured image by the server or the terminal device, to obtain the position information of each preset pattern in the captured image and the array element of each preset pattern in the captured image.

It can be understood that, both the server and the terminal device can perform recognition processing on the captured image, but due to the limited computing resources of the terminal device, it is more efficient to perform recognition processing on the captured image by the server. That is, in an optional embodiment, recognition processing is performed on the captured image by the server, to obtain the position information of each preset pattern in the captured image and the array element of each preset pattern in the captured image.

By implementing this optional embodiment, the server performs recognition processing on the captured image, which reduces the processing pressure on the terminal device, saves the terminal device's computing resources, and improves the efficiency of recognition processing since the server has more computing resources than the terminal device.

In an embodiment of the present disclosure, recognition processing may be performed on the captured image by the server or the terminal device, to obtain the position information of each preset pattern in the captured image and the array element of each preset pattern in the captured image as follows. The server or the terminal device performs pattern-position recognition on the captured image to obtain the position information of each preset pattern on the captured image, and performs array-element recognition on the preset pattern corresponding to each position information to obtain the array element of each preset pattern in the captured image.

That is, in an optional embodiment, the server or the terminal device performs pattern-position recognition on the captured image to obtain the position information of each preset pattern on the captured image, and performs array-element recognition on the preset pattern corresponding to each position information to obtain the array element of each preset pattern in the captured image.

By implementing this optional embodiment, the server or the terminal device first performs pattern-position recognition on the captured image and then performs array-element recognition after clarifying the position of each preset pattern on the captured image, thereby avoiding issues such as incorrect identification and omission of identification and improving the accuracy of recognition processing.

In an embodiment of the present disclosure, recognition processing may be performed on the captured image by the server or the terminal device, to obtain the position information of each preset pattern in the captured image and the array element of each preset pattern in the captured image as follows. The captured image is sent to the server or the terminal device, to enable the server or the terminal device to apply the recognition processing model to perform pattern-position recognition and perform array-element recognition on each of the multiple preset patterns in the captured image. Position information of each of the multiple preset patterns in the captured image and the array element corresponding to each of the multiple preset patterns in the captured image that are input from the recognition processing model are obtained.

That is, in an optional embodiment, the server or the terminal device inputs the captured image into the recognition processing model, and then applies the recognition processing model to perform pattern-position recognition and array-element recognition on each preset pattern in the captured image. Correspondingly, the recognition processing model outputs the recognition processed result, that is, outputs the position information of each preset pattern in the captured image and the array element of each preset pattern in the captured image, thereby obtaining the position information of each preset pattern in the captured image and the array element of each preset pattern in the captured image.

The terminal device inputs the captured image into the recognition processing model, and then applies the recognition processing model to perform pattern-position recognition and array-element recognition on each preset pattern in the captured image. Correspondingly, the recognition processing model outputs the recognition processed result, that is, outputs the position information of each preset pattern in the captured image and the array element of each preset pattern in the captured image, thereby obtaining the position information of each preset pattern in the captured image and the array element of each preset pattern in the captured image.

By implementing this optional embodiment, the server or the terminal device can apply the recognition processing model to perform pattern-position recognition and array-element recognition on each preset pattern in the captured image, which results in a high degree of intelligence and improves the accuracy and efficiency of the recognition processing.

In an embodiment of the present disclosure, the captured image may be sent to the server or the terminal device as follows. If an upload request for the captured image is received, the captured image will be sent to the server or the terminal device.

Correspondingly, the position information of each of the multiple preset patterns in the captured image and the array element corresponding to each of the multiple preset patterns in the captured image that are input from the recognition processing model may be obtained as follows. The position information of each preset pattern in the captured image and the array element of each preset pattern in the captured image that are input from the recognition processing mode are received from the server or the terminal device. The position information of each preset pattern in the captured image and the array element of each preset pattern in the captured image are displayed.

In other words, in an optional embodiment, the user can send an upload operation for the captured image to the terminal device. Correspondingly, the terminal device receives the upload operation for the captured image, and in response to the upload operation for the captured image, sends the captured image to the server or the terminal device. Then, the server or the terminal device applies the recognition processing model to perform pattern-position recognition and array-element recognition on each preset pattern in the captured image, to obtain the position information of each of the multiple preset patterns in the captured image and the array element corresponding to each of the multiple preset patterns in the captured image, and sends the position information of each of the multiple preset patterns in the captured image and the array element corresponding to each of the multiple preset patterns in the captured image to the terminal device. Correspondingly, the terminal device receives the position information of each of the multiple preset patterns in the captured image and the array element corresponding to each of the multiple preset patterns in the captured image and displays the position information of each of the multiple preset patterns in the captured image and the array element corresponding to each of the multiple preset patterns in the captured image for the user to view.

By implementing this optional embodiment, the terminal device displays the position information of each of the multiple preset patterns in the captured image and the array element corresponding to each of the multiple preset patterns in the captured image for the user to view, which provides good human-computer interaction and improves the user experience.

In an embodiment of the present disclosure, the training process of the recognition processing model may include the following. A training sample set is obtained, where the training sample set includes a first sample image and a second sample image. The first sample image and the second sample image are obtained by capturing an image of processed train workpiece that includes multiple sample patterns. The processed train workpiece is processed by the processing device according to multiple array elements. The second sample image has a label relative to the first sample image. The first sample image is input into the model to be trained to obtain the recognition processing sample result of the first sample image. According to a loss value between the recognition processing sample result and the second sample image, the model to be trained is iteratively trained until the loss value is less than a preset value, to obtain a recognition processing model.

That is, in an optional embodiment, the training process of the recognition processing model is to first obtain a training sample set containing the first sample image and the second sample image, then input the first sample image into the model to be trained to obtain the recognition processing sample result of the first sample image, and then iteratively train the model to be trained according to the loss value between the recognition processing sample result and the second sample image until the loss value is less than the preset value, thereby training the recognition processing model.

In an optional embodiment, the first sample image and the second sample image each refer to an image obtained by capturing an image of the processed train workpiece. The processed train workpiece refers to a workpiece with multiple sample patterns obtained by the processing device processing the multiple sample patterns onto the train workpiece according to multiple array elements, respectively. The train workpiece refers to a workpiece used for training without filling the multiple preset patterns. Correspondingly, the processed train workpiece refers to a workpiece processed to have the multiple preset patterns.

It can be understood that, the first sample image and the second sample image are obtained in the same way as the captured image in the foregoing embodiment. The difference lies in that the first sample image and the second sample image are used to train the model to be trained, while the captured image is used to test and obtain the target array element. The two processes may involve the same or different workpiece (the training process targets the train workpiece and the processed train workpiece, while the testing process targets the test workpiece and the processed test workpiece), array elements, and patterns (the training process targets the sample pattern, while the testing process targets the preset pattern), which can be flexibly adjusted according to the specific application scenario in practical applications.

It can be clear that, the second sample image has a label relative to the first sample image. Therefore, the model to be trained can be iteratively trained based on the loss value between the recognition processing sample result and the second sample image until the loss value is less than the preset value.

In an optional embodiment, the number of training sample sets may be one or more, typically multiple training sample sets, thereby improving the training accuracy of the recognition processing model.

In an embodiment of the present disclosure, the recognition processed sample result of the first sample image includes first position sample information of each sample pattern in the first sample image, and a first processing parameter sample set of each sample pattern in the first sample image. The first position sample information of the sample pattern refers to position information of the sample pattern in the first sample image. Similarly, the position information of the sample pattern in the first sample image can be represented by coordinates, such as (x, y), where x represents the horizontal coordinate, and y represents the vertical coordinate. For example, the sample pattern may be outlined with a regular border, and the position information of the sample pattern in the first sample image can be represented by the coordinates of the upper left corner and the lower right corner of the regular border. The first processing parameter sample set of the sample patterns refers to array elements corresponding to the sample pattern.

In an embodiment of the present disclosure, the label of the second sample image includes second position sample information of each sample pattern in the second sample image, and a second processing parameter sample set of each sample pattern in the second sample image. The second position sample information of the sample pattern refers to position information of the sample pattern in the second sample image. Similarly, the position information of the sample pattern in the second sample image can be represented by coordinates, such as (x, y), where x represents the horizontal coordinate, and y represents the vertical coordinate. For example, the sample pattern may be outlined with a regular border, and the position information of the sample pattern in the second sample image may be represented by the coordinates of the upper left corner and the lower right corner of the regular border. The second processing parameter sample set of the sample patterns refers to array elements corresponding to the sample pattern.

Correspondingly, according to the loss value between the recognition processing sample result and the second sample image, the model to be trained is iteratively trained until the loss value is less than the preset value, to obtain the recognition processing model as follows. According to the loss value between the first position sample information and the second position sample information as well as the loss value between the first processing parameter sample set and the second processing parameter sample set, the model to be trained is iteratively trained until the loss value is less than the preset value, to obtain the recognition processing model.

That is, in an optional embodiment, the model to be trained is iteratively trained according to the loss value between the first position sample information (i.e., the identified position information) and the second position sample information (i.e., the actual position information) as well as the loss value between the first processing parameter sample set (i.e., the identified array elements) and the second processing parameter sample set (i.e., the actual array elements), until the loss value (i.e., the loss value between the first position sample information and the second position sample information, and the loss value between the first processing parameter sample set and the second processing parameter sample set) is less than the preset value, thereby training the recognition processing model.

By implementing this optional embodiment, the recognition processing model can be trained easily and accurately, thereby providing strong support for the recognition processing of the image captured during testing.

In an embodiment of the present disclosure, after the operations at S203, i.e., the array element corresponding to each preset pattern in the captured image is obtained according to the recognition processing result on the captured image, the method may further include the following. An array element selection interface is displayed, where the display array element selection interface includes the multiple preset patterns in the captured image. When a selection instruction for the multiple preset patterns in the captured image is received, at least one parameter value of an array element corresponding to a selected preset pattern is displayed.

That is, in an optional embodiment, the terminal device obtains the array element corresponding to each preset pattern in the captured image, and then can display the array element selection interface. The array element selection interface includes the captured image. Then, the user sends the selection instruction for the multiple preset patterns in the captured image to the terminal device. Correspondingly, the terminal device receives the selection instruction for the multiple preset patterns in the captured image and displays the array element corresponding to the preset pattern selected by the selection instruction.

By implementing this optional embodiment, the terminal device displays the array element selection interface containing the captured image after obtaining the array element corresponding to each preset pattern in the captured image, such that the user can select whether to trigger the selection instruction for the multiple preset patterns in the captured image, leading to good human-computer interaction performance. After the user issues the selection instruction for a certain preset pattern, the array element corresponding to that preset pattern can be displayed in real time, thereby improving the user experience.

In an embodiment of the present disclosure, the array element selection interface may be displayed as follows. The array element corresponding to each preset pattern in the captured image is obtained, where the array element includes a first parameter value and a second parameter value. A position of each preset pattern in the first direction is determined based on the first parameter value corresponding to each preset pattern, where a larger first parameter value can have a position shifted further to the top in the first direction; and a position of each preset pattern in the second direction is determined based on the second parameter value corresponding to each preset pattern, where a larger second parameter value can have a position shifted further to right in the second direction. Based on the position of each preset pattern in the first direction and the position of each preset pattern in the second direction, each preset pattern is arranged to be displayed on the array element selection interface.

That is, in an optional embodiment, the terminal device arranges the multiple preset patterns according to a preset arrangement rule to display the array element selection interface. Specifically, for each preset pattern, the preset arrangement rule may be to determine the position of each preset pattern in the first direction and the position in the second direction, and arrange each preset pattern at a corresponding position in the first direction and at a corresponding position in the second direction, ultimately forming the multiple preset patterns arranged in an array form. The position of each preset pattern in the first direction can be determined according to the first parameter value of each preset pattern. Optionally, a larger first parameter value corresponding to the preset pattern can have the position of the preset pattern shifted further to the top in the first direction. The position of each preset pattern in the second direction can also be determined according to the second parameter value of each preset pattern. Optionally, a larger second parameter value corresponding to the preset pattern can have the position of the preset pattern shifted further to the right in the second direction.

In an optional embodiment, the array element selection interface may further display the first parameter value and the second parameter value corresponding to each preset pattern. Specifically, the first parameter value is arranged from bottom to top in the first direction in an ascending order (i.e., a larger first parameter value corresponding to the preset pattern can have the position of the preset pattern shifted further to the top in the first direction), and the second parameter value is arranged from left to right in the second direction in an ascending order (i.e., a larger second parameter value corresponding to the preset pattern can have the position of the preset pattern shifted further to the right in the second direction).

In an optional embodiment, the first direction may be the vertical direction (i.e., the longitudinal axis direction, also known as the Y-axis direction), and the second direction may be the horizontal direction (i.e., the transverse axis direction, also known as the X-axis direction).

In an optional embodiment, the first parameter value includes, but is not limited to, the scan speed value, and the second parameter value includes, but is not limited to, the laser power value.

In practical applications, the preset arrangement rule, the first direction, the second direction, the first parameter value, the second parameter value, etc., can be flexibly adjusted according to specific application scenarios.

The array element selection interface is displayed with the multiple preset patterns arranged in an array form, which can be highly intuitive and further enhances the user experience.

In an embodiment of the present disclosure, the array element selection interface further includes a confirmation control. Correspondingly, after the array element corresponding to the preset pattern selected by the selection instruction is displayed, the method may further include the following. If a trigger operation for the confirmation control is received, the preset pattern selected by the selection instruction will be used as the target preset pattern, and it is confirmed that a confirmation operation for the array element corresponding to the target preset pattern is received. If no trigger operation for the confirmation control is received, it is determined that no confirmation operation for the array element corresponding to the target preset pattern is received.

That is, in an optional embodiment, the terminal device displays the array element corresponding to the preset pattern selected by the selection instruction, and the confirmation control. If the user sends the trigger operation for the confirmation control to the terminal device, the terminal device receives the trigger operation for the confirmation control. In this case, the preset pattern selected by the selection instruction is used as the target preset pattern, and it is confirmed that the confirmation operation for the array element corresponding to the target preset pattern is received. Then the array element corresponding to the target preset pattern is the target array element. If the user does not send the trigger operation for the confirmation control to the terminal device, the terminal device will not receive the trigger operation for the confirmation control. In this case, it is determined that no confirmation operation for the array element corresponding to the target preset pattern is received, and therefore, the array element corresponding to the target preset pattern is not the target array element.

By implementing this optional embodiment, the array element selection interface includes the confirmation control, and based on whether the confirmation control is triggered, it is determined whether the array element corresponding to the selected preset pattern is the target array element, thereby avoiding errors and improving the accuracy of determining the target array element.

At S204, a processing parameter array corresponding to the processed test workpiece is obtained based on the multiple preset patterns and the multiple array elements.

After the operations at S204, the processing device can be controlled to perform processing based on an identified array element. In this embodiment, the terminal device obtains the array element corresponding to each preset pattern in the processed test workpiece in the captured image, and then can use the identified array element to control the processing device to perform processing, thereby realizing processing control.

In an embodiment of the present disclosure, the processing device may be controlled to perform processing based on an identified array element as follows. If the confirmation operation for the array element corresponding to the target preset pattern in the captured image is received, the array element confirmed by the confirmation operation will be determined as the target array element. The processing device is controlled, based on the target array element, to perform processing.

That is, in an optional embodiment, if the confirmation operation for the array element corresponding to the target preset pattern in the captured image is received, the array element confirmed by the confirmation operation can be determined as the target array element, and then the processing device can be controlled to perform processing using the target array element.

In an optional embodiment, the target array element refers to an array element used to process the workpiece to be processed with the same or similar type as the test workpiece, and may be one of the multiple array elements in the foregoing embodiments.

Optionally, the target array element may be some (i.e., multiple) of the multiple array elements in the foregoing embodiments, where when there are multiple target array elements, all multiple target array elements are used as candidates.

By implementing this optional embodiment, the target array elements can be determined simply and accurately, thereby providing strong support for processing control.

In an embodiment of the present disclosure, the processing device may be controlled to perform processing based on the target array elements as follows. The processing device is controlled to process, according to the target array element, the pattern to be processed onto the workpiece to be processed with the same or similar type as the test workpiece.

That is, in an optional embodiment, the terminal device obtains the target array element, and then in the actual processing, the terminal device can control the processing device to be in a working state corresponding to the target array element, so as to process the pattern to be processed onto the workpiece to be processed with the same or similar type as the test workpiece.

In an optional embodiment, a difference between the workpiece to be processed and the test workpiece is that the test workpiece is used to test and obtain the target array element, while the workpiece to be processed is used to actually process and obtain the desired product.

It can be understood that, when there is only one target array element, the terminal device controls the processing device to process, according to the target array element, the pattern to be processed onto the workpiece to be processed with the same or similar type as the test workpiece. When there are multiple target array elements, according to the selection instruction for the multiple target array elements by the user, the terminal device can control the processing device to process, according to the target array element selected by the selection instruction, the pattern to be processed onto the workpiece to be processed with the same or similar type as the test workpiece.

Optionally, when there are multiple target array elements, the usage frequency or the number of times of each target array element can be counted after a period of time, and the multiple target array elements can be sorted according to the usage frequency or the number of times of each target array element, to display the sorted multiple target array elements, thereby providing a guidance for the user to select, and further improving the user experience.

In embodiments of the present disclosure, the processing control is achieved simply and accurately, avoiding the waste of material and time caused by the artificial configuration of the target array elements due to cognitive bias of the workpiece to be processed, improving processing efficiency and accuracy, meeting product manufacturing requirements, and improving the reliability of the data processing based on the processing device.

In an embodiment, the processing factor information includes a material type, and the operations at S60, i.e., the processing factor information of the workpiece to be processed is configured, include the following. An image of the workpiece to be processed is obtained. At least a portion of the image of the workpiece to be processed is identified, and the material type of the workpiece to be processed is determined.

The above operations are similar to the operations at S10 and S20. For a detailed explanation, reference may be made to related descriptions of the operations at S10 and S20, which will not be repeated herein.

In an embodiment, at least a portion of the image of the workpiece to be processed is identified and the material type of the workpiece to be processed is determined as follows. Label information on the workpiece to be processed is identified, and the material type of the workpiece to be processed is determined. Alternatively, material feature information is determined based on the image of the workpiece to be processed, and the material type of the workpiece to be processed is determined based on a matching degree between the material feature information and preset feature information.

In an embodiment, the material feature information is determined based on the image of the workpiece to be processed as follows. First feature information of the workpiece to be processed is determined based on the image of the workpiece to be processed, where the first feature information includes a texture feature, a color feature, and a shape feature. Alternatively, second feature information of the workpiece to be processed is determined based on the image of the workpiece to be processed, where the second feature information includes a spectral feature and/or a speckle feature.

The above operations are similar to the operations at S10 and S20. For a detailed explanation, reference may be made to the related descriptions of the operations at S10 and S20, which will not be repeated herein.

The following provides a detailed description of specific scenarios in embodiments of the present disclosure.

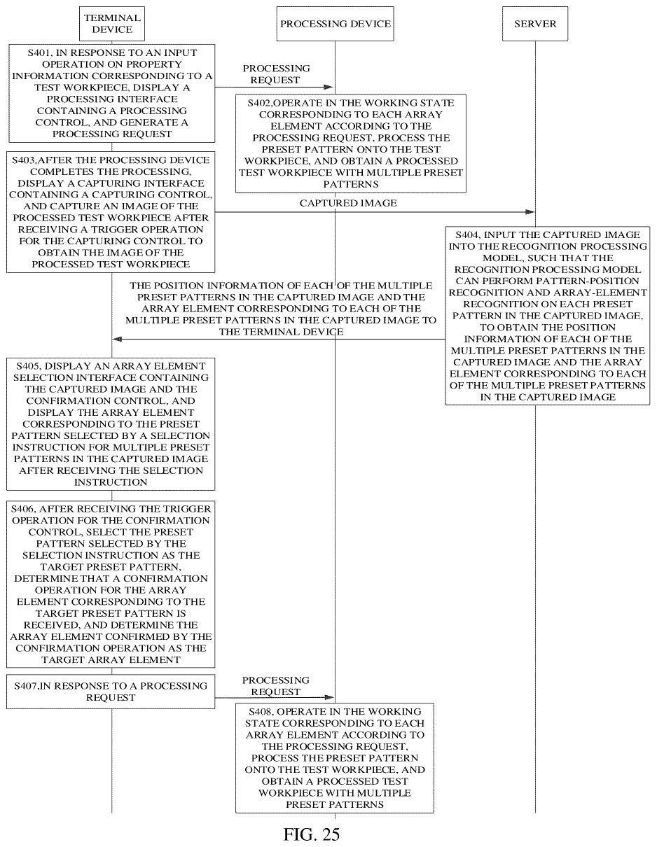

Reference may be made to FIG. 25, which is a flowchart illustrating a method for data processing based on a processing device according to an embodiment of the present disclosure. As illustrated in FIG. 25, the method for data processing based on the processing device at least includes operations at S401 to S408, which are described in detail below.

At S401, in response to an input operation on property information corresponding to a test workpiece, a terminal device displays a processing interface containing a processing control, generates a processing request, and sends the processing request to the processing device after receiving a trigger operation for the processing control.

It can be understood that, the user needs to first place the test workpiece in a processing area on the processing device platform, and input the property information corresponding to the test workpiece, such as the name and type of the test workpiece. Correspondingly, the terminal device receives the property information corresponding to the test workpiece and displays the processing interface containing the processing control.

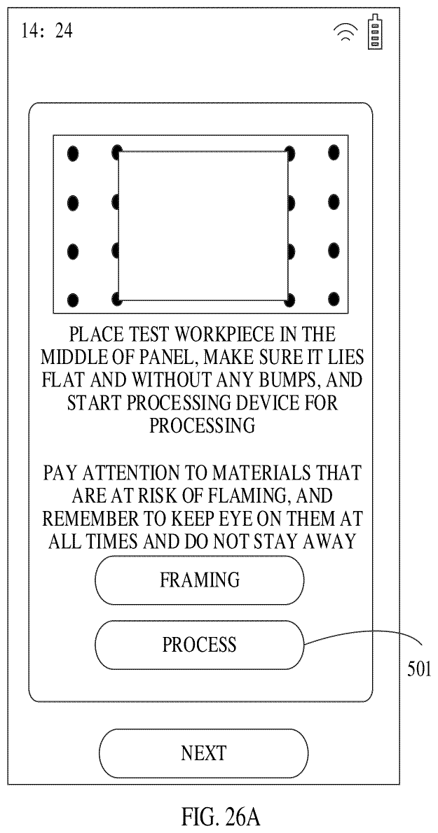

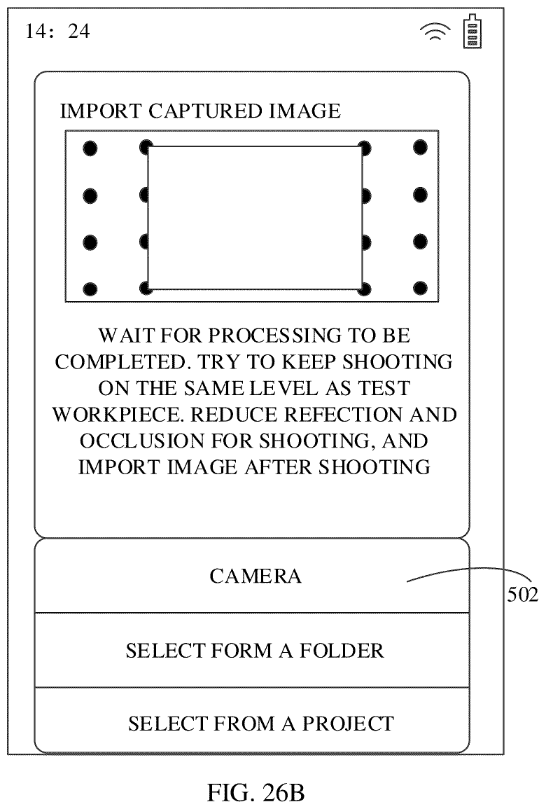

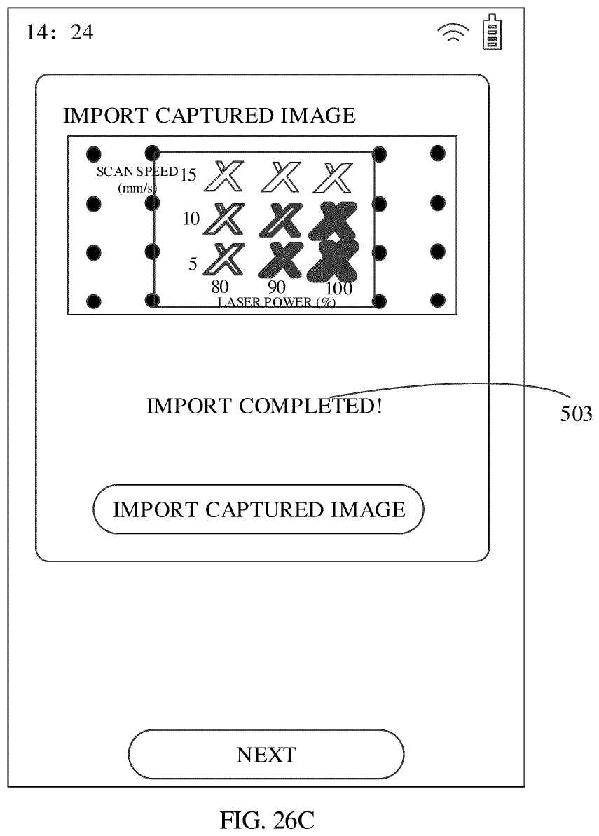

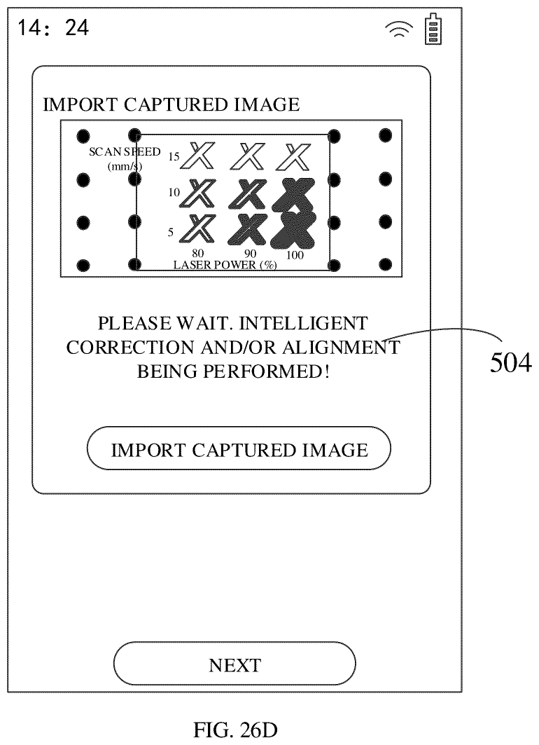

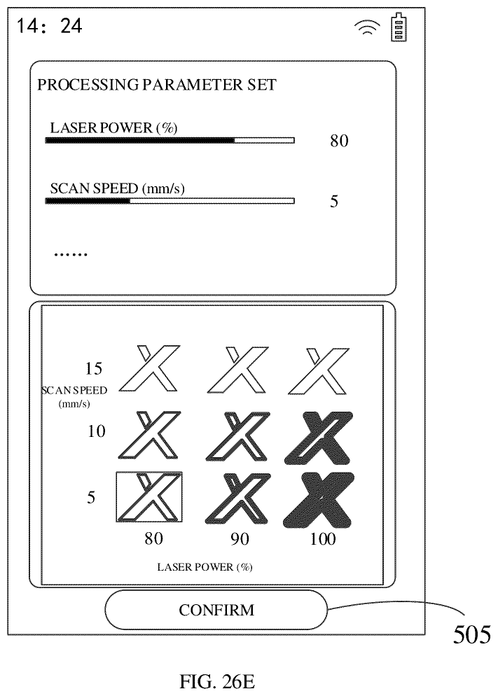

Reference may be made to FIG. 26A, which is a schematic diagram of a processing interface. As illustrated in FIG. 26A, the processing interface displays the processing control “processing” 501. Optionally, the processing interface can further display a border control and some additional information (such as corresponding operation guidance information, attention information, etc.). In practical applications, the user interface (UI) design of the processing interface can be flexibly adjusted.

At S402, the processing device receives the processing request, operates in the working state corresponding to each array element according to the processing request, processes the preset pattern onto the test workpiece, and obtains a processed test workpiece with multiple preset patterns.

At S403, after the processing device completes the processing, the terminal device displays a capturing interface containing a capturing control, captures an image of the processed test workpiece after receiving a trigger operation for the capturing control to obtain the image of the processed test workpiece, and sends the image of the workpiece to the server.

Reference may be made to FIG. 26B, which is a schematic diagram of a capturing interface. As illustrated in FIG. 26B, the capturing interface displays a capturing control “camera” 502. Optionally, the capturing interface may further display an image selection control and some additional information (such as corresponding operation guidance information), etc. In practical applications, the UI design of the capturing interface can also be flexibly adjusted.

Reference may be made to FIG. 26C, which is a schematic diagram of another capturing interface. As illustrated in FIG. 26C, the captured image is successfully imported, and an import reminder message “import complete!” 503 is displayed.

At S404, the server or the terminal device receives the captured image and inputs the captured image into the recognition processing model, such that the recognition processing model can perform pattern-position recognition and array-element recognition on each preset pattern in the captured image, to obtain the position information of each of the multiple preset patterns in the captured image and the array element corresponding to each of the multiple preset patterns in the captured image, and sends the position information of each of the multiple preset patterns in the captured image and the array element corresponding to each of the multiple preset patterns in the captured image to the terminal device.

In an embodiment of the present disclosure, the training process of the recognition processing model may include the following. A training sample set is obtained, where the training sample set includes a first sample image and a second sample image. The first sample image and the second sample image are obtained by capturing a processed train workpiece that includes multiple sample patterns, and the processed train workpiece is processed by the processing device according to multiple array elements. The second sample image has a label relative to the first sample image, where the label of the second sample image includes second position sample information of each sample pattern in the second sample image, and a second processing parameter sample set of each sample pattern in the second sample image.

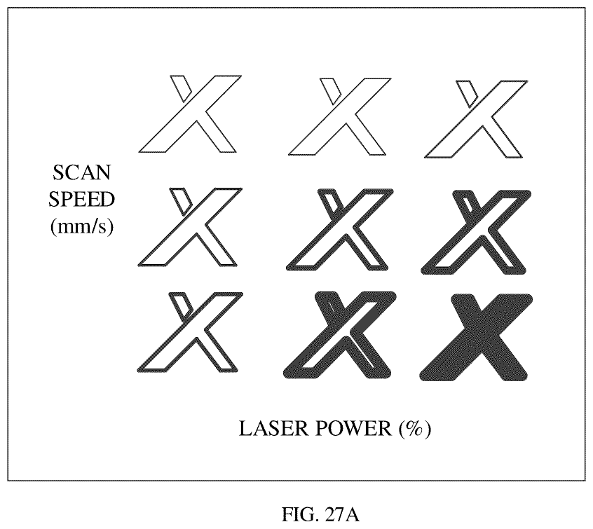

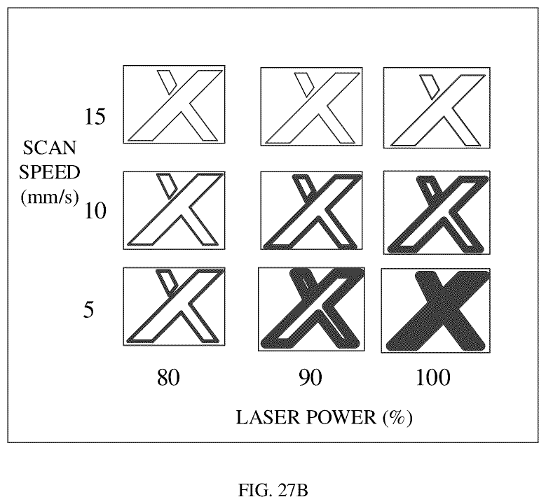

Reference may be made to FIG. 27A, which is a schematic diagram of a first sample image. As illustrated in FIG. 27A, the first sample image includes 9 sample patterns X.

Reference may be made to FIG. 27B, which is a schematic diagram of a second sample image. As illustrated in FIG. 27B, the second sample image includes 9 sample patterns X, and each sample pattern X is outlined with a rectangle to represent the position information of each sample pattern X (i.e., the second position sample information). Meanwhile, each sample pattern X corresponds to a specific laser power and a specific scan speed to represent the array element of each sample pattern X (i.e., the second processing parameter sample set).

Then, the first sample image is input into the model to be trained, to obtain the recognition processing sample result of the first sample image. The recognition processing sample result of the first sample image includes the first position sample information of each sample pattern in the first sample image, and the first processing parameter sample set of each sample pattern in the first sample image.

Then, according to a loss value between the first position sample information and the second position sample information as well as a loss value between the first processing parameter sample set and the second processing parameter sample set, the model to be trained is iteratively trained until the loss value is less than a preset value, to obtain the recognition processing model.

In an embodiment of the present disclosure, during the recognition processing of the captured image, the terminal device can display a recognition processing interface, such that the user can clearly see that the recognition processing of the captured image is in progress.

Reference may be made to FIG. 26D, which is a schematic diagram of a recognition processing interface. As illustrated in FIG. 26D, the recognition processing interface displays an alignment reminder message “please wait, intelligent correction in progress!” 504. Optionally, the recognition processing interface can further display an import control, etc. In practical applications, the UI design of the recognition processing interface can also be flexibly adjusted.

In an embodiment of the present disclosure, after obtaining the position information of each preset pattern in the captured image and the array element of each preset pattern in the captured image, the server can encapsulate them into a certain data exchange format, such as javascript object notation (JSON) (a lightweight data exchange format), and send them to the terminal device.

At S405, the terminal device receives the position information of each preset pattern in the captured image and the array element of each preset pattern in the captured image, displays an array element selection interface containing the captured image and the confirmation control, and displays the array element corresponding to the preset pattern selected by a selection instruction for multiple preset patterns in the captured image after receiving the selection instruction.

Reference may be made to FIG. 26E, which is a schematic diagram of an array element selection interface. As illustrated in FIG. 26E, the user issues the selection instruction for multiple preset patterns in the captured image. The user selects the preset pattern illustrated in the box. Correspondingly, the array element corresponding to the preset pattern illustrated in the box is displayed in the upper area of the array element selection interface. Specifically, the laser power is 80%, and the scan speed is 5 mm/s. In practical applications, the UI design of the array element selection interface can also be flexibly adjusted.

At S406, after receiving the trigger operation for the confirmation control, the terminal device selects the preset pattern selected by the selection instruction as the target preset pattern, determines that a confirmation operation for the array element corresponding to the target preset pattern is received, and determines the array element confirmed by the confirmation operation as the target array element.

Reference may be made to FIG. 26E again, and the array element selection interface displays a confirmation control “confirm” 505.

As for now, the testing and processing to obtain the target array element are completed.

At S407, the terminal device sends a processing request for the workpiece to be processed to the processing device in response to the processing request.

It can be understood that, the workpiece to be processed is typically of the same or similar type as the test workpiece.

At S408, the processing device receives the processing request, operates in the working state corresponding to each array element according to the processing request, processes the preset pattern onto the test workpiece, and obtains a processed test workpiece with multiple preset patterns.

As for now, the actual processing to obtain the desired product is completed.

In this embodiment, the interaction between the terminal device, the processing device, and the server enables the efficient and accurate determination of the target array element. The target processing device is then used to process the workpiece to be processed, avoiding the waste of material and time caused by manually configuring the target array elements due to cognitive biases about the workpiece to be processed, which improves processing efficiency and accuracy, meets product manufacturing requirements, enhances user experience, and increases the stickiness between the processing device and the user.

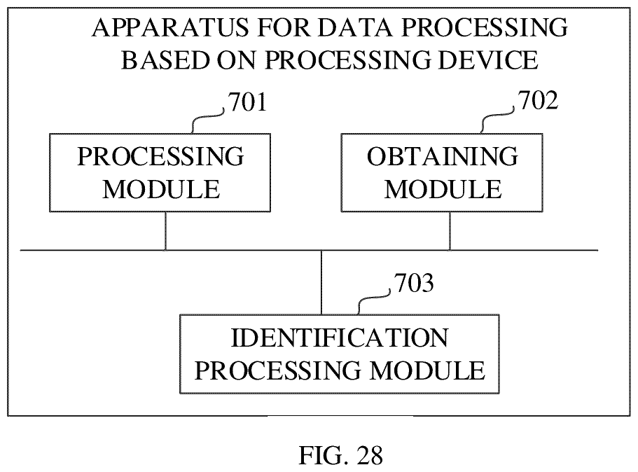

FIG. 28 is a block diagram of an apparatus for data processing based on a processing device according to an exemplary embodiment of the present disclosure. The apparatus includes a processing module 701, an obtaining module 702, and a recognition processing module 703. The processing module 701 is configured to control, based on a processing request, a processing device to process multiple preset patterns onto a test workpiece according to multiple array elements, respectively, to obtain a processed test workpiece that is processed with the multiple preset patterns. The obtaining module 702 is configured to obtain a captured image of the processed test workpiece. The recognition processing module 703 is configured to obtain an array element corresponding to each of the multiple preset patterns in the captured image according to an identification processed result on the captured image. The processing module is further configured to control the processing device to perform processing based on the identified array element.

In an embodiment of the present disclosure, based on the foregoing solution, the recognition processing module 703 is specifically configured to perform pattern-position recognition on the captured image to obtain the position information of each preset pattern on the captured image, and perform array-element recognition on the preset pattern corresponding to each position information to obtain the array element of each preset pattern in the captured image.

In an embodiment of the present disclosure, based on the foregoing solution, the captured image includes multiple preset patterns and multiple array elements, and the recognition processing module 703 is further specifically configured to identify the array element associated with the preset pattern corresponding to each position information from multiple array elements, to obtain the array element of each preset pattern in the captured image.

In an embodiment of the present disclosure, based on the foregoing solution, the recognition processing module 703 is further configured to input the captured image into the recognition processing model, to enable the recognition processing model to perform pattern-position recognition and perform array-element recognition on each of the multiple preset patterns in the captured image. The recognition processing module 703 is further configured to obtain position information of each of the multiple preset patterns in the captured image and the array element corresponding to each of the multiple preset patterns in the captured image that are input from the recognition processing model.

In an embodiment of the present disclosure, based on the foregoing solution, the recognition processing module 703 is specifically configured to perform recognition processing on the captured image by the server or the terminal device, to obtain the position information of each preset pattern in the captured image and the array element of each preset pattern in the captured image.

In an embodiment of the present disclosure, based on the foregoing solution, the recognition processing module 703 is further configured to send the captured image to the server or the terminal device, to enable the server or the terminal device to apply the recognition processing model to perform pattern-position recognition and perform array-element recognition on each of the multiple preset patterns in the captured image. The recognition processing module 703 is further configured to obtain position information of each of the multiple preset patterns in the captured image and the array element corresponding to each of the multiple preset patterns in the captured image that are input from the recognition processing model.

In an embodiment of the present disclosure, based on the foregoing solution, the recognition processing module 703 is further configured to send the captured image to the server or the terminal device if an upload request for the captured image is received. The recognition processing module 703 is further configured to receive, from the server or the terminal device, the position information of each preset pattern in the captured image and the array element of each preset pattern in the captured image that are input from the recognition processing model. The recognition processing module 703 is further configured to display the position information of each preset pattern in the captured image and the array element of each preset pattern in the captured image.

In an embodiment of the present disclosure, based on the foregoing solution, the device further includes a training module. The training module is configured to obtain a training sample set, where the training sample set includes a first sample image and a second sample image, the first sample image and the second sample image are obtained by capturing an image of processed train workpiece that includes multiple sample patterns, the processed train workpiece is processed by the processing device according to multiple array elements, and the second sample image has a label relative to the first sample image. The training module is configured to input the first sample image into the model to be trained, to obtain the recognition processing sample result of the first sample image. The training module is configured to, according to a loss value between the recognition processing sample result and the second sample image, iteratively train the model to be trained until the loss value is less than a preset value, to obtain a recognition processing model.

In an embodiment of the present disclosure, based on the aforementioned solution, the recognition processed sample result of the first sample image includes first position sample information of each sample pattern in the first sample image, and a first processing parameter sample set of each sample pattern in the first sample image. The label of the second sample image includes second position sample information of each sample pattern in the second sample image, and a second processing parameter sample set of each sample pattern in the second sample image. The training module is specifically configured to, according to the loss value between the first position sample information and the second position sample information as well as the loss value between the first processing parameter sample set and the second processing parameter sample set, iteratively train the model to be trained until the loss value is less than the preset value, to obtain the recognition processing model.

In an embodiment of the present disclosure, based on the foregoing solution, the processing module 701 is specifically configured to, in response to an input operation on property information of a test workpiece, display a processing interface, where the processing interface includes a processing control. The processing module 701 is specifically configured to generate a processing request in response to a triggering operation through the processing control. The processing module 701 is specifically configured to send the processing request to the processing device, to enable the processing device to process the multiple preset patterns onto the test workpiece based on an array element of each of the multiple preset patterns in the processing parameter test array, to obtain the processed test workpiece that is processed with the multiple preset patterns.

In an embodiment of the present disclosure, based on the foregoing solution, the device further includes a display module. The display module is configured to display an array element selection interface, where the display array element selection interface includes the multiple preset patterns in the captured image. The display module is configured to display at least one parameter value of an array element corresponding to a selected preset pattern when a selection instruction for the multiple preset patterns in the captured image is received.

In an embodiment of the present disclosure, based on the foregoing solution, the display module is specifically configured to obtain the array element corresponding to each preset pattern in the captured image, where the array element includes a first parameter value and a second parameter value. The display module is specifically configured to determine a position of each preset pattern in the first direction based on the first parameter value corresponding to each preset pattern, where a larger first parameter value can have a position shifted further to the top in the first direction; and determine a position of each preset pattern in the second direction based on the second parameter value corresponding to each preset pattern, where a larger second parameter value can have a position shifted further to right in the second direction. The display module is specifically configured to, based on the position of each preset pattern in the first direction and the position of each preset pattern in the second direction, arrange each preset pattern to be displayed on the array element selection interface.

In an embodiment of the present disclosure, based on the foregoing solution, the array element selection interface further includes a confirmation control, and the apparatus further includes a confirmation module. The confirmation module is configured to, if a trigger operation for the confirmation control is received, take the preset pattern selected by the selection instruction as the target preset pattern, and confirm that a confirmation operation for the array element corresponding to the target preset pattern is received.

In an embodiment of the present disclosure, based on the foregoing solution, the processing module 701 is specifically configured to, if the confirmation operation for the array element corresponding to the target preset pattern in the captured image is received, determine the array element confirmed by the confirmation operation as the target array element. The processing module 701 is specifically configured to control the processing device is controlled, based on the target array element, to perform processing.

In an embodiment of the present disclosure, based on the foregoing solution, the processing module 701 is further configured to control the processing device to process, according to the target array element, the pattern to be processed onto the workpiece to be processed with the same or similar type as the test workpiece.

It can be noted that, the apparatus for data processing based on the processing device provided in the foregoing embodiments and the method for data processing based on the processing device provided in the foregoing embodiments belong to the same concept. The specific way in which various modules and units perform operations is described in detail in the method embodiments, which will not be repeated herein.

An electronic device is further provided in embodiments of the present disclosure. The electronic device includes one or more processors and a memory. The memory is configured to store one or more programs which, when executed by the one or more processors, cause the electronic device to implement the method for data processing based on the processing device provided in the foregoing embodiments.

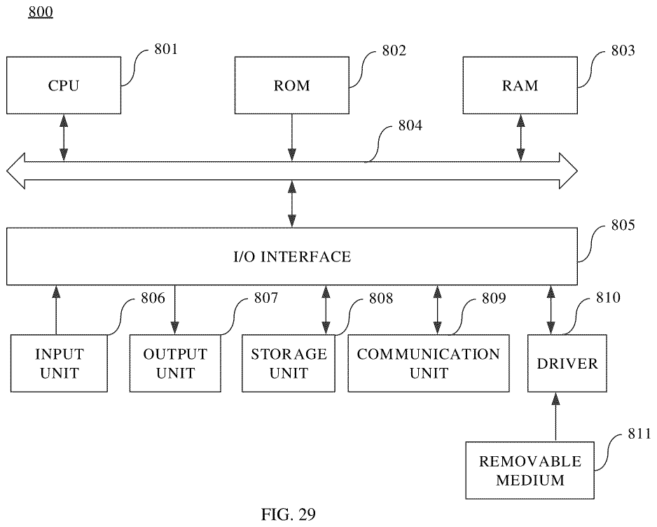

FIG. 29 is a schematic structural diagram of a computer system appropriate for implementing embodiments of the present disclosure. It can be noted that, the computer system 800 of the electronic device as illustrated in FIG. 29 is only an example and shall not impose any limitation on the functions and scope of use of embodiments of the present disclosure.

As illustrated in FIG. 29, computing device 800 includes a central processing unit (CPU) 801, which can execute various appropriate operations and processing according to programs stored in a read-only memory (ROM) 802 or programs loaded into a random access memory (RAM) 803 from a storage unit 808, for example, for executing the methods disclosed herein. Various programs and data required for system operation are also stored in the RAM 803. The CPU 801, the ROM 802, and the RAM 803 are connected to each other via a bus 804. An input/output (I/O) interface 805 is also connected to the bus 804.

The following components are connected to the I/O interface 805: an input unit 806 including a keyboard, a mouse, etc.; an output unit 807 including a cathode ray tube (CRT), liquid crystal display (LCD), a speaker, etc.; a storage unit 808 including, for example, a hard disk; and a communication unit 809 including a network interface card such as a local area network (LAN) card, modem, etc. The communication unit 809 performs communications via networks such as the Internet. A driver 810 is also connected to the I/O interface 805 as needed. A removable medium 811, such as a disk, an optical disk, a magneto-optical disk, a semiconductor memory, etc., is installed on the driver 810 as needed, so that a computer program read from it can be installed into the storage unit 808 as needed.

Specifically, according to embodiments of the present disclosure, the processes described in the following by referring to the flowcharts may be implemented as computer software programs. For example, embodiments of the present disclosure include a computer program product. The computer program product includes a computer program stored in a computer-readable medium. The computer program includes a computer program used for performing a method illustrated in the flowchart. In such embodiments, the computer program may be downloaded and installed from a network via communication section 809, and/or installed from removable medium 811. When the computer program is executed by the CPU 801, the various functions defined in the system of this application are executed.

In an embodiment, a method for determining a processing parameter is provided in the present disclosure. The method for determining the processing parameter includes: configuring processing factor information of a workpiece to be processed; displaying one or more processing preview diagrams according to the processing factor information, where there is a mapping relationship between the one or more processing preview diagrams and processing parameters; and determining a processing parameter corresponding to a selection instruction for the one or more processing preview diagrams to be a target processing parameter in response to the selection instruction, where the target processing parameter is used for controlling a processing device to process the workpiece to be processed.

In an embodiment, displaying the one or more processing preview diagrams according to the processing factor information includes: determining a corresponding processing parameter array according to the processing factor information, and displaying the processing parameter array in an interaction interface, where the processing parameter array includes the one or more processing preview diagrams, there is a mapping relationship between the one or more processing preview diagrams and array elements, and an array element indicates at least one processing parameter. Determining the processing parameter corresponding to the selection instruction for the one or more processing preview diagrams to be the target processing parameter in response to the selection instruction includes: taking an array element corresponding to a selected processing preview diagram as the target processing parameter in response to a selection instruction for one processing preview diagram in the processing parameter array.

In an embodiment, the processing factor information includes a material type and a processing type, at least two different material types and at least two different processing types are preconfigured in an interaction interface, and configuring the processing factor information of the workpiece to be processed includes: displaying one or more processing elements in the interaction interface, where the one or more processing elements are patterns that are intended to be processed onto the workpiece to be processed; configuring the material type of the workpiece to be processed in response to the selection instruction in the interaction interface; and configuring a processing type for the one or more processing elements in response to the selection instruction in the interaction interface. The method further includes: when one processing element is displayed in the interaction interface, obtaining a corresponding processing parameter array based on the configured material type and a configured processing type, where in a case where the material type of the workpiece to be processed is the same, the corresponding processing parameter array has different display effect when the processing type for the processing element is different; and/or when multiple processing elements are displayed in the interaction interface, obtaining a processing parameter array corresponding to each of the multiple processing elements based on the configured material type and a configured processing type for each of the multiple processing elements, where the multiple processing elements correspond to one or more processing types, and when the multiple processing elements correspond to the multiple processing types, respectively, the multiple processing types correspond to multiple processing parameter arrays with different display effect, respectively.

In an embodiment, when the multiple processing elements are displayed in the interaction interface, configuring the processing type for the one or more processing elements in response to the selection instruction in the interaction interface includes: in response to the selection instruction in the interaction interface, selecting at least one processing element among the multiple processing elements, and configuring a processing type for the at least one processing element.

In an embodiment, in response to the selection instruction in the interaction interface, selecting the at least one processing element among the multiple processing elements and configuring the processing type for the at least one processing element includes: in response to the selection instruction in the interaction interface, selecting at least two processing elements among the multiple processing elements, and configuring a processing type for the at least two processing elements; and/or in response to the selection instruction in the interaction interface, selecting at least two processing elements among the multiple processing elements for performing combination instruction, and configuring a processing type for the at least two processing elements subject to the combination instruction.

In an embodiment, the processing factor information includes a material type and a processing type, at least two different material types and at least two different processing types are preconfigured in an interaction interface, the processing type includes laser line engraving, laser fill engraving, and laser line cutting, and configuring the processing factor information of the workpiece to be processed and displaying the one or more processing preview diagrams according to the processing factor information includes: configuring the material type of the workpiece to be processed in response to the selection instruction in the interaction interface; and displaying, according to the configured material type, a processing preview diagram corresponding to the configured material type, where a background of the processing preview diagram is filled with a material schematic diagram corresponding to the material type, and the material schematic diagram displays at least two of a texture, a material property, and a color of the corresponding material type; and configuring a processing type for a processing element displayed in the interaction interface in response to the selection instruction in the interaction interface; and displaying, according to the configured processing type, a preview pattern corresponding to the configured processing type over a layer of the material schematic diagram, where processing preview diagrams corresponding to the laser line engraving, the laser fill engraving, and the laser line cutting are different.

In an embodiment, the preview pattern includes at least one of a reference pattern and an intended processing pattern, where the reference pattern is a preset schematic pattern, and the intended processing pattern is a pattern that is intended to be processed onto the workpiece to be processed. Displaying, according to the configured processing type, the preview pattern corresponding to the configured processing type over the layer of the material schematic diagram includes: in response to the selection instruction in the interaction interface, configuring the processing type for the workpiece to be processed as the laser line engraving, and displaying multiple different preview patterns on the material schematic diagram according to the configured material type, where the preview pattern is formed by lines, and a greater target processing parameter leads to darker lines in the preview pattern; and/or in response to the selection instruction in the interaction interface, configuring the processing type for the workpiece to be processed as the laser fill engraving, and displaying multiple different preview patterns on the material schematic diagram according to the configured material type, where the preview pattern is formed by filled color blocks, and a greater target processing parameter leads to darker filled color blocks in the preview pattern; and/or in response to the selection instruction in the interaction interface, configuring the processing type for the workpiece to be processed as the laser line cutting, and displaying multiple different preview patterns on the material schematic diagram according to the configured material type, where the preview pattern is formed by lines, a greater target processing parameter leads to darker lines in the preview pattern, and an area defined by lines of the reference pattern is displayed as a hollowed-out pattern when the target processing parameter is sufficient for cutting through the workpiece to be processed.

In an embodiment, the array element at least includes a first parameter item and a second parameter item, and determining the corresponding processing parameter array according to the processing factor information includes: determining a first sorting position of each of the one or more processing preview diagrams in a first direction based on a processing parameter of a first parameter item corresponding to each of the array elements; determining a second sorting position of each of the one or more processing preview diagrams in a second direction based on a processing parameter of a second parameter item corresponding to each of the array elements; and obtaining the processing parameter array by arranging each of the one or more processing preview diagrams based on the first sorting position of each of the one or more processing preview diagrams and the second sorting position of each of the one or more processing preview diagrams; where the processing parameter of the first parameter item is positively correlated with an arrangement order of the first sorting position in the first direction; and the processing parameter of the second parameter item is positively correlated with an arrangement order of the second sorting position in the second direction.

In an embodiment, the interaction interface displays a parameter configuration control, the processing parameter array is in an image format, and taking the array element corresponding to the selected processing preview diagram as the target processing parameter in response to the selection instruction for the processing preview diagram in the processing parameter array includes: moving an operation pointer to the parameter configuration control in the interaction interface, and hovering the processing parameter array in the interaction interface; and in response to the hovering operation performed on the processing parameter array, clicking on the one processing preview diagram in the hovered processing parameter array, and taking a processing parameter indicated by the array element corresponding to the selected processing preview diagram as the target processing parameter.

In an embodiment, a processing element is displayed in an editing area of an interaction interface, the processing element is a pattern that is intended to be processed onto the workpiece to be processed, the one or more processing preview diagrams includes one or more processing preview diagrams corresponding to the processing element, and a parameter configuration control in the interaction interface at least includes a parameter adjustment control for the processing parameter. After determining the processing parameter corresponding to the selection instruction to be the target processing parameter, the method includes: taking an adjusted processing parameter as a new target processing parameter in response to an adjustment operation through the parameter adjustment control; and generating a processing preview diagram corresponding to the processing element based on the target processing parameter and the processing factor information, and displaying the processing preview diagram corresponding to the processing element in the interaction interface, where the processing preview diagram corresponding to the processing element is a processing effect of the processing element under the target processing parameter and the processing factor information.

In an embodiment, the processing factor information at least includes a material type, and determining the corresponding processing parameter array according to the processing factor information includes: obtaining a factor-array mapping table, where the factor-array mapping table is used for describing a mapping relationship between processing factors and processing parameter arrays; and querying the factor-array mapping table according to the material type, to obtain a processing parameter array that matches the material type.

In an embodiment, displaying the one or more processing preview diagrams according to the processing factor information includes displaying an interaction interface, where the interaction interface further includes a parameter configuration control, and the parameter configuration control at least includes a parameter adjustment control for the processing parameter; displaying an adjusted processing parameter in the interaction interface in response to an adjustment operation through the parameter adjustment control; and generating a processing preview diagram corresponding to the workpiece to be processed according to the adjusted processing parameter and the processing factor information, and displaying the processing preview diagram in the interaction interface. Determining the processing parameter corresponding to the selection instruction for the one or more processing preview diagrams to be the target processing parameter in response to the selection instruction includes: determining a processing preview diagram corresponding to a latest adjustment operation when no adjustment operation is received through the parameter adjustment control within a preset duration; and taking an adjusted processing parameter corresponding to the latest adjustment operation as the target processing parameter in response to a selection instruction for the processing preview diagram corresponding to the latest adjustment operation.

In an embodiment, after determining the processing parameter corresponding to the selection instruction to be the target processing parameter, the method further includes: displaying a parameter sharing interface, where the parameter sharing interface includes the target processing parameter; in response to a sharing instruction for the displayed parameter sharing interface, taking a target processing parameter selected by the sharing instruction as a shared processing parameter, and taking an entity to be shared selected by the sharing instruction as a target shared entity; and sending the shared processing parameter to the target shared entity.

In an embodiment, before determining the corresponding processing parameter array according to the processing factor information, the method further includes: controlling, based on a processing request, the processing device to process multiple preset patterns onto a test workpiece according to multiple array elements, respectively, to obtain a processed test workpiece that is processed with the multiple preset patterns, where each of the multiple array elements includes at least two different types of processing parameters; obtaining a captured image of the processed test workpiece; obtaining an array element corresponding to each of the multiple preset patterns in the captured image according to an identification processing on the captured image, where a preset pattern includes at least one of a line pattern, a filled pattern, and a hollowed-out pattern; and obtaining a processing parameter array corresponding to the processed test workpiece based on the multiple preset patterns and the multiple array elements.

In an embodiment, the processing parameter includes at least two of a laser power, a pulse frequency, a pulse width, a scan speed, a processing speed, a spot size, a defocus amount, and the number of processing times, the captured image contains the multiple preset patterns, and obtaining the array element corresponding to each of the multiple preset patterns in the captured image according to the identification processing on the captured image includes: identifying a position of each of the multiple preset patterns in the captured image, to obtain position information of each of the multiple preset patterns in the captured image; and identifying at least two different types of processing parameters corresponding to each of the multiple preset patterns, to obtain the array element corresponding to each of the multiple preset patterns, where the position information of each of the multiple preset patterns and the array element corresponding to each of the multiple preset patterns are correlated with each other.

In an embodiment, obtaining the array element corresponding to each of the multiple preset patterns in the captured image according to the identification processing on the captured image includes: sending the captured image to a server or a terminal device, to enable the server or the terminal device to apply an identification processing model to perform pattern-position identification and perform array-element identification on each of the multiple preset patterns in the captured image; and receiving, from the server or the terminal device, position information of each of the multiple preset patterns in the captured image and the array element corresponding to each of the multiple preset patterns in the captured image that are input from the identification processing model.

In an embodiment, controlling, based on the processing request, the processing device to process the multiple preset patterns onto the test workpiece according to the multiple array elements, respectively, to obtain the processed test workpiece that is processed with the multiple preset patterns includes: obtaining the multiple preset patterns in the interaction interface; generating and displaying a processing parameter test array corresponding to the multiple preset patterns in the interaction interface in response to a request to generate the processing parameter test array corresponding to the multiple preset patterns; receiving an input operation on property information of a test workpiece; displaying a processing interface, where the processing interface includes a processing control; generating a processing request in response to a triggering operation through the processing control; and sending the processing request to the processing device, to enable the processing device to process the multiple preset patterns onto the test workpiece based on an array element of each of the multiple preset patterns in the processing parameter test array, to obtain the processed test workpiece that is processed with the multiple preset patterns. Additionally/alternatively, after obtaining the array element corresponding to each of the multiple preset patterns in the captured image according to the identification processing on the captured image, the method further includes: displaying an array element selection interface, where the display array element selection interface includes the multiple preset patterns in the captured image; and displaying at least one parameter value of an array element corresponding to a selected preset pattern when a selection instruction for the multiple preset patterns in the captured image is received.

In an embodiment, generating and displaying the processing parameter test array corresponding to the multiple preset patterns in the interaction interface in response to the request to generate the processing parameter test array corresponding to the multiple preset patterns includes: displaying a configuring control for processing parameter test array information in the interaction interface in response to the request to generate the processing parameter test array corresponding to the multiple preset patterns, where the processing parameter test array information includes at least one of: a laser source type, a material type, a processing parameter type, a processing parameter value, the number of rows and the number of columns of preset patterns, and an row interval and an column interval between two adjacent preset patterns; and in response to a configuration operation through the configuring control for the processing parameter test array information, displaying the processing parameter test array corresponding to the multiple preset patterns in the interaction interface based on the configured processing parameter test array information.

In an embodiment, the processing factor information includes a material type, and configuring the processing factor information of the workpiece to be processed includes: obtaining an image of the workpiece to be processed; and identifying at least a portion of the image of the workpiece to be processed, and determining the material type of the workpiece to be processed.

In an embodiment, identifying the at least a portion of the image of the workpiece to be processed and determining the material type of the workpiece to be processed includes: identifying label information on the workpiece to be processed, and determining the material type of the workpiece to be processed; or determining material feature information based on the image of the workpiece to be processed, and determining the material type of the workpiece to be processed based on a matching degree between the material feature information and preset feature information.

In an embodiment, determining the material feature information based on the image of the workpiece to be processed includes: determining first feature information of the workpiece to be processed based on the image of the workpiece to be processed, where the first feature information includes a texture feature, a color feature, and a shape feature; or determining second feature information of the workpiece to be processed based on the image of the workpiece to be processed, where the second feature information includes a spectral feature and/or a speckle feature.

In an embodiment, after determining the processing parameter corresponding to the selection instruction for the one or more processing preview diagrams to be the target processing parameter, the method further includes: generating a corresponding processing execution instruction in response to a parameter application instruction, where the processing execution instruction includes an execution instruction and a motion plan; and sending the processing execution instruction to the processing device, to enable the processing device to process, based on the execution instruction, the workpiece to be processed according to the motion plan.

Based on this, the present disclosure provides a processing device. The processing device includes a slide rail, a processing head, a communication component, and a controller. The processing head is configured to be movably disposed on the slide rail. The communication component is configured to receive an execution control instruction generated according to a processing parameter obtained according to the method for determining the processing parameter. The controller is configured to control, based on the received execution control instruction, the processing head to move on the slide rail to perform manufacturing processing.

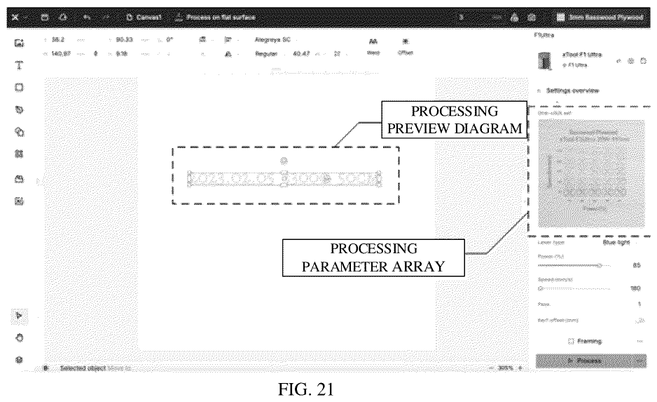

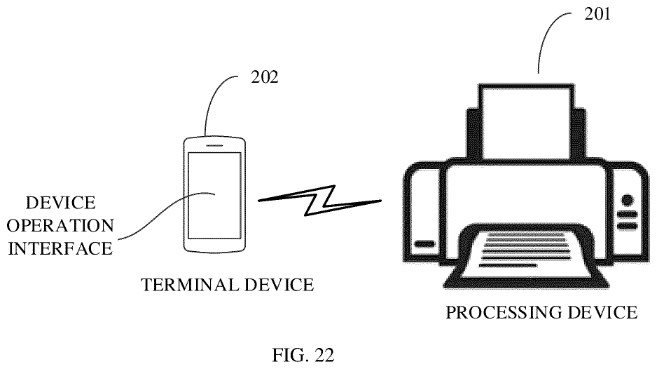

In this embodiment, the processing device is a device that performs subtractive manufacturing operations, such as cutting and carving, or performs additive manufacturing operations, such as printing, for example, a laser processing device using a laser as a means of processing, a CNC milling machine using a cutter as a means of processing, an additive manufacturing device, etc. The processing device communicates with the terminal device (one or more devices labeled with 202 in FIG. 2 and FIG. 21), and the processing control device is configured to perform data processing operations (e.g., data processing of the processing method in the present disclosure) on the processing device.

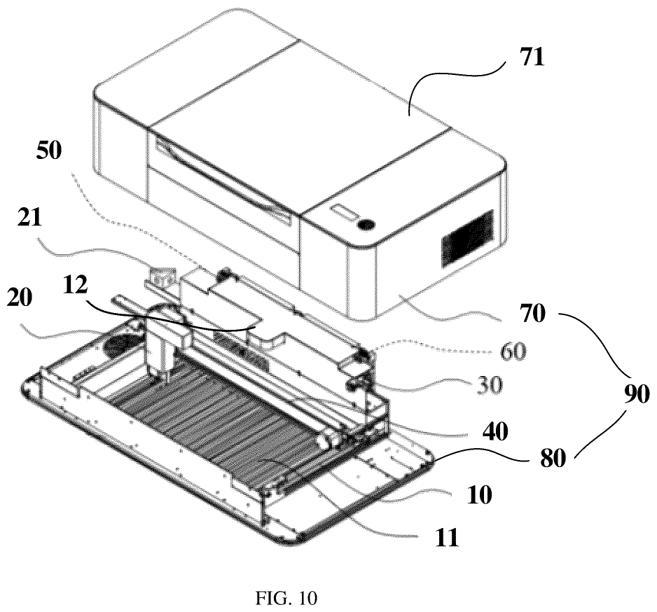

A hardware structure of the processing device is described by taking a laser processing device as an example as illustrated in FIG. 10. The processing device includes a housing 90, a processing platform 10, a processing head 20, a laser tube 30, a slide rail 40, a communication component 50, and a controller 60. The housing 90 includes an upper shell 70 and a bottom shell 80. The processing platform 10 includes a processing area 11 for placing a workpiece to be processed. The processing head 20 is moveably mounted on the slide rail 40 and is configured to move on the processing area to perform processing. The communication component 50 is configured to receive a target processing parameter obtained according to operations of the method in embodiments of the present disclosure. Based on the target processing parameter, the controller 60 is configured to control the processing head 50 to move on the slide rail 80 to process the workpiece to be processed. The communication unit 50 and the controller 60 can be installed inside a back panel of the laser tube 30, and are not visible from the perspective of the figure (shown with dotted leading lines in the figure). In some embodiments, a reflecting mirror 21 is provided between the processing head 20 and the laser tube 30. A beam generated by the laser tube 30 is reflected by the reflecting mirror 21 to arrive at the processing head 20, and then emits out to process the workpiece after reflection and focusing. In some embodiments, the processing head 20 can generate a light beam. In some other embodiments, the light beam can be generated by other components, such as the laser tube 30 (including a CO2 laser tube), and then enters a beam emitting apparatus through the reflecting mirror 21, and subsequently emits out through the processing head 20 to process the workpiece. The processing head can emit laser or any other suitable light.

In a feasible embodiment, the processing device includes a slide rail 40 and a processing head 20, the processing head 20 is moveably disposed on the slide rail 40, and the processing head 20 is configured to perform at least one of laser processing, cutting processing, and printing processing on the workpiece to be processed.

In this embodiment, during the processing of the workpiece to be processed by the processing device based on the processing execution instruction, the processing device includes a slide rail 40 and a processing head 20, and the processing head 20 is moveably mounted on the slide rail 40. For example, the slide rail 40 can be a guide rail having an X-axis rail and/or a Y-axis rail, and the guide rail can include linear rails or rails with cooperative optical axes and rollers for sliding, as long as the processing head 20 can be driven to move on the guide rail to process on the X-axis and/or Y-axis. The processing head 20 may also include a Z-axis rail, such that the processing head 20 may move in the Z direction along the Z-axis rail for adjusting focusing before and/or during processing. Therefore, the processing head 20 can move within a range covered by the slide rail 40 to perform at least one of laser processing, cutting processing, printing processing, etc., on the workpiece to be processed. For different processing devices, the processing heads 20 configured therein are also different. For example, for a processing device that uses a laser as the processing means, its corresponding processing head 20 can be configured with a laser component for emitting a laser to perform laser processing on the workpiece to be processed. For a processing device that uses a cutter as the processing means, its corresponding processing head 20 can be configured with a cutter to perform mechanical cutting processing on the workpiece to be processed. For a processing device that uses additive manufacturing as the processing means, its corresponding processing head 20 can be configured with an additive manufacturing component to perform additive processing (e.g., printing processing) on the workpiece to be processed to achieve additive manufacturing.

In a feasible embodiment, the processing device further includes a processing platform 10, the processing platform 10 includes a processing area 11 for placing the workpiece to be processed, and a processing head 20 moves on the processing area 11 to perform at least one of laser processing, cutting processing, and printing processing on the workpiece to be processed.

In this embodiment, the processing device further includes a processing platform 10, the processing platform 10 includes a processing area 11 for placing the workpiece to be processed. The processing head 20 can move on the processing area 11 by means of a slide rail 40. During the movement of the processing head 20 on the processing area 11, at least one of the following processing methods can be used to process the workpiece to be processed: laser processing, cutting processing, and printing processing.

In a feasible embodiment, the processing device 100 further includes a housing 90 and a cover plate 71, where housing 90 and cover plate 71 may enclose an inner space for accommodating the workpiece to be processed. The housing 90 may include an opening that communicates with the inner space, and the cover plate 71 is connected to the housing 90 to expose or cover the opening. The cover plate 71 includes a light-transmitting window. The slide rail 40, the processing head 20, and the processing platform 10 are located in the internal space. A camera apparatus 12 is further provided in the internal space.

In this embodiment, the housing 90 can be an integrally formed housing 90 or a housing 90 formed by splitable components. For example, the housing 90 may include an upper shell 70 and a bottom shell 80 that are detachably connected or fixedly connected, where the upper shell 70 and the bottom shell 80 enclose an inner space for accommodating the workpiece together with the cover plate 71. Through the blocking and/or filtering effect of the upper shell 70 and the bottom shell 80, the laser emitted by the processing head 20 can be prevented from overflowing from the inner space during operation of the processing head 20, thereby preventing the laser from causing harm to an operator. The housing 90 defines an opening communicating with the internal space, and the cover plate 71 is connected to the housing 90 to open or close the opening. Exemplarily, the cover plate 71 can be connected to housing 90 through a hinge (i.e., a hinge can be installed between the cover plate 71 and the housing 90, allowing the cover plate 71 to be opened and closed like a door.), a slide rail connection approach (i.e., the slide rail 40 is provided between the cover plate 71 and the housing 90, allowing the cover plate 71 to move relative to the housing 90 along the slide rail 40, opening and closing the opening by sliding in and out), or any other suitable connection approach. The operator can open or close the cover plate 71 to expose the opening, allowing the open or closure of the inner space, such that the workpiece to be processed can be placed into or taken out from the inner space through the opening. The cover plate 71 includes a light-transmitting window, allowing the operator to observe the processing on the workpiece in the inner space through the light-transmitting window. The slide rail 40, the processing head 20, and the processing platform 10 are located in the inner space. A camera apparatus 12 is further provided in the inner space, which can be used to film the processing process of the workpiece to be processed in the inner space.

A processing system is further provided in the present disclosure. The processing system includes a processing device and a terminal device communicating with the processing device. The processing device includes a processing device platform and a processing head, the processing device platform includes a processing area for placing workpiece, and the processing head is configured to move on the processing area. The terminal device is configured to execute the method for determining the processing parameter in any of the foregoing embodiments.

A processing system is further provided in the present disclosure. The processing system includes at least one processor and at least one non-transitory computer-readable medium. The at least one non-transitory computer-readable medium is configured to store program instructions which, when executed by the at least one processor, cause the computer system to perform the method for determining the processing parameter in any of the foregoing embodiments.

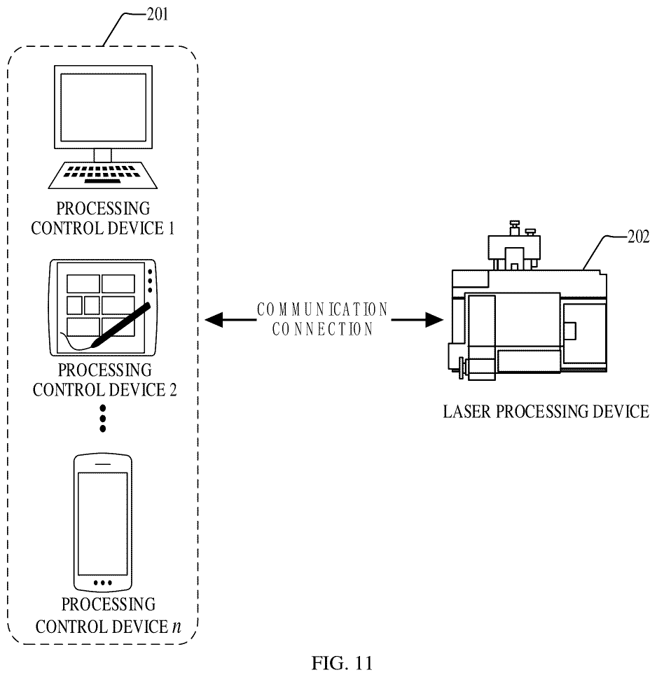

Reference may be made to FIG. 11, which is a schematic diagram of a processing system in the present disclosure. With the development of processing device, the processing device has become increasingly intelligent and convenient. The user can easily use the processing device to process a workpiece to be processed by operating a host computer software installed on the terminal device. As illustrated in FIG. 11, the host computer software for the processing device 202 is installed on the terminal device 201. The host computer software provides a device control interface. The user can use the processing device to process the workpiece to be processed by performing relevant trigger operations on the device control interface.

In an embodiment of the present disclosure, the processing parameter may be determined by a terminal device 101. Specifically, the terminal device 101 configures processing factor information of a workpiece to be processed; displays one or more processing preview diagrams according to the processing factor information, where there is a mapping relationship between the one or more processing preview diagrams and processing parameters; an determines a processing parameter corresponding to a selection instruction for the one or more processing preview diagrams to be a target processing parameter in response to the selection instruction, where the target processing parameter is used for controlling a processing device to process the workpiece to be processed.

It can be clarified that, the terminal device 101 includes, but is not limited to, smartphones, computers (tablets, laptops, desktop computers, etc.), smart wearable devices (wristbands, watches, etc.), etc.

It can be clarified that, the processing device 102 can be any processing device. For example, the processing device 102 may be a laser processing device, which is a device that uses a laser beam for processing. It can cut, drill, engrave, and process various materials such as metal, plastic, wood, glass, textiles, and so on, using a laser beam. It includes, but is not limited to, a laser engraving machine, a laser cutter, a laser printer, and so on.

In embodiments of the present disclosure, processing control can be achieved simply and accurately, avoiding the waste of material and time caused by cognitive biases in the processing the material and the manual configuring the processing parameter, thereby improving the processing effect and accuracy and meeting the product manufacturing requirements.

It can be noted that, the number of terminal devices 101 and the number of processing devices 102 are merely illustrative. Depending on actual needs, there may be any number of terminal devices 101 and any number of processing devices 102.

A terminal device is further provided in the present disclosure. The terminal device includes at least one processor and a memory communicatively connected to the at least one processor. The memory is configured to store instructions executable by the at least one processor. The instructions, when executed by the at least one processor, cause the at least one processor to perform the method for determining the processing parameter in the foregoing embodiments.

Reference may be made to FIG. 12, which is a schematic diagram of a terminal device appropriate for implementing embodiments of the present disclosure. The terminal device in embodiments of the present disclosure may include, but is not limited to, mobile phones, laptops, and tablets. The terminal device as illustrated in FIG. 12 is merely an example and shall not impose any limitation on the functions and scope of use of embodiments of the present disclosure.

As illustrated in FIG. 12, the terminal device may include a processing apparatus 1001 (that is, a CPU, a graphics processor, etc.), which can perform various appropriate operations and processing according to a program stored in an ROM 1002 or a program loaded from a storage apparatus 1003 to an RAM 1004. In the RAM 1004, various programs and data required for the operation of the terminal device are further stored. The processing apparatus 1001, the ROM 1002, and the RAM 1004 are connected to each other via a bus 1005. An I/O interface 1006 is also connected to the bus. Typically, the following systems can be connected to the I/O interface 1006: an input apparatus 1007 including, for example, a touch screen, a touchpad, a keyboard, a mouse, an image sensor, a microphone, an accelerometer, a gyroscope, etc.; an output apparatus 1008 including, for example, an LCD, a speaker, a vibrator, etc.; a storage apparatus 1003 including, for example, a magnetic tape, a hard disk, etc.; and a communication apparatus 1009. The communication apparatus 1009 can allow the terminal device to communicate with other equipment wirelessly or wired to exchange data. Although the figure shows a terminal device with various systems, it should be understood that it is not required to implement or have all the systems shown. More or fewer systems may be implemented or have alternatives.

The terminal device provided in the present disclosure, with the method for determining the processing parameter in the foregoing embodiments, can solve the technical problem of low matching degree between processing parameter and workpiece, leading to poor processed results. Compared with the prior art, the beneficial effects of the terminal device provided in the present disclosure are the same as those of the terminal device provided in the foregoing embodiments, and other technical features in this terminal device are the same as those disclosed in the method of the previous embodiment, which will not be repeated herein.

It can be understood that, the various parts of the present disclosure can be implemented by hardware, software, firmware, or a combination thereof. In the description of the above-described embodiment, specific features, structures, materials, or characteristics can be combined in any one or more embodiments or examples in a suitable manner.

A non-transitory computer-readable storage medium is provided in the present disclosure. The non-transitory computer-readable storage medium is configured to store computer-readable program instructions (i.e., a computer program) which, when executed by a processor, cause the processor to perform the method for determining the processing parameter in the foregoing embodiments.

The non-transitory computer-readable storage medium provided in the embodiment of the present disclosure can be, for example, a Universal Serial Bus (USB) flash drive, but is not limited to electrical, magnetic, optical, electromagnetic, infrared, or semiconductor systems or devices, or any combination of the above. More specific examples of non-transitory computer-readable storage medium can include, but are not limited to: an electrical connection with one or more wires, a portable computer disk, a hard disk, a random access memory (RAM), a read-only memory (ROM), an erasable programmable read-only memory (EPROM: Erasable Programmable Read Only Memory or flash memory), an optical fiber, a portable compact disk read-only memory (CD-ROM), an optical storage device, a magnetic storage device, or any suitable combination of the above as described above. In this embodiment, the non-transitory computer-readable storage medium may be any tangible medium containing or storing a program that may be used by or in conjunction with an instruction execution system or device. The program code contained on the non-transitory computer-readable storage medium may be transmitted using any appropriate medium, including but not limited to: wires, optical cables, RF (Radio Frequency), etc., or any suitable combination as described above.

The non-transitory computer-readable storage medium as described above may be included in the terminal device, or may exist independently and not be assembled in the terminal device.

The non-transitory computer-readable storage medium as described above carries one or more programs. When the one or more programs as described above are executed by the terminal device, the terminal device is caused to obtain a processing area image corresponding to the processing device platform, where the processing area image contains the workpiece to be processed; identify the processing area image and determine the material type of the workpiece to be processed; and obtain a processing parameter for the workpiece to be processed based on the material type.

Computer program code configured for performing the operations of the present disclosure may be written in one or more programming languages or a combination thereof, including object-oriented programming languages such as Java, Smalltalk, C++, and further including conventional procedural programming languages such as “C” language or similar programming languages. The program code may be executed entirely on the user's computer, or may be executed partially on the user's computer, or may be executed as a separate software package, or may be executed partially on the user's computer and partially on a remote computer, or may be executed entirely on a remote computer or server. In situations involving remote computers, the remote computer may be connected to the user's computer by any type of network, including a local area network (LAN) or a wide area network (WAN), or may be connected to an external computer (that is, use an Internet Service Provider to connect via the Internet).

The flowcharts and block diagrams in the accompanying drawings illustrate the possible architecture, functions, and operations of the systems, methods, and computer program products according to various embodiments of the present disclosure. In this regard, each square frame in a flowchart or block diagram may represent a module, a program segment, or a portion of a code. The module, the program segment, or the portion of the code contains one or more executable instructions for implementing a specified logical function. It should also be noted that in some alternative embodiments, the functions marked in the box may also occur in a different order than that marked in the accompanying drawings. For example, two square frames represented in succession may actually be executed substantially in parallel, and they may sometimes be executed in the opposite order, depending on the functions involved. It should also be noted that each square frame in a block diagram and/or flowchart, and a combination of square frames in a block diagram and/or flowchart, may be implemented with a dedicated hardware-based system that performs a specified function or operation, or may be implemented with a combination of dedicated hardware and computer instructions.

The modules described in the embodiments of the present disclosure may be implemented in software or in hardware. The name of the module does not constitute a limitation on the unit itself in certain situations.

The computer-readable storage medium provided in the present disclosure is a non-transitory computer-readable storage medium. The non-transitory computer-readable storage medium stores computer-readable program instructions (i.e., a computer program) for executing the method for determining the processing parameter in the foregoing embodiments, which can solve the technical problem of low matching degree between processing parameter and workpiece, leading to poor processed results. Compared with the prior art, the beneficial effects of the computer-readable storage medium provided in the present disclosure are the same as those of the method for determining the processing parameter in the foregoing embodiments, which will not be repeated herein.

A computer program product is further provided in embodiment of the present disclosure. The computer program product includes a computer program which, when executed by a processor, causes the processor to implement the method for determining the processing parameter. The computer program product provided in the present disclosure can solve the technical problem of low matching degree between processing parameter and workpiece, leading to poor processed results. Compared with the prior art, the beneficial effects of the computer program product provided in the present disclosure are the same as those of the method for determining the processing parameter in the foregoing embodiments, which will not be repeated herein.

The above are only some embodiments of the present disclosure, and are not intended to limit the scope of the present disclosure. Under the concept of the present disclosure, any equivalent structure transformation made by using the description and accompanying drawings of the present disclosure, or directly or indirectly applied in other related technical fields, is included within the scope of the present disclosure.

What is claimed is:

1. A method for determining a processing parameter, comprising:
configuring processing factor information of a workpiece to be processed;
displaying one or more processing preview diagrams according to the processing factor information, wherein there is a mapping relationship between the one or more processing preview diagrams and processing parameters; and
determining a processing parameter corresponding to a selection instruction for the one or more processing preview diagrams to be a target processing parameter in response to the selection instruction, wherein the target processing parameter is used for controlling a processing device to process the workpiece to be processed.

2. The method for determining the processing parameter of claim 1, wherein
displaying the one or more processing preview diagrams according to the processing factor information comprises:
determining a corresponding processing parameter array according to the processing factor information, and displaying the processing parameter array in an interaction interface, wherein the processing parameter array comprises the one or more processing preview diagrams, there is a mapping relationship between the one or more processing preview diagrams and array elements, and an array element indicates at least one processing parameter; and
determining the processing parameter corresponding to the selection instruction for the one or more processing preview diagrams to be the target processing parameter in response to the selection instruction comprises:
taking an array element corresponding to a selected processing preview diagram as the target processing parameter in response to a selection instruction for one processing preview diagram in the processing parameter array.

3. The method for determining the processing parameter of claim 1, wherein
the processing factor information comprises a material type and a processing type, at least two different material types and at least two different processing types are preconfigured in an interaction interface, and configuring the processing factor information of the workpiece to be processed comprises:
displaying one or more processing elements in the interaction interface, wherein the one or more processing elements are patterns that are intended to be processed onto the workpiece to be processed;
configuring the material type of the workpiece to be processed in response to the selection instruction in the interaction interface; and
configuring a processing type for the one or more processing elements in response to the selection instruction in the interaction interface; and
the method further comprises:
when one processing element is displayed in the interaction interface, obtaining a corresponding processing parameter array based on the configured material type and a configured processing type, wherein in a case where the material type of the workpiece to be processed is the same, the corresponding processing parameter array has different display effect when the processing type for the processing element is different; and/or
when a plurality of processing elements are displayed in the interaction interface, obtaining a processing parameter array corresponding to each of the plurality of processing elements based on the configured material type and a configured processing type for each of the plurality of processing elements, wherein the plurality of processing elements correspond to one or more processing types, and when the plurality of processing elements correspond to the plurality of processing types, respectively, the plurality of processing types correspond to a plurality of processing parameter arrays with different display effect, respectively.

4. The method for determining the processing parameter of claim 3, wherein when the plurality of processing elements are displayed in the interaction interface, configuring the processing type for the one or more processing elements in response to the selection instruction in the interaction interface comprises:
in response to the selection instruction in the interaction interface, selecting at least one processing element among the plurality of processing elements, and configuring a processing type for the at least one processing element.

5. The method for determining the processing parameter of claim 4, wherein in response to the selection instruction in the interaction interface, selecting the at least one processing element among the plurality of processing elements and configuring the processing type for the at least one processing element comprises:
in response to the selection instruction in the interaction interface, selecting at least two processing elements among the plurality of processing elements, and configuring a processing type for the at least two processing elements; and/or
in response to the selection instruction in the interaction interface, selecting at least two processing elements among the plurality of processing elements for performing combination instruction, and configuring a processing type for the at least two processing elements subject to the combination instruction.

6. The method for determining the processing parameter of claim 1, wherein
the processing factor information comprises a material type and a processing type, at least two different material types and at least two different processing types are preconfigured in an interaction interface, the processing type comprises laser line engraving, laser fill engraving, and laser line cutting, and configuring the processing factor information of the workpiece to be processed and displaying the one or more processing preview diagrams according to the processing factor information comprises:
configuring the material type of the workpiece to be processed in response to the selection instruction in the interaction interface; and displaying, according to the configured material type, a processing preview diagram corresponding to the configured material type, wherein a background of the processing preview diagram is filled with a material schematic diagram corresponding to the material type, and the material schematic diagram displays at least two of a texture, a material property, and a color of the corresponding material type; and
configuring a processing type for a processing element displayed in the interaction interface in response to the selection instruction in the interaction interface; and displaying, according to the configured processing type, a preview pattern corresponding to the configured processing type over a layer of the material schematic diagram, wherein processing preview diagrams corresponding to the laser line engraving, the laser fill engraving, and the laser line cutting are different.

7. The method for determining the processing parameter of claim 6, wherein
the preview pattern comprises at least one of a reference pattern and an intended processing pattern, wherein the reference pattern is a preset schematic pattern, and the intended processing pattern is a pattern that is intended to be processed onto the workpiece to be processed; and
displaying, according to the configured processing type, the preview pattern corresponding to the configured processing type over the layer of the material schematic diagram comprises:
in response to the selection instruction in the interaction interface, configuring the processing type for the workpiece to be processed as the laser line engraving, and displaying a plurality of different preview patterns on the material schematic diagram according to the configured material type, wherein the preview pattern is formed by lines, and a greater target processing parameter leads to darker lines in the preview pattern; and/or
in response to the selection instruction in the interaction interface, configuring the processing type for the workpiece to be processed as the laser fill engraving, and displaying a plurality of different preview patterns on the material schematic diagram according to the configured material type, wherein the preview pattern is formed by filled color blocks, and a greater target processing parameter leads to darker filled color blocks in the preview pattern; and/or
in response to the selection instruction in the interaction interface, configuring the processing type for the workpiece to be processed as the laser line cutting, and displaying a plurality of different preview patterns on the material schematic diagram according to the configured material type, wherein the preview pattern is formed by lines, a greater target processing parameter leads to darker lines in the preview pattern, and an area defined by lines of the reference pattern is displayed as a hollowed-out pattern when the target processing parameter is sufficient for cutting through the workpiece to be processed.

8. The method for determining the processing parameter of claim 2, wherein the array element at least comprises a first parameter item and a second parameter item, and determining the corresponding processing parameter array according to the processing factor information comprises:
determining a first sorting position of each of the one or more processing preview diagrams in a first direction based on a processing parameter of a first parameter item corresponding to each of the array elements;
determining a second sorting position of each of the one or more processing preview diagrams in a second direction based on a processing parameter of a second parameter item corresponding to each of the array elements; and
obtaining the processing parameter array by arranging each of the one or more processing preview diagrams based on the first sorting position of each of the one or more processing preview diagrams and the second sorting position of each of the one or more processing preview diagrams; wherein
the processing parameter of the first parameter item is positively correlated with an arrangement order of the first sorting position in the first direction; and
the processing parameter of the second parameter item is positively correlated with an arrangement order of the second sorting position in the second direction.

9. The method for determining the processing parameter of claim 2, wherein the interaction interface displays a parameter configuration control, the processing parameter array is in an image format, and taking the array element corresponding to the selected processing preview diagram as the target processing parameter in response to the selection instruction for the processing preview diagram in the processing parameter array comprises:
moving an operation pointer to the parameter configuration control in the interaction interface, and hovering the processing parameter array in the interaction interface; and
in response to the hovering operation performed on the processing parameter array, clicking on the one processing preview diagram in the hovered processing parameter array, and taking a processing parameter indicated by the array element corresponding to the selected processing preview diagram as the target processing parameter.

10. The method for determining the processing parameter of claim 1, wherein
a processing element is displayed in an editing area of an interaction interface, the processing element is a pattern that is intended to be processed onto the workpiece to be processed, the one or more processing preview diagrams comprises one or more processing preview diagrams corresponding to the processing element, and a parameter configuration control in the interaction interface at least comprises a parameter adjustment control for the processing parameter; and
after determining the processing parameter corresponding to the selection instruction to be the target processing parameter, the method comprises:
taking an adjusted processing parameter as a new target processing parameter in response to an adjustment operation through the parameter adjustment control; and
generating a processing preview diagram corresponding to the processing element based on the target processing parameter and the processing factor information, and displaying the processing preview diagram corresponding to the processing element in the interaction interface, wherein the processing preview diagram corresponding to the processing element is a processing effect of the processing element under the target processing parameter and the processing factor information.

11. The method for determining the processing parameter of claim 2, wherein the processing factor information at least comprises a material type, and determining the corresponding processing parameter array according to the processing factor information comprises:
obtaining a factor-array mapping table, wherein the factor-array mapping table is used for describing a mapping relationship between processing factors and processing parameter arrays; and
querying the factor-array mapping table according to the material type, to obtain a processing parameter array that matches the material type.

12. The method for determining the processing parameter of claim 1, wherein
displaying the one or more processing preview diagrams according to the processing factor information comprises:
displaying an interaction interface, wherein the interaction interface further comprises a parameter configuration control, and the parameter configuration control at least comprises a parameter adjustment control for the processing parameter;
displaying an adjusted processing parameter in the interaction interface in response to an adjustment operation through the parameter adjustment control; and
generating a processing preview diagram corresponding to the workpiece to be processed according to the adjusted processing parameter and the processing factor information, and displaying the processing preview diagram in the interaction interface; and
determining the processing parameter corresponding to the selection instruction for the one or more processing preview diagrams to be the target processing parameter in response to the selection instruction comprises:
determining a processing preview diagram corresponding to a latest adjustment operation when no adjustment operation is received through the parameter adjustment control within a preset duration; and
taking an adjusted processing parameter corresponding to the latest adjustment operation as the target processing parameter in response to a selection instruction for the processing preview diagram corresponding to the latest adjustment operation.

13. The method for determining the processing parameter of claim 1, wherein after determining the processing parameter corresponding to the selection instruction to be the target processing parameter, the method further comprises:
displaying a parameter sharing interface, wherein the parameter sharing interface comprises the target processing parameter;
in response to a sharing instruction for the displayed parameter sharing interface, taking a target processing parameter selected by the sharing instruction as a shared processing parameter, and taking an entity to be shared selected by the sharing instruction as a target shared entity; and
sending the shared processing parameter to the target shared entity.

14. The method for determining the processing parameter of claim 2, wherein before determining the corresponding processing parameter array according to the processing factor information, the method further comprises:
controlling, based on a processing request, the processing device to process a plurality of preset patterns onto a test workpiece according to a plurality of array elements, respectively, to obtain a processed test workpiece that is processed with the plurality of preset patterns, wherein each of the plurality of array elements comprises at least two different types of processing parameters;
obtaining a captured image of the processed test workpiece;
obtaining an array element corresponding to each of the plurality of preset patterns in the captured image according to an identification processing on the captured image, wherein a preset pattern comprises at least one of a line pattern, a filled pattern, and a hollowed-out pattern; and
obtaining a processing parameter array corresponding to the processed test workpiece based on the plurality of preset patterns and the plurality of array elements.

15. The method of claim 14, wherein the processing parameter comprises at least two of a laser power, a pulse frequency, a pulse width, a scan speed, a processing speed, a spot size, a defocus amount, and a number of processing times, the captured image contains the plurality of preset patterns, and obtaining the array element corresponding to each of the plurality of preset patterns in the captured image according to the identification processing on the captured image comprises:
identifying a position of each of the plurality of preset patterns in the captured image, to obtain position information of each of the plurality of preset patterns in the captured image; and
identifying at least two different types of processing parameters corresponding to each of the plurality of preset patterns, to obtain the array element corresponding to each of the plurality of preset patterns, wherein the position information of each of the plurality of preset patterns and the array element corresponding to each of the plurality of preset patterns are correlated with each other.

16. The method for determining the processing parameter of claim 14, wherein obtaining the array element corresponding to each of the plurality of preset patterns in the captured image according to the identification processing on the captured image comprises:
sending the captured image to a server or a terminal device, to enable the server or the terminal device to apply an identification processing model to perform pattern-position identification and perform array-element identification on each of the plurality of preset patterns in the captured image; and
receiving, from the server or the terminal device, position information of each of the plurality of preset patterns in the captured image and the array element corresponding to each of the plurality of preset patterns in the captured image that are input from the identification processing model.

17. The method for determining the processing parameter of claim 14, wherein
controlling, based on the processing request, the processing device to process the plurality of preset patterns onto the test workpiece according to the plurality of array elements, respectively, to obtain the processed test workpiece that is processed with the plurality of preset patterns comprises:
obtaining the plurality of preset patterns in the interaction interface;
generating and displaying a processing parameter test array corresponding to the plurality of preset patterns in the interaction interface in response to a request to generate the processing parameter test array corresponding to the plurality of preset patterns;
receiving an input operation on property information of a test workpiece;
displaying a processing interface, wherein the processing interface comprises a processing control;
generating a processing request in response to a triggering operation through the processing control; and
sending the processing request to the processing device, to enable the processing device to process the plurality of preset patterns onto the test workpiece based on an array element of each of the plurality of preset patterns in the processing parameter test array, to obtain the processed test workpiece that is processed with the plurality of preset patterns; and/or after obtaining the array element corresponding to each of the plurality of preset patterns in the captured image according to the identification processing on the captured image, the method further comprises:
displaying an array element selection interface, wherein the display array element selection interface comprises the plurality of preset patterns in the captured image; and
displaying at least one parameter value of an array element corresponding to a selected preset pattern when a selection instruction for the plurality of preset patterns in the captured image is received.

18. The method for determining the processing parameter of claim 17, wherein generating and displaying the processing parameter test array corresponding to the plurality of preset patterns in the interaction interface in response to the request to generate the processing parameter test array corresponding to the plurality of preset patterns comprises:
displaying a configuring control for processing parameter test array information in the interaction interface in response to the request to generate the processing parameter test array corresponding to the plurality of preset patterns, wherein the processing parameter test array information comprises at least one of:
a laser source type, a material type, a processing parameter type, a processing parameter value, a number of rows and a number of columns of preset patterns, and an row interval and an column interval between two adjacent preset patterns; and
in response to a configuration operation through the configuring control for the processing parameter test array information, displaying the processing parameter test array corresponding to the plurality of preset patterns in the interaction interface based on the configured processing parameter test array information.

19. The method for determining the processing parameter of claim 1, wherein the processing factor information comprises a material type, and configuring the processing factor information of the workpiece to be processed comprises:
obtaining an image of the workpiece to be processed; and
identifying at least a portion of the image of the workpiece to be processed, and determining the material type of the workpiece to be processed.

20. The method for determining the processing parameter of claim 19, wherein identifying the at least a portion of the image of the workpiece to be processed and determining the material type of the workpiece to be processed comprises:
identifying label information on the workpiece to be processed, and determining the material type of the workpiece to be processed; or
determining material feature information based on the image of the workpiece to be processed, and determining the material type of the workpiece to be processed based on a matching degree between the material feature information and preset feature information.

21. The method for determining the processing parameter of claim 20, wherein determining the material feature information based on the image of the workpiece to be processed comprises:
determining first feature information of the workpiece to be processed based on the image of the workpiece to be processed, wherein the first feature information comprises a texture feature, a color feature, and a shape feature; or
determining second feature information of the workpiece to be processed based on the image of the workpiece to be processed, wherein the second feature information comprises a spectral feature and/or a speckle feature.

22. The method for determining the processing parameter of claim 1, wherein after determining the processing parameter corresponding to the selection instruction for the one or more processing preview diagrams to be the target processing parameter, the method further comprises:
generating a corresponding processing execution instruction in response to a parameter application instruction, wherein the processing execution instruction comprises an execution instruction and a motion plan; and
sending the processing execution instruction to the processing device, to enable the processing device to process, based on the execution instruction, the workpiece to be processed according to the motion plan.

23. A processing device, comprising:
a processing platform comprising a processing area used for placing a workpiece to be processed;
a slide rail and a processing head, wherein the processing head is movably disposed on the slide rail, the processing head is disposed above the processing platform, and the processing head is configured to perform manufacturing processing on the workpiece to be processed;
a housing and a cover plate, wherein the housing and the cover plate are configured to enclose an inner space, the housing defines an opening that is in communication with the inner space, the cover plate is connected to the housing to expose or cover the opening, the slide rail, the processing head, and the processing platform are disposed in the inner space, and a camera apparatus is provided in the inner space;
a communication component configured to receive an execution control instruction generated according to a processing parameter obtained according to the method of claim 1; and
a controller configured to control, based on the received execution control instruction, the processing head to move on the slide rail to perform manufacturing processing.

24. A computer system, comprising:
at least one processor; and
at least one non-transitory computer-readable medium configured to store program instructions which, when executed by the at least one processor, cause the computer system to perform:
configuring processing factor information of a workpiece to be processed;
displaying one or more processing preview diagrams according to the processing factor information, wherein there is a mapping relationship between the one or more processing preview diagrams and processing parameters; and
determining a processing parameter corresponding to a selection instruction for the one or more processing preview diagrams to be a target processing parameter in response to the selection instruction, wherein the target processing parameter is used for controlling a processing device to process the workpiece to be processed.

25. A non-transitory computer-readable storage medium, wherein the non-transitory computer-readable storage medium is configured to store a computer program which, when executed by a processor, causes the processor to perform:
configuring processing factor information of a workpiece to be processed;
displaying one or more processing preview diagrams according to the processing factor information, wherein there is a mapping relationship between the one or more processing preview diagrams and processing parameters; and
determining a processing parameter corresponding to a selection instruction for the one or more processing preview diagrams to be a target processing parameter in response to the selection instruction, wherein the target processing parameter is used for controlling a processing device to process the workpiece to be processed.
